(19) United States
(12) Patent Application Publication
(10) Pub. No.: US 2012/0251858 A1
(43) Pub. Date: Oct. 4, 2012

(54) LAMINATED TYPE ENERGY DEVICE, CHIP TYPE ENERGY DEVICE, ENERGY DEVICE ELECTRODE STRUCTURE AND FABRICATION METHOD OF THE LAMINATED TYPE ENERGY DEVICE

(75) Inventors: Tomohiro KATO, Kyoto (JP); Daichi TOMITA, Kyoto (JP)

(73) Assignee: ROHM CO., LTD., Kyoto (JP)

(21) Appl. No.: 13/439,606

(22) Filed: Apr. 4, 2012

(30) Foreign Application Priority Data
Apr. 4, 2011 (JP) 2011-083014
Apr. 4, 2011 (JP) 2011-083015
Aug. 19, 2011 (JP) 2011-179323
Dec. 1, 2011 (JP) 2011-263498

(51) Int. Cl. H01M 2/36; H01G 9/145; H01G 9/048; H01M 4/82; H01M 2/08; H01M 2/10; H01M 4/64; B05D 5/12; H01G 9/155; H01G 9/10

(52) U.S. Cl. 429/82; 361/502; 361/503; 361/518; 429/185; 429/99; 429/211; 429/160; 427/77; 29/623.2

(57) ABSTRACT

Provided is a laminated type energy device which can enhance the sealing ability and the adhesibility between the layered structure and the sealing body which houses the layered structure, and the degree of space-saving, and uses the sealing means with sufficient productivity and reliability. The laminated type energy device includes: at least two layers of layered structure 80 in which a positive electrode and a negative electrode are alternately laminated so that positive and negative extraction electrodes 32a and 32b are exposed, inserting a separator 30 in which an electrolysis solution and ion pass therethrough between positive and negative active material electrodes 10 and 12; laminate sheets 40a and 40b overlaid from front and back surfaces of the layered structure 80 to compressively seal the layered structure 80; and contact holes 20a and 20b for use in spot bonding of the laminated type energy device to a module substrate 100.

### CROSS REFERENCE TO RELATED APPLICATIONS

This application is based upon and claims the benefit of priority from prior Japanese Patent Application Nos. P2011-83014 filed on Apr. 4, 2011, P2011-83015 filed on Apr. 4, 2011, P2011-179323 filed on Aug. 19, 2011, and P2011-263498 filed on Dec. 1, 2011, the entire contents of which are incorporated herein by reference.

### TECHNICAL FIELD

The present invention relates to energy devices (e.g., a laminated type energy device and a chip type energy device), energy device electrode structure, and a fabrication method of the energy device electrode structure. More specifically, the present invention relates to a laminated type energy device utilized for internal electrodes (e.g., an electric double layered capacitor, a lithium ion capacitor, and a lithium ion battery); a chip type energy device utilized for a backup electronic power supply, a micro energy storage element, and a coupling capacitor, a smoothing capacitor, etc.; an energy device electrode structure whose reliability is enhanced, a fabrication method of the energy device electrode structure, and an energy device to which the energy device electrode structure is applied; and a laminated type energy device in which a miniaturization and cost reduction can be achieved, and a fabrication method of the laminated type energy device.

### BACKGROUND ART

Conventionally, a laminated type energy storage device, a laminated type electric double layered capacitor (EDLC), etc. has been known as a laminated type energy device. As a certain example, a laminated type energy storage device includes; a layered structure composed so as to laminate an electrode and a separator and to be impregnated with an electrolysis solution; a laminate sheet (aluminum laminated package) for sealing the layered structure inside thereof; and an extraction electrode extracted from the layered structure to an outside of the laminate sheet in order to electrically connect the layered structure to an external.

Many of conventional laminated type energy storage devices had a structure that a positive-negative pair of extraction electrodes is lengthily extracted from the laminated type energy storage device, for example. As a length of the extraction electrode becomes long, a space on a module substrate will be occupied, and thereby space-saving becomes difficult. Moreover, at high frequencies, a reactance (resistance component of a coil) is increased and impedance becomes high. Furthermore, when solder welding is performed in a weld hole of a soldered part in order to mount the laminated type energy storage device on the module substrate, a thermal load is applied to an electrolysis solution in the laminated type energy storage device, and thereby leading to degradation of characteristics.

In the conventional laminated type energy storage device, when forming the layered structure which laminates an electrode and a separator, the layered structure is fastened with a tape so that the layered structure may not collapse. Alternatively, such a layered structure is also prevented from the collapsing by laminating the electrode and the separator so that the separator is exposed to outside the layered structure (i.e., making the size of the separator larger than the size of the electrode) to fasten the exposed separators with a cord etc. each other. In the case where such a reinforcing means with a tape, a cord, etc. is used, marks due to the tape or the cord will appear on a portion reinforced when the layered structure is sealed with a laminate sheet. As a result, unevenness of adhesibility, inferiority of appearance, etc. will occur. Moreover, a complicated process for providing such a reinforcing means also increases, thereby leading to an increase in cost.

Since it causes a short when the size of the separator is not larger than that of the electrode (the area of the separator is not wider than that of the electrode), the package is also upsized as the upsizing of the separator, and thereby becoming difficult to install the package into a set.

With regard to the above-mentioned matters, an electric double layered capacitor composed to laminate a polarizable electrode, a collector electrode and a separator, and to be impregnated with an electrolysis solution is disclosed (refer to Patent Literature 1, for example). The electric double layered capacitor disclosed in the Patent Literature 1 sews at least the polarizable electrode and the collector electrode with a sewing thread to integrate the polarizable electrode and the collector electrode, and laminates and sews the integrated polarizable electrode and collector electrode and the separator with a sewing thread, thereby integrating the polarizable electrode, the collector electrode and the separator. According to the electric double layered capacitor disclosed in the Patent Literature 1, an electric contact between the electrodes is improved, and workability is enhanced.

On the other hand, technology of providing a thin-shaped high capacity capacitor is disclosed (refer to Patent Literature 2, for example). In the technology disclosed in Patent Literature 2, necessary number of collector electrodes on which a polarizable electrode layer is formed on the surface of band-shaped metallic foil and necessary number of band-shaped separators are overlaid alternately, and the overlaid collector electrodes and band-shaped separators are folded up in the shape of a folding screen.

Then, an electric double layered capacitor element is formed by impregnating the above-mentioned separator in an electrolysis solution, and the electric double layered capacitor element is enclosed with a suitable pack. Furthermore, lead tabs made from a metallic thin plate is bonded with each collector electrode mechanically and electrically, and the lead tabs are derived to an external through a sealing port of the above-mentioned pack.

It is also disclosed about technology for providing a battery and an electric double layered capacitorin with which basic cells having a separator, a pair of electrodes laminated so as to be opposed by sandwiching the separator, and an electrolysis solution are packed in a resin sheet container (refer to Patent Literature 3, for example). The battery and the electric double layered capacitorin disclosed in Patent Literature 3 have a configuration that the basic cells are laminated in series via sheet-shaped collector electrodes, the sheet-shaped collector electrodes extend to an edge of the resin sheet container over a perimeter of the basic cell laminated on the both sides, and are bonding or fused to the resin sheet container at the edge, and the basic cells adjoining via the sheet-shaped collector electrode are liquid-tight separated in the resin sheet container. Accordingly, the above-mentioned configuration disclosed in Patent Literature 3 can provide a small-sized battery and a small-sized electric double layered capacitor with sufficient cell voltage and/or electric strength of capacitor.

A certain conventional chip type energy storage device as one of chip type energy devices had an uncomplicated structure of housing an electrode structure in which a separator is inserted in one pair of bulk positive and negative active material electrodes in a package of ceramic structure and sealing the package. However, since a comparatively thick active material electrode (whose specific surface area is great) was used, it had a problem that internal electrical resistance is increased.

Moreover, as a small-sized chip type energy storage device, a circular chip type energy storage device and a button type battery is known as a coin type battery. However, since one pair (or two pairs in order to increase voltage) of the comparatively thick active material electrodes (whose specific surface area is great) were caulked as an electrode structure, it had a problem that an internal electrical resistance was similarly is increased after all.

Furthermore, since a chip type energy storage device as a coin type battery or a button type battery is circle-shaped, mounting area is smaller than a square-shaped energy storage device, thereby having a limit to the miniaturization.

Moreover, in the conventional chip type energy storage device, the electrode structure was housed in the package after impregnating the electrode structure with an electrolysis solution. In particular, in the case of a chip type energy storage device, when sealing the package by using an organic based sealing member, there was a possibility that the characteristics might deteriorate due to elution to the electrolysis solution.

With regard to the above-mentioned matters, for example, in a coin type or button type circular nonaqueous electrolyte battery and electric double layered capacitor, it is disclosed about technology for achieving saving-space on a substrate by integrating connecting terminal and a housing container to disposing at a lower part of the container (refer to Patent Literature 4, for example).

On the other hand, it is disclosed about technology for providing an electrochemical cell configured so that a conducting film is formed from a bottom surface of a recessed region to an opening edge (refer to Patent Literature 5, for example). According to the electrochemical cell disclosed in Patent Literature 5, a current collector and an external electrode can be easily connected in low cost, and the sealing characteristics of the container are securable since neither a leadframe nor a VIA is used.

Moreover, it is disclosed about technology for providing an electric double layered capacitor composed so that moisture of a polarizable electrode is removed enough, and bonding between the polarizable electrode and a current collector is maintained solidly (refer to Patent Literature 6, for example). According to the electric double layered capacitor disclosed in Patent Literature 6, an increase in internal electrical resistance due to a repetition of charge and discharge and a floating electric charge with a high voltage can be reduced, and thereby long-term reliability can be secured.

It is also disclosed about technology for providing a coin type electric double layered capacitor composed using a gasket which is thermoplastic resin and performed thermal compression molding in not more than the melting point of resin from a raw material molded part (refer to Patent Literature 7, for example). According to the coin type electric double layered capacitor disclosed in Patent Literature 7, leakage resistance in reflow soldering is improved, and the reliability can be secured.

Moreover, a laminated type energy storage device, an electric double layered capacitor, etc. as a conventional energy device are known (refer to Patent Literatures 1-3, for example).

It is disclosed also about a fabrication method of an electrode for use in electric double layered capacitors which is an electrode having a high-density electrode layer by calendaring treatment (refer to Patent Literature 8, for example).

Moreover, various technology with respect to the electric double layered capacitor has been proposed (refer to Patent Literature 2, for example).

### CITATION LIST

Patent Literature 1: Japanese Patent Application Laying-Open Publication No. 2000-12407
Patent Literature 2: Japanese Patent Application Laying-Open Publication No. 2001-338848
Patent Literature 3: Japanese Patent Application Laying-Open Publication No. 2003-217646
Patent Literature 4: Japanese Patent Application Laying-Open Publication No. 2001-216952
Patent Literature 5: Japanese Patent Application Laying-Open Publication No. 2010-192874
Patent Literature 6: Japanese Patent Application Laying-Open Publication No. 2008-211116
Patent Literature 7: Japanese Patent Application Laying-Open Publication No. 2002-050551
Patent Literature 8: Japanese Patent Application Laying-Open Publication No. 2005-191424

### SUMMARY OF THE INVENTION

### Technical Problem

The object of the present invention is to provide a laminated type energy device which can enhance a sealing ability and an adhesibility between a layered structure and a sealing body which houses the layered structure, and a degree of space-saving, and uses sealing means with sufficient productivity and reliability.

Another object of the present invention is to provide a laminated type energy device which is compact shaped, can enhance high frequency characteristics, and uses sealing means with sufficient productivity and reliability.

The further object of the present invention is to provide a chip type energy device which can obtain high power and can reduce internal electrical resistance, even in a field of chip type energy device.

The object of a present invention is to provide a chip type energy device which can improve an adhesibility, can suppress an effect of electrolysis solutions on degradation etc., and can be sealed with a package having high strength.

By the way, the fabrication method of the electrode for use in electric double layered capacitors described in Patent Literature 8 includes the steps of: forming an undercoat layer including a binder which can be bound to electric conduction particles on the collector electrode; and forming the electrode layer on the undercoat layer by coating a coating liquid for use in electrode layers including electric conduction particles, the binder, a solvent, and activated carbon. Moreover, the step of forming the electrode layer includes the steps of: drying the electrode layer under not more than 200 degrees C. so that residual solvent volume included in the layer on the collector electrode becomes 5 to 35 percent of the weight after coating the coating liquid for use in the electrode layers, subjecting the electrode layer to a roll press after the drying, and subjecting the electrode layer to vacuum drying.

In each of above-mentioned steps, since the thermal resistance of the applied binder is low, the electrode layer will deteriorate when subjecting the electrode layer to high temperature drying. Accordingly, since the high temperature drying cannot be applied, it is difficult to reduce the residual water volume. Moreover, when subjecting the electrode layer to the roll press in the condition that the residual solvent is included, active materials (e.g., activated carbon) adhere to a roll press machine, and then the electrode layer is easily removed from the collector electrode (aluminum foil). Furthermore, denaturation and degradation due to heat of the electrode layer occur, therefore, the adhesibility with the undercoat layer is reduced, and the electrode layer is easily removed.

The further object of the present invention is to provide an energy device electrode structure whose reliability can be enhanced, a fabrication method of such an energy device electrode structure, and an energy device to which such an energy device electrode structure is applied.

On the other hand, electric strength of the electric double layered capacitor is low, and its voltage which can be charged is also low. Accordingly, when a high voltage is required, a plurality of the electric double layered capacitors is connected in series.

In this case, the conventional electric double layered capacitors packaged by laminate is overlaid, when tab electrodes is welded to be connected in series, space occurs in the laminated packages and the whole capacity is increased.

Moreover, as for each electric double layered capacitor packed with laminate, the tab electrodes are bonded to each extraction electrode (metallic foil). The tab electrode used for the electric double layered capacitor etc. packed with laminate is composed of Cu with which Ni is plated, Al, Ni, etc. Accordingly, the tab electrode is relatively expensive as a component member, and therefore an increase in the number of the electric double layered capacitors connected in series affects the whole cost.

The further object of the present invention is to provide a laminated type energy device in which a miniaturization and cost reduction can be achieved, and a fabrication method of the laminated type energy device.

### Solution to Problem

According to an aspect of the present invention, provided is a laminated type energy device including: at least two layers of layered structure in which a positive electrode and a negative electrode are alternately laminated so that positive and negative extraction electrodes are exposed, inserting a separator in which an electrolysis solution and ion pass therethrough between positive and negative active material electrodes; a laminate sheet overlaid from a front surface and a back surface of the layered structure to compressively seal the layered structure; and a contact hole for performing spot bonding of the laminated type energy device to a module substrate.

According to another aspect of the present invention, provided is a laminated type energy device including: at least two layers of layered structure in which a positive electrode and a negative electrode are alternately laminated so that positive and negative extraction electrodes are exposed, inserting a separator in which an electrolysis solution and ion pass therethrough between a positive and negative active material electrode connected in a series, and so that the separators are respectively laminated on a topmost part and a lowermost part, the separator whose area is wider than those of the active material electrodes being used so that whole of the active material electrode is covered; and a bonded structure in which the separators with respect to one another are punched collectively in the layered structure including the active material electrodes and the separator, and fiber structures of edge faces of the separators are entangled to be bonded mutually in the edge faces of the separators.

According to a further aspect of the present invention, provided is a chip type energy device including: at least two layers of layered structure in which a positive electrode and a negative electrode are alternately laminated so that extraction electrodes portions are exposed, inserting a separator between active material electrode portions of electrodes into which positive and negative active material electrodes and positive and negative extraction electrodes are integrated; a frame member for housing the layered structure, wherein through-holes for extracting terminal electrodes connected to the extraction electrodes to the outside thereof are formed in the frame member; a sealing cover for sealing an upper surface of the frame member; and a sealant for sealing a bottom surface of the frame member and the through-holes to impregnate a layered portion of the layered structure with an electrolyte.

According to another aspect of the present invention, provided is a chip type energy device including: at least two layers of layered structure in which a positive electrode and a negative electrode are alternately laminated so that extraction electrodes portions are exposed, inserting a separator between active material electrode portions of electrodes into which positive and negative active material electrodes and positive and negative extraction electrodes are integrated; a base on which the layered structure is mounted, wherein through-holes are formed in the base, terminal electrodes connected to the extraction electrodes are extracted through the through-holes to outside, and the through-holes functions as an injected hole for injecting an electrolysis solution including the electrolyte; a frame member for housing the layered structure mounted on the base; and a sealing cover for sealing an upper surface of the frame member.

According to a further aspect of the present invention, provided is an energy device electrode structure including: a collector electrode; an undercoat layer disposed on the collector electrode; and an active material electrode layer disposed on the undercoat layer and including a first binder with high-temperature thermal resistance, a melting point of the first binder being higher than 200 degrees C.

According to another aspect of the present invention, provided is a fabrication method of an energy device electrode structure including: coating a coating liquid for use in undercoat layer on a collector electrode; drying the coating liquid for use in undercoat layer to form an undercoat layer; coating a coating liquid for use in active material electrode layer including the first binder on the undercoat layer; drying the coating liquid for use in active material electrode layer to form an active material electrode layer; and subjecting a layered structure to a roll press, the layered structure being composed of the collector electrode, the undercoat layer, and the active material electrode layer.

According to another aspect of the present invention, provided is an electric double layered capacitor providing a positive and negative active material electrode structure with the energy device electrode structure mentioned above.

According to another aspect of the present invention, provided is a lithium ion capacitor providing a positive and negative active material electrode structure with the energy device electrode structure mentioned above.

According to another aspect of the present invention, provided is a Lithium ion battery providing a positive and negative active material electrode structure with the energy device electrode structure mentioned above.

According to a further aspect of the present invention, provided is a laminated type energy device including: a plurality of single cells having at least two layers of layered structure in which a positive electrode and a negative electrode are alternately laminated so that positive and negative extraction electrodes are exposed, inserting a separator in which an electrolysis solution and ion pass therethrough between positive and negative active material electrodes; a dividing laminate sheet by which the single cells are overlaid with respect to one another, the dividing laminate sheet being intervened between the single cells; an outer sealing laminate sheet which seals the whole of the single cells which are connected; and an electrolysis solution injected between the outer sealing laminate sheet and the dividing laminate sheet, wherein the plurality of the single cells are electrically connected via the extraction electrodes.

According to another aspect of the present invention, provided is a fabrication method of a laminated type energy device including: overlaying a plurality of single cells including at least two layers of layered structure in which a positive electrode and a negative electrode are alternately laminated so that positive and negative extraction electrodes are exposed, inserting a separator in which an electrolysis solution and ion pass therethrough between positive and negative active material electrodes; welding the extraction electrode to be connected to the plurality of the single cells in parallel or in series; welding a tab electrode to the connected extraction electrode and the extraction electrodes of both terminals side; disposing a sealant composed of a thermoplastic resin on an edge part of single cells side of the tab electrode; inserting a dividing laminate sheet in which a notched part is formed between each single cell, the sealant being set in the notched part; covering the connected single cell with an outer sealing laminate sheet; fusing an edge of the outer sealing laminate sheet in the condition that opening is formed in part thereof; injecting an electrolysis solution via the opening between the outer sealing laminate sheet and the dividing laminate sheet; and fusing the opening to be sealed.

### Advantageous Effects of Invention

According to the present invention, it can provide the laminated type energy device which can enhance the sealing ability and the adhesibility between the layered structure and the sealing body which houses the layered structure, and the degree of space-saving, and uses the sealing means with sufficient productivity and reliability.

Moreover, according to the present invention, it can provide the laminated type energy device which is compact shaped, can enhance the high frequency characteristics, and uses the sealing means with sufficient productivity and reliability.

According to the present invention, it can provide the chip type energy device which can obtain the high power and can reduce the internal electrical resistance, even in a field of chip type energy device.

Moreover, according to the present invention, it can provide the chip type energy device which can improve the adhesibility, can suppress the effect of the electrolysis solutions on degradation etc., and can be sealed with the package having high strength.

According to the present invention, it can provide the energy device electrode structure whose reliability can be enhanced, the fabrication method of such an energy device electrode structure, and an energy device to which such an energy device electrode structure is applied.

According to the present invention, it can provide the laminated type energy device in which the miniaturization and the cost reduction can be achieved, and the fabrication method of the laminated type energy device.

### BRIEF DESCRIPTION OF DRAWINGS

FIG. 1 is a perspective diagram showing a module substrate on which a laminated type energy storage device composed in a first embodiment shown in FIG. 15 is mounted.

FIG. 2 is a top view diagram showing a layered structure in which an electrode and a separator are laminated, in the laminated type energy storage device composed in the first embodiment.

FIG. 3A is a top view diagram showing a tab electrode with sealant (before processing) used in the layered structure shown in FIG. 2, in the first embodiment.

FIG. 3B is a top view diagram showing the tab electrode with sealant (after processing) used in the layered structure shown in FIG. 2, in the first embodiment.

FIG. 4 is a top view diagram showing an energy storage device in which the tab electrode with sealant shown in FIG. 3B is bonded to an aluminum extraction electrode of the layered structure of FIG. 2, in the first embodiment.

FIG. 5 is a cross-sectional diagram taken in the line I-I of the layered structure of FIG. 4, in the first embodiment.

FIG. 6 is a cross-sectional diagram taken in the line II-II of the layered structure of FIG. 4, in the first embodiment.

FIG. 7 is a diagram showing an example of embodying a multilayered structure of the layered structure used in the first embodiment.

FIG. 8 is a front view diagram showing an aluminum laminate sheet in which a hole is bored beforehand, aligning the hole with a hole of the tab electrode shown in FIG. 4, in the first embodiment.

FIG. 9 is a top view diagram shows an aspect that the aluminum laminate sheet shown in FIG. 8 is overlaid on the energy storage device shown in FIG. 4, in the first embodiment.

FIG. 10 is a top view diagram showing an aspect that the aluminum laminate sheet shown in FIG. 8 is compressed to be sealed from the front surface and the back surface to the energy storage device shown in FIG. 4, and then an electrolysis solution injection port is formed in the aluminum laminate sheet, in the first embodiment.

FIG. 11 is a diagram showing an aspect that the energy storage device shown in FIG. 10 is immersed in an electrolytic bath to impregnate with an electrolysis solution, and electrical aging is performed, in the first embodiment.

FIG. 12 is a diagram showing an energy storage device in which the electrolysis solution injection port is closed to be sealed with the aluminum laminate sheet, after the energy storage device shown in FIG. 11 is pulled up from the electrolytic bath, in the first embodiment.

FIG. 13A is a top view diagram showing an example of cutting the aluminum tab electrode of the energy storage device shown in FIG. 12, in the first embodiment.

FIG. 13B is a cross-sectional diagram taken in the line of FIG. 13A.

FIG. 14A is a top view diagram showing an aspect that the aluminum laminate sheet of the energy storage device shown in FIG. 13 is recompressed to insulate an aluminum end face of the aluminum laminate sheet, in the first embodiment.

FIG. 14B is a cross-sectional diagram taken in the line IV-IV of FIG. 14A.

FIG. 15 is a diagram showing an aspect that the energy storage devices shown in FIG. 14 are detached, respectively, to be completed as a respective laminated type energy storage device, in the first embodiment.

FIG. 16A is a diagram showing various examples of a position of the tab electrode extraction hole formed in the laminated type energy storage device, in the first embodiment.

FIG. 16B is a diagram showing alternative various examples of a position of the tab electrode extraction hole formed in the laminated type energy storage device, in the first embodiment.

FIG. 16C is a diagram showing another alternative various examples of a position of the tab electrode extraction hole formed in the laminated type energy storage device, in the first embodiment.

FIG. 17A is a diagram showing various examples of the laminated type energy storage device in which the aluminum tab electrode is disposed, aligning the aluminum tab electrode with the tab electrode extraction hole shown in FIG. 16A, in the first embodiment.

FIG. 17B is a diagram showing alternative various examples of the laminated type energy storage device in which the aluminum tab electrode is disposed, aligning the aluminum tab electrode with the tab electrode extraction hole shown in FIG. 16A, in the first embodiment.

FIG. 17C is a diagram showing various examples of the laminated type energy storage device in which the aluminum tab electrode is disposed, aligning the aluminum tab electrode with the tab electrode extraction hole shown in FIG. 16C, in the first embodiment.

FIG. 17D is a diagram showing alternative various examples of the laminated type energy storage device in which the aluminum tab electrode is disposed, aligning the aluminum tab electrode with the tab electrode extraction hole shown in FIG. 16C, in the first embodiment.

FIG. 18 is a front view diagram showing an internal electrode of an electric double layered capacitor in the second embodiment.

FIG. 19 is a front view diagram showing an internal electrode of a lithium ion capacitor in the second embodiment.

FIG. 20 is a front view diagram showing an internal electrode of a lithium ion battery in the second embodiment.

FIG. 21A is a front view diagram showing a sheet (electrode sheet of positive electrode side) in which an active material is distinguished by different coats on an upper surface of aluminum foil, in the second embodiment.

FIG. 21B is a front view diagram showing a sheet (electrode sheet of negative electrode side) in which the active material is distinguished by different coats on the upper surface of the aluminum foil, in the second embodiment.

FIG. 22A is a front view diagram which shows an aluminum electrode (aluminum electrode of positive electrode side) in which the sheet shown in FIG. 21 is punched to form an arbitrary electrode structure, in the second embodiment.

FIG. 22B is a front view diagram which shows an aluminum electrode (aluminum electrode of negative electrode side) in which the sheet shown in FIG. 21 is punched to form an arbitrary electrode structure, in the second embodiment.

FIG. 23 is a perspective diagram showing a layered structure in which (using resistance welding, ultrasonic welding) extraction electrodes among the positive electrodes/among the negative electrodes are welded, aligning in sequence of a separator, a positive electrode, a separator, a negative pole electrode, a separator, and a positive electrode . . . , with regard to the aluminum electrode shown in FIG. 22, in the second embodiment.

FIG. 24 is a cross-sectional diagram taken in the line V-V of the layered structure shown in FIG. 23, in the second embodiment.

FIG. 25 is a perspective diagram showing a punching die for punching the separator of the layered structure shown in FIG. 23, in the second embodiment.

FIG. 26 is a perspective diagram of a layered structure showing a welded part at the time of welding the extraction electrode of the layered structure shown in FIG. 23 performed previous to the punching, in the second embodiment.

FIG. 27 is a perspective diagram of a layered structure showing a punching part at the time of punching the separator of the layered structure shown in FIG. 26 using the punching die, in the second embodiment.

FIG. 28 is the perspective diagram of a layered structure showing an aspect the separator of the layered structure shown in FIG. 27 is punched using the punching die, in the second embodiment.

FIG. 29 is a cross-sectional diagram taken in the line VI-VI of the layered structure shown in FIG. 28, in the second embodiment.

FIG. 30 is a front view diagram of a layered structure showing an aspect that an external extraction tab electrode (aluminum tab electrodes 34a and 34b) is welded to the extraction electrode of the layered structure shown in FIG. 28 to compose a common electrode part as a tab electrode, in the second embodiment.

FIG. 31 is a front view diagram of a layered structure showing an aspect that the layered structure (the punched separators) shown in FIG. 30 is laminated with an aluminum laminate material, in the second embodiment.

FIG. 32 is a cross-sectional diagram showing a layered structure (the punched separators) laminated with the aluminum laminate material shown in FIG. 31, in the second embodiment.

FIG. 33 is a cross-sectional diagram showing details of the layered structure (the punched separators) laminated with the aluminum laminate material shown in FIG. 31, in the second embodiment.

FIG. 34 is a diagram showing an example of forming the aluminum electrode shown in FIG. 22 by using a roll press (roll-to-roll technology), in the second embodiment.

FIG. 35A is a diagram showing materials of an active material electrode and an extraction electrode both used for a chip type energy device according to a third embodiment, and is a perspective diagram of the aluminum foil to which an active material is coated on only portion used as an active material electrode.

FIG. 35B is a perspective diagram showing an aspect that the aluminum foil shown in FIG. 35A is cut in rectangles.

FIG. 36A is a top view diagram showing a layered structure in which positive/negative electrodes are laminated alternately so that a portion which is not coated with the active material is exposed as the extraction electrode, inserting a separator into the aluminum foil shown in FIG. 35B and coated partially with the active material.

FIG. 36B is a cross-sectional diagram taken in the line VII-VII of FIG. 36A.

FIG. 37 is a cross-sectional diagram showing internal electrode structure in which a tab electrode is welded to the extraction electrode of the layered structure shown in FIG. 36.

FIG. 38A is a top view diagram showing a ceramic frame member having a housing recess for housing the internal electrode structure shown in FIG. 37.

FIG. 38B is a cross-sectional diagram taken in the line VIII-VIII of FIG. 38A showing an example of housing the internal electrode structure in the housing recess of the ceramic package.

FIG. 39 is a cross-sectional diagram showing an example of a chip composed by covering an upper surface of the chip shown in FIG. 38 with a metallic sealing cover, and filling up a bottom surface thereof with a ceramic adhesive agent.

FIG. 40 is a cross-sectional diagram showing an example of setting a press machine on the upper surface and bottom surface of the chip shown in FIG. 39.

FIG. 41 is a cross-sectional diagram showing an example of applying pressure to the chip from upward and downward with the press machine shown in FIG. 40.

FIG. 42A is a diagram showing an example of the chip to which pressure was applied by the press machine as shown in FIG. 41, and showing a chip after removing the press machine therefrom.

FIG. 42B is a cross-sectional diagram taken in the line IX-IX of FIG. 42A.

FIG. 43 is a cross-sectional diagram showing an example of removing the ceramics adhesives from the bottom surface of the chip shown in FIG. 42.

FIG. 44 is a cross-sectional diagram showing an example of immersing the chip shown in FIG. 43 in an electrolytic bath.

FIG. 45 is a cross-sectional diagram showing an example of a chip type energy device completed by filling up the bottom surface of the chip pulled up from the electrolytic bath shown in FIG. 44 with an adhesive agent, and molding an outer package of the chip.

FIG. 46A is a cross-sectional diagram showing an example of an internal electrode structure used for a chip type energy device according to a fourth embodiment, and showing an example of bonding a ceramic base to a bottom surface of the internal electrode structure shown in FIG. 37.

FIG. 46B is a cross-sectional diagram taken in the line X-X of FIG. 46A.

FIG. 47 is a diagram showing an example of a chip composed by housing the internal electrode structure shown in FIG. 46 in the recessed region of the ceramic frame member, and covering an upper surface of the ceramic package with a metallic sealing cover.

FIG. 48 is a cross-sectional diagram showing an example of setting a press machine on the upper surface and bottom surface of the chip shown in FIG. 47.

FIG. 49 is a cross-sectional diagram showing an example of applying pressure to the chip from upward and downward with the press machine shown in FIG. 48.

FIG. 50 is a cross-sectional diagram showing an example of removing the press machine from the chip to which the pressure was applied as shown in FIG. 49.

FIG. 51 is a cross-sectional diagram showing an example of immersing the chip shown in FIG. 50 in an electrolytic bath.

FIG. 52 is a cross-sectional diagram showing an example of a chip type energy device completed by molding an outer package of the chip pulled up from the electrolytic bath shown in FIG. 51.

FIG. 53 is a schematic cross-sectional structure diagram showing an energy device electrode structure according to a fifth embodiment.

FIG. 54 is a schematic cross-sectional structure diagram showing an energy device electrode structure according to a modified example 1 of the fifth embodiment.

FIG. 55 is a schematic cross-sectional structure diagram showing an energy device electrode structure according to a modified example 2 of the fifth embodiment.

FIG. 56 is a schematic cross-sectional structure diagram showing an energy device electrode structure according to a modified example 3 of the fifth embodiment.

FIG. 57 is a diagram showing a chemical formula of poly-tetrafluoroethylene (PTFE) as a binder applied to the energy device electrode structure according to the fifth embodiment.

FIG. 58 shows an example of a scanning electron microscope (SEM) photograph of an active material electrode layer to which the poly-tetrafluoroethylene (PTFE) is applied as the binder applied to the energy device electrode structure according to fifth embodiment.

FIG. 59 is a schematic explanatory diagram of the active material electrode layer to which the poly-tetrafluoroethylene (PTFE) is applied as the binder applied to the energy device electrode structure according to the fifth embodiment.

FIG. 60 is a diagram showing a chemical formula of a poly-vinylidene fluoride (PVdF) as a binder of a comparative example of the fifth embodiment.

FIG. 61 shows an example of an SEM photograph of an active material electrode layer to which the poly-vinylidene fluoride (PVdF) is applied as the binder of the comparative example of the fifth embodiment.

FIG. 62A is a schematic explanatory diagram of the active material electrode layer to which the poly-vinylidene fluoride (PVdF) is applied as the binder of the comparative example of the fifth embodiment.

FIG. 62B is a diagram showing details of FIG. 62A.

FIG. 63 is a diagram showing a chemical formula of aramid resin (poly-meta-phenyleneisophthalamide) as a binder applied to the energy device electrode structure according to the fifth embodiment.

FIG. 64 shows an example of an SEM photograph of an active material electrode layer to which the aramid resin (poly-meta-phenyleneisophthalamide) is applied as a binder applied to the energy device electrode structure according to the fifth embodiment.

FIG. 65A is a schematic explanatory diagram of the active material electrode layer to which the aramid resin (poly-meta-phenyleneisophthalamide) is applied as the binder applied to the energy device electrode structure according to the fifth embodiment.

FIG. 65B is a diagram showing details of FIG. 65A.

FIG. 66A is a schematic cross-sectional structure diagram for explaining one process (phase 1) of a fabrication method of the energy device electrode structure according to the fifth embodiment.

FIG. 66B is a schematic cross-sectional structure diagram for explaining one process (phase 2) of the fabrication method of the energy device electrode structure according to the fifth embodiment.

FIG. 66C is a schematic cross-sectional structure diagram for explaining one process (phase 3) of the fabrication method of the energy device electrode structure according to the fifth embodiment.

FIG. 66D is a schematic cross-sectional structure diagram for explaining one process (phase 4) of the fabrication method of the energy device electrode structure according to the fifth embodiment.

FIG. 67A is a schematic cross-sectional structure diagram for explaining one process (phase 5) of the fabrication method of the energy device electrode structure according to the fifth embodiment.

FIG. 67B is a schematic cross-sectional structure diagram for explaining one process (phase 6) of the fabrication method of the energy device electrode structure according to the fifth embodiment.

FIG. 68 is a schematic cross-sectional structure diagram for explaining one process (roll press process) of the fabrication method of the energy device electrode structure according to the fifth embodiment.

FIG. 69A is a schematic bird's-eye view configuration diagram for explaining one process (phase 1) of a fabrication method of an energy device electrode structure according to a sixth embodiment.

FIG. 69B is a schematic bird's-eye view configuration diagram for explaining one process (phase 2) of the fabrication method of the energy device electrode structure according to the sixth embodiment.

FIG. 69C is a schematic bird's-eye view configuration diagram for explaining one process (phase 3) of the fabrication method of the energy device electrode structure according to the sixth embodiment.

FIG. 69D is a schematic bird's-eye view configuration diagram for explaining one process (phase 4) of the fabrication method of the energy device electrode structure according to the sixth embodiment.

FIG. 69A is a schematic bird's-eye view configuration diagram for explaining one process (phase 5) of the fabrication method of the energy device electrode structure according to the sixth embodiment.

FIG. 70B is a schematic bird's-eye view configuration diagram for explaining one process (phase 6) of the fabrication method of the energy device electrode structure according to the sixth embodiment.

FIG. 71 is a schematic cross-sectional structure diagram for explaining one process (roll press process) of the fabrication method of the energy device electrode structure according to the sixth embodiment.

FIG. 72 is a schematic cross-sectional structure diagram showing an electric double layered capacitor to which the energy device electrode structure according to the fifth or sixth embodiment is applied.

FIG. 73 is a schematic cross-sectional structure diagram showing a lithium ion capacitor to which the energy device electrode structure according to the fifth or sixth embodiment is applied.

FIG. 74 is a schematic cross-sectional structure diagram showing a lithium ion battery to which the energy device electrode structure according to the fifth or sixth embodiment is applied.

FIG. 75A is a schematic bird's-eye view configuration diagram showing an energy device according to a seventh embodiment.

FIG. 75B is a schematic bird's-eye view configuration diagram showing an example of a module substrate on which the energy device according to the seventh embodiment is mounted.

FIG. 76A is a top view diagram showing an energy device in which the tab electrode with sealant shown in FIG. 3B is bonded to the aluminum extraction electrode of the layered structure of FIG. 2, in the seventh embodiment.

FIG. 76B is a top view diagram showing an energy device in which a tab electrode with sealant not having a contact hole (bonding hole) is bonded to the aluminum extraction electrode.

FIG. 77A is a schematic cross-sectional structure diagram taken in the line XI-XI line of the layered structure of FIG. 76, in the seventh embodiment.

FIG. 77B is a schematic cross-sectional structure diagram taken in the line XI-XI of the layered structure including three pairs of positive and negative electrodes.

FIG. 78 is a schematic cross-sectional structure diagram taken in the line XII-XII of the layered structure of FIG. 76, in the seventh embodiment.

FIG. 79A is a diagram showing an aspect of completing as one laminated type energy device (having a contact hole (bonding hole)), in the seventh embodiment.

FIG. 79B is a diagram showing an aspect of completing as one laminated type energy device (not having a contact hole (bonding hole)), in the seventh embodiment.

FIG. 80A is a diagram showing an elementary substance of a laminated type energy device as a comparative example of the seventh embodiment.

FIG. 80B is a diagram showing an elementary substance of another laminated type energy device as the comparative example of the seventh embodiment.

FIG. 80C is a diagram showing an aspect that the elementary substances of the laminated type energy device as the comparative example of the seventh embodiment are overlaid to be connected in parallel.

FIG. 81A is a diagram showing an elementary substance of a laminated type energy device in which positive and negative electrodes are formed in placing to the left, as the comparative example of the seventh embodiment.

FIG. 81B is a diagram showing an elementary substance of a laminated type energy device in which the positive and negative electrodes are formed in placing to the right, as the comparative example of the seventh embodiment.

FIG. 82 is a diagram showing an aspect that the elementary substances of the laminated type energy device as the comparative example of the seventh embodiment are overlaid to be connected in series.

FIG. 83 is a diagram showing one process of a fabricating process of the laminated type energy device according to the seventh embodiment, and showing a state where two single cells are opposed via a dividing laminate sheet.

FIG. 84A is a top view diagram showing a configuration example of a dividing laminate sheet having a notched part.

FIG. 84B shows a configuration example of the dividing laminate sheet, and is a schematic cross-sectional structure diagram taken in the line XIII-XIII of FIG. 84A.

FIG. 84C shows a configuration example of the dividing laminate sheet, and is a schematic cross-sectional structure diagram taken in the line XIV-XIV of FIG. 84A.

FIG. 85A is a front view diagram showing one process of the fabricating process of the laminated type energy device according to the seventh embodiment, and showing a state where two single cells are overlaid via the dividing laminate sheet.

FIG. 85B is a top view diagram showing one process of the fabricating process of the laminated type energy device according to the seventh embodiment, and showing a state where two single cells are overlaid via the dividing laminate sheet.

FIG. 86 is a schematic cross-sectional structure diagram taken in the line XV-XV of the configuration shown in FIG. 85 that the single cells are overlaid via the dividing laminate sheet.

FIG. 87 is a schematic cross-sectional structure diagram taken in the line XVI-XVI of the configuration shown in FIG. 85 that the single cells are overlaid via the dividing laminate sheet.

FIG. 88 is a schematic cross-sectional structure diagram taken in the line XVII-XVII of the configuration shown in FIG. 85 that the single cells are overlaid via the dividing laminate sheet.

FIG. 89A is a diagram showing a state where the single cells are overlaid via the dividing laminate sheet, and is a front view diagram showing a state where the positive electrode and the negative electrode are welded and to be bonded.

FIG. 89B is a schematic bird's-eye view configuration diagram showing a state where the single cells are overlaid via the dividing laminate sheet.

FIG. 90 is a configuration diagram showing an aspect that three pieces of the single cell are connected in series, in the laminated type energy device according to the seventh embodiment.

FIG. 91 is a configuration diagram showing an aspect that four pieces of the single cell are connected in series, in the laminated type energy device according to the seventh embodiment.

FIG. 92 shows one process of the fabricating process of the laminated type energy device according to the seventh embodiment, and is a schematic bird's-eye view configuration diagram showing a state where the whole of two pieces of the single cell connected in series with an outer sealing (packaging) laminate sheet is covered.

FIG. 93 shows one process of the fabricating process of the laminated type energy device according to the seventh embodiment, and is a schematic diagram showing a state where an edge of the outer sealing (packaging) laminate sheet is fused in the condition that an opening is formed in part thereof.

FIG. 94A shows one process of the fabricating process of the laminated type energy device according to the seventh embodiment, and is a schematic bird's-eye view configuration diagram showing a state of injecting an electrolysis solution into between the outer sealing (packaging) laminate sheet and the dividing laminate sheet via the opening.

FIG. 94B shows one process of the fabricating process of the laminated type energy device according to the seventh embodiment, and is a schematic bird's-eye view configuration diagram showing a state of injecting the electrolysis solution 44 from two pieces of the openings.

FIG. 95 shows one process of the fabricating process of the laminated type energy device according to the seventh embodiment, and is a schematic diagram showing a state of fusing an edge of the side where the opening is formed.

FIG. 96 is a circuit diagram showing a configuration example of an emitting circuit of an LED flash to which the laminated type energy device according to the seventh embodiment is applied.

FIG. 97A is a diagram showing an elementary substance of a laminated type energy device according to an eighth embodiment.

FIG. 97B is a diagram showing an elementary substance of anther laminated type energy device according to the eighth embodiment.

FIG. 97C is a laminated type energy device according to the eighth embodiment, and is a diagram showing a state where the elementary substances of the laminated type energy device shown in FIGS. 97A and 97B are overlaid to be connected in parallel.

FIG. 97D is a laminated type energy device according to the eighth embodiment, and is a diagram showing a state where a tab electrode is bonded to the laminated type energy device connected in parallel.

FIG. 97E is a laminated type energy device according to the eighth embodiment, and a diagram showing a configuration not forming a tab electrode extraction hole.

FIG. 98 is a schematic bird's-eye view configuration diagram showing a state where a dividing laminate sheet is inserted between the single cells of the laminated type energy device connected in parallel, in the laminated type energy device according to the eighth embodiment.

FIG. 99 is an explanatory diagram showing a state where the extraction electrode 32 and the tab electrode are welded to be bonded.

FIG. 100A is a schematic cross-sectional diagram showing a configuration in the case of forming a notched part in the dividing laminate sheet.

FIG. 100B is a schematic cross-sectional diagram showing a configuration in the case of not forming a notched part in the dividing laminate sheet.

FIG. 101 is a schematic cross-sectional diagram showing a state where the extraction electrodes are welded to be bonded at an outside of the sealant.

### DESCRIPTION OF EMBODIMENTS

Next, embodiments of the invention will be described with reference to drawings. In the description of the following drawings, the identical or similar reference numeral is attached to the identical or similar part. However, it should be known about that the drawings are schematic and the relation between thickness and the plane size and the ratio of the thickness of each layer differs from an actual thing. Therefore, detailed thickness and size should be determined in consideration of the following explanation. Of course, the part from which the relation and ratio of a mutual size differ also in mutually drawings is included.

Moreover, the embodiments shown hereinafter exemplify the apparatus and method for materializing the technical idea of the present invention; and the embodiments of the present invention does not specify the material, shape, structure, placement, etc. of component parts as the following. Various changes can be added to the technical idea of the present invention in scope of claims.

### First Embodiment

### (Fundamental Structure of Laminated Type Energy Device)

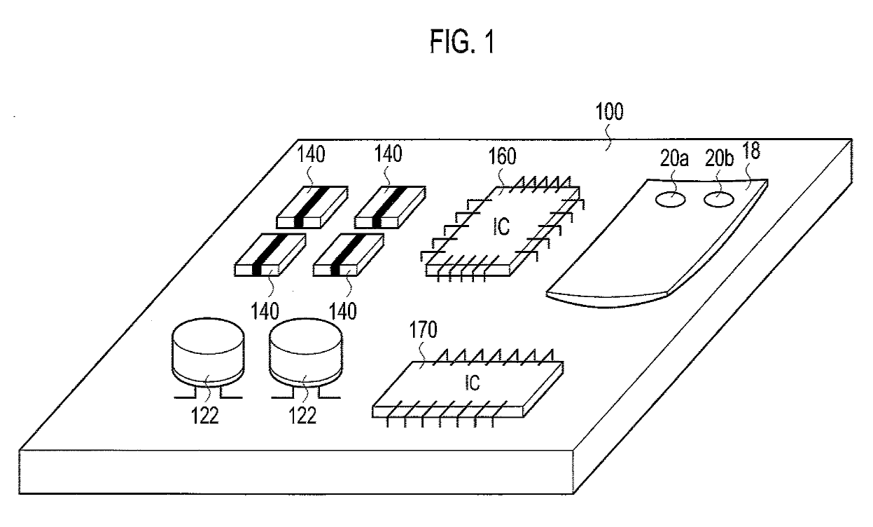

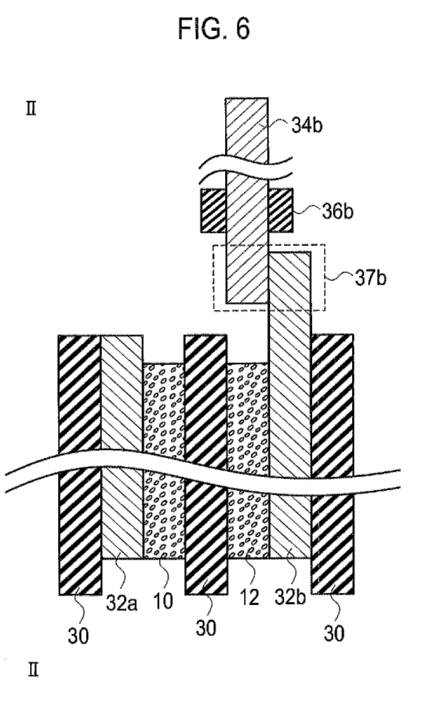

With reference to FIGS. 1-17, a fundamental structure of a laminated type energy device (e.g., an energy storage device) according to a first embodiment will be explained.

The laminated type energy storage device 18 according to the first embodiment includes: at least two (or more) layers of layered structure 80 in which a positive electrode and a negative electrode are alternately laminated so that positive and negative extraction electrodes 32a and 32b are exposed, inserting a separator 30 in which an electrolysis solution and ion pass therethrough between positive and negative active material electrodes 10 and 12; and contact holes 20a and 20b for use in spot bonding of the laminated type energy device to a module substrate 100, wherein laminate sheets 40a and 40b overlaid from a front surface and a back surface of a layered structure 80 to compressively seal the layered structure 80.

The laminated type energy storage device 18 according to the first embodiment includes: the contact holes (bonding hole) 20a and 20b for use in the spot bonding between the laminated type energy storage device 18 and the module substrate 100 as shown in FIG. 1. As the laminated type energy storage device 18, for example, a thing used as a basic module and mounted on a printed circuit board is assumed. Generally, plenty of parts (e.g., IC chips 160 and 170, a transformer 122 and other device parts 140) except the laminated type energy storage device 18 are mounted on the module substrate 100. Accordingly, the point of forming the contact holes 20a and 20b in the laminated type energy storage device 18 contributes to mounting of the laminated type energy storage device 18 within a limited space. Moreover, since the spot bonding in the contact holes (bonding hole) 20a and 20b is achieved when the module is mounted, a thermal load to the electrolysis solution which is impregnated into the layered structure 80 in the laminated type energy storage device 180 is reduced, contribution of a coil component also is reduced, and thereby high frequency characteristics is improved.

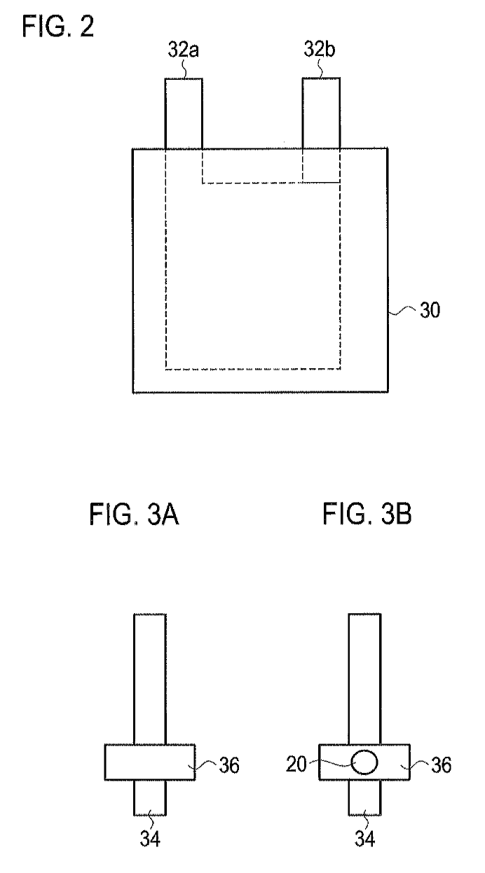

Moreover, as shown in FIGS. 2-17, since the contact holes 20a and 20b provided in the laminated type energy storage device 18 according to the first embodiment can function as the tab electrode extraction holes 20a and 20b used for extracting the tab electrode 34 (34a and 34b), it is not necessary to be configured that the tab electrode 34 (34a and 34b) is extract to the external. Accordingly, since the extraction electrode is unnecessary, the laminated type energy storage device 18 can be compact shape, and thereby it is easy to build the laminated type energy storage device 18 into a module. That is, it is not necessary to guide the tab electrode from the laminated type energy storage device at the time of modularization.

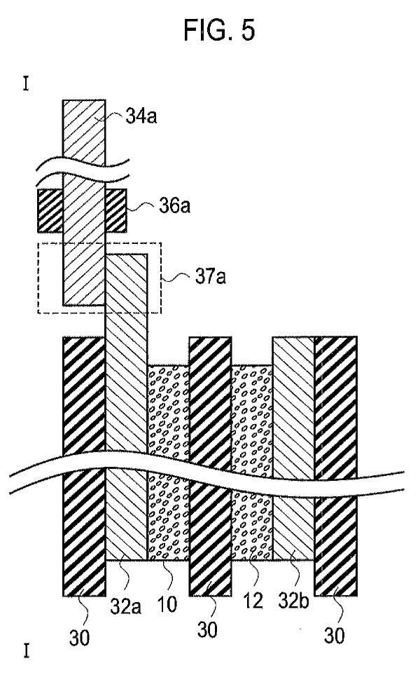

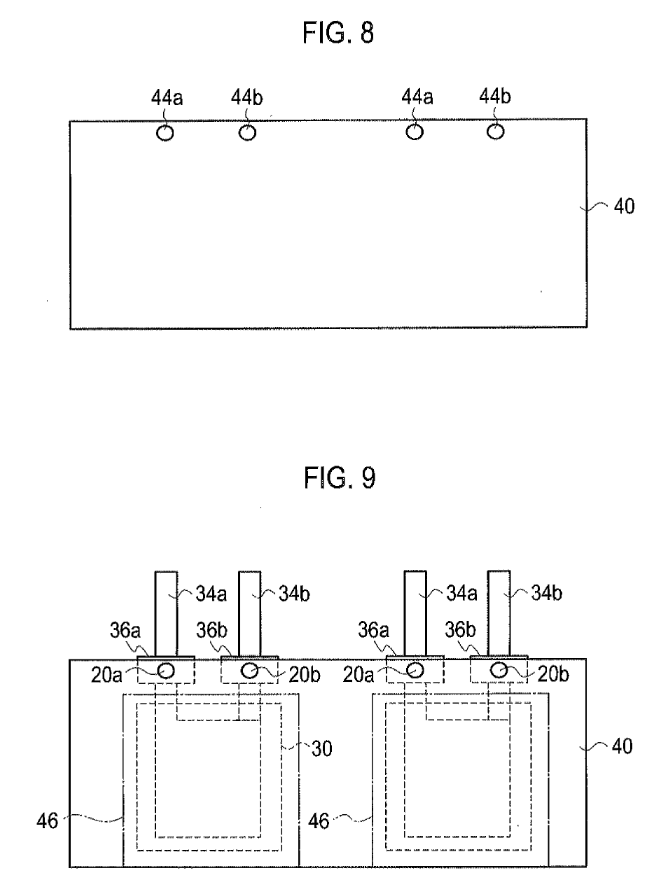

More specifically, as shown in FIGS. 2-7, a part of both surfaces of the sealant 36 of the (aluminum) tab electrode 34 (34a and 34b) used for the (aluminum) extraction electrodes 32a and 32b is shaved until an aluminum material of the tab electrode 34 (34a and 34b) is exposed, in order to form the tab electrode extraction holes 20a and 20b. Then, as shown in FIG. 8, holes 44a and 44b are beforehand bored also in the aluminum laminate 40 to be aligned with the same position as the tab electrode extraction holes 20a and 20b. When sealing the layered structure 80 of an internal electrode, the laminate sheet 40 is compressed to be sealed from a front surface and a back surface of the layered structure 80, aligning the tab electrode extraction holes 20a and 20b with the holes 44a and 44b, as shown in FIGS. 9-14. In addition, since the tab electrode extraction holes 20a and 20b and the holes 44a and 44b do not need to be circular holes, the desired shaped hole can also be used for the tab electrode extraction holes 20a and 20b and the holes 44a and 44b. An internal electrode structure (e.g., storage element) in the laminated type energy storage device 18 according to the first embodiment is composed of the layered structure 80 having multilayered structure in which the positive electrode 10 and the negative electrode 12 are alternately laminated so that the extraction electrode 32 (32a and 32b) is exposed, while inserting the separator 30 in which an electrolysis solution and ion pass therethrough between at least two (or more) layers of the active material electrodes 10 and 12, as shown in FIGS. 5-8. As shown in FIGS. 5-7, an edge part of an upper side of the extraction electrode 32 (32a and 32b) is bonded to an edge part of the tab electrode 34 (34a and 34b) at a welded part 37 (37a and 37b), respectively.

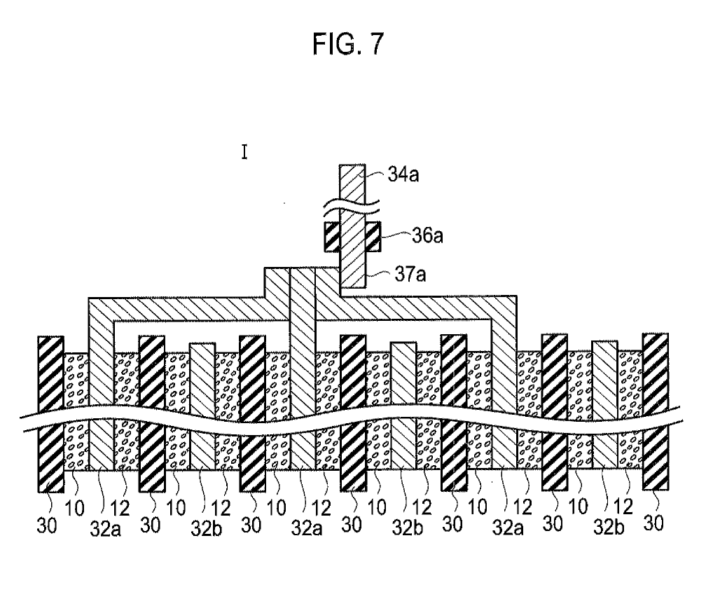

Moreover, FIG. 7 shows a configuration example in the case of three pairs of the positive and negative electrodes. Since the outermost active material electrodes 10 and 12 do not become a pair so as to sandwich the separator 30, the outermost active material electrodes 10 and 12 do not affect a capacitor. Moreover, although it is also possible to omit the outermost separator 30, the outermost separator 30 is needed when the separator itself is covered to be packs shape. Although illustrating is omitted in FIG. 7, electrode wirings are constructed respectively in common for the active material electrodes 10 and 12 and the extraction electrodes 32a and 32b, in the case of the three pairs of positive and negative electrodes. The extraction electrode 32 (32a and 32b) is bonded to the tab electrode 34 (34a and 34b) in the sealant 52 (52a and 52b), respectively. As shown in FIGS. 5-8, the separator 30 whose size is larger (whose area is wider) than those of the active material electrodes 10 and 12 is used so that whole of the active material electrode 10 and the 12 is covered. Furthermore, as shown in FIG. 8, not an electrode but the separator 30 is laminated respectively on a topmost part and a lowermost part of the layered structure. Although the separator 30 is not theoretically dependent on a kind of energy device, high thermal resistance is required when in particular corresponding to a reflow is needed. As the separator 30, polypropylene etc. can be used when high thermal resistance is not required, or cellulosic based materials can be used when high thermal resistance is required.

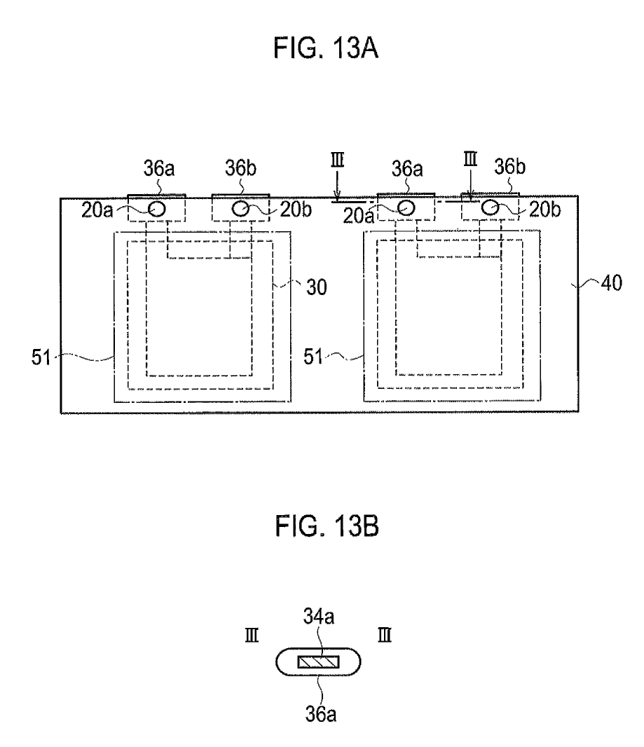

When productizing the laminated type energy storage device 18 as shown in FIG. 13, a portion of the tab electrode 34 (34a and 34b) exposed from the sealant 36 is cut to be removed. However, since it is necessary to perform electrical aging (initial electrical conduction), as shown in FIG. 11, the upper part of the tab electrode 34 (34a and 34b) is left in that condition until the electrical aging is completed (the electrical aging is performed so that the energy storage device 18 is immersed into an electrolytic bath 45 to be impregnated in the electrolysis solution 44, and an electrolyte is impregnated between the laminated active material electrodes 10 and 12). In addition, as shown in FIG. 13, the electrolysis solution 44 is made to infiltrate from the electrolysis solution injection port 48 formed when the laminate sheet 40 is compressed and sealed from the front surface and the back surface.

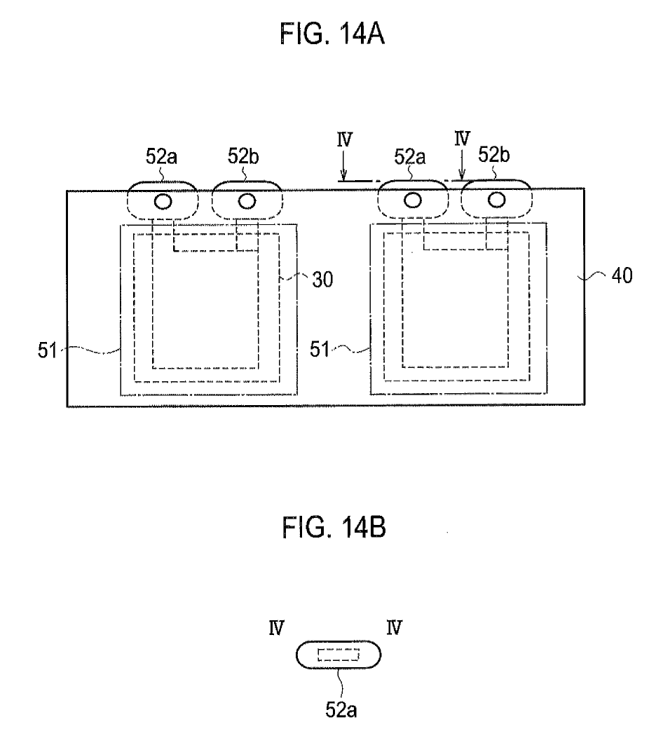

As shown in FIG. 14, the laminate sheet 40 of the energy storage device 18 is recompressed (re-sealed), and thereby the cut end face of the tab electrode 34 (34a and 34b) is insulated. The cut edge part of the tab electrode 34 (34a and 34b) is protected with the compressed and extended sealant 52 (52a and 52b) to be insulated (i.e., the cut end face of the tab electrode 34 (34a and 34b) is covered to be twine with the sealant 52 (52a and 52b) in which the heat compressed is performed and then the sealing member is melted and extended). Accordingly, it can be prevented from any troubles of short-circuiting due to the cut end face of the tab electrode 34 (34a and 34b) being exposed, or electrical conduction by contacting with other devices 122, 140, 160 and 170. Moreover, since the perimeter of the tab electrode extraction holes 20a and 20b and the holes 44a and 44b is also covered with the sealants 52a and 52b compressed and extended, the electrolysis solution 44 impregnated to the layered structure 80 is prevented from leaking, and troubles (e.g., a short circuit by contacting the tab electrodes 34a and 34b with the exposed end face of the aluminum material exposed from the edge of the holes 44a and 44b formed in the laminate sheet 40) can be prevented.

Moreover, a balanced terminal in series or in parallel can also be made electric contact from the tab electrode extraction holes 20a and 20b and the holes 44a and 44b.

### (Fabrication Method of Laminated Type Energy Device)

With reference to FIGS. 1 and 2-17, a fabrication method of the laminated type energy device 18 (e.g., an energy storage device) according to the first embodiment will be explained.

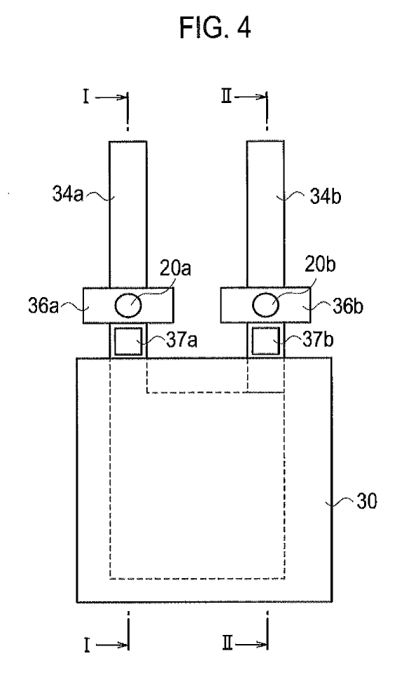

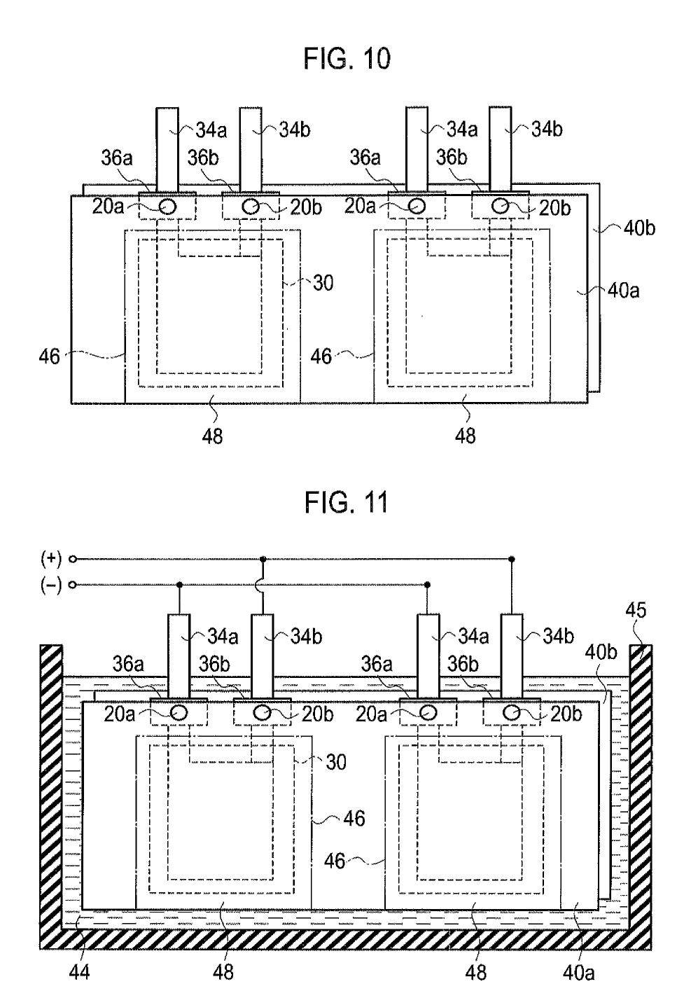

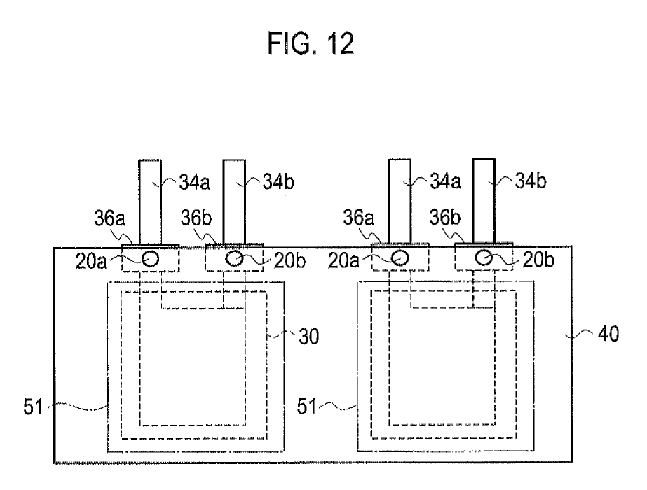

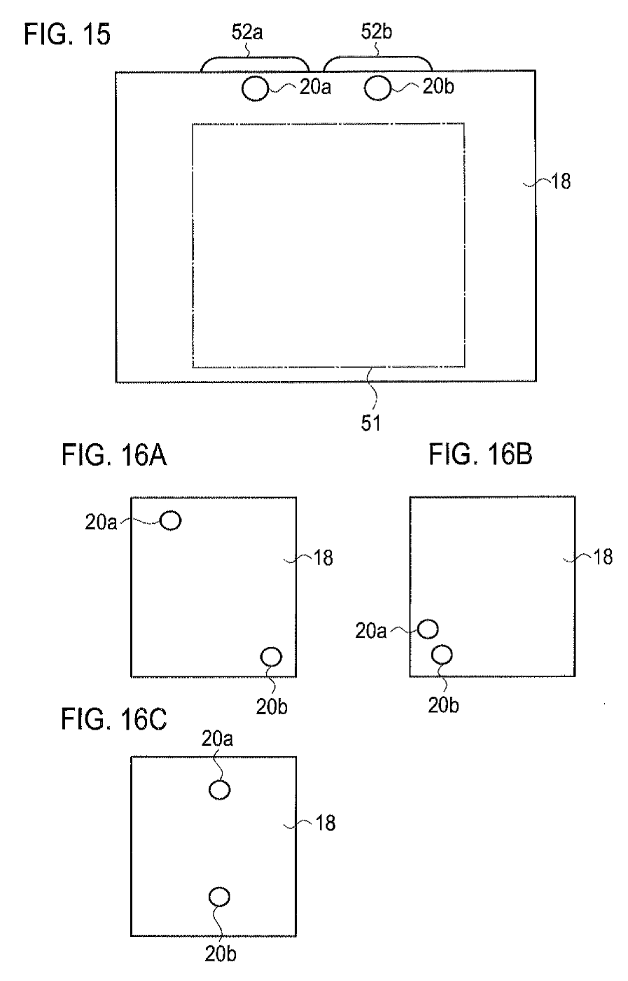

(a) As shown in FIGS. 2 and 5-7, the internal electrode structure 80 (e.g., storage element) which is the layered structure is composed. The internal electrode structure 80 is laminated with at least two (or more) layers of the active material electrodes 10 and 12 so that the positive electrode 10 and the negative electrode 12 become alternately. At this time, the extraction electrodes 32a and 32b are exposed from the internal electrode structure 80. Moreover, the layered structure is laminated to insert the separator 30 between the layers of each active material electrode 10 and 12, respectively. Moreover, in order to prevent from a short circuit, the separator 30 whose size is larger (whose area is wider) than those of the active material electrodes 10 and 12 is used so that whole of the active material electrode 10 and the 12 is covered, and the layered structure is laminated so that not an electrode but the separator 30 is laminated respectively on the topmost part and the lowermost part of layered structure.
(b) Next, the tab electrode 34 with the sealant 36 for bonding to the extraction electrode 32 (32a and 32b) exposed from the layered structure 80 is formed (processed). FIG. 3A shows the tab electrode 34 with the sealant 36 before the processing, and FIG. 3B shows the tab electrode 34 with the sealant 36 after the processing. The tab electrode 34 can be formed of Al, Ni, Cu, etc., for example. The sealant 36 can be formed of polypropylene resin etc., for example. The tab electrode extraction hole 20 (20a and 20b) is formed in both surfaces (both of back and front surfaces) of the sealant 36. The tab electrode extraction hole 20 is formed by shaving both surfaces of the sealant 36 until a raw material (e.g., Al) of the tab electrode 34 appears.
(c) Next, as shown in FIGS. 4-7, the edge parts of the upper side of the extraction electrodes 32a and 32b exposed from the layered structure 80 and the edge parts of the tab electrodes 34a and 34b are bonded in the welded parts 37a and 37b to make electrode formation. Ultrasonic welding etc., for example, are used for bonding of such electrode formation.
(d) On the other hand, as shown in FIG. 8, the two pieces of the laminate sheets 40 (the laminate sheet 40a for use in front surface and the laminate sheet 40b for use in the back surface) are prepared beforehand. The hole 44 (44a and 44b) are bored beforehand in the laminate sheets 40, aligning with the tab electrode extraction hole 20 (20a and 20b).
(e) Next, as shown in FIGS. 9-10, the laminate sheets 40a and 40b shown in FIG. 8 are overlaid from a front surface and a back surface of a layered structure 80 to compressively seal the layered structure 80 shown in FIG. 4. When the laminate sheets 40a and 40b are compressively sealed, the laminate sheets 40a and 40b are compressed along with a laminating line (compressing line) 46. Accordingly, the electrolysis solution injection port 48 is formed simultaneously. In addition, in the compressional sealing process, only predetermined length of the sealants 36a and 36b to be exposed from the sealed laminate sheets 40a and 40b, and the tab electrodes 34a and 34b are also exposed to the outside of the laminate sheets 40a and 40b.
(f) Next, as shown in FIG. 11, the laminated energy storage device 18 is immersed in the electrolytic bath 45 containing the electrolysis solution 44, the electrolysis solution 44 is impregnated in the layered structure 80 from the electrolysis solution injection port 48, and the electrolyte is impregnated between the laminated active material electrodes 10 and 12. At this time, electrical aging is also simultaneously performed from the tab electrodes 34a and 34b exposed to the outside of the laminate sheets 40a and 40b, and a degas process is performed.
(g) Next, as shown in FIG. 12, the laminate sheets 40a and 40b of the energy storage device 18 pulled up from the electrolytic bath 45 are compressed from the front and back surfaces along with a laminating line 51 so that the electrolysis solution injection port 48 is closed.
(h) Next, as shown in FIG. 13, the tab electrodes 34a and 34b exposed from the sealant 36 are cut to be removed.
(i) Next, as shown in FIG. 14, the laminate sheets 40a and 40b are recompressed from the front and back surfaces, and thereby the aluminum of the cut end face of the tab electrode 34 (34a and 34b) is insulated. At this time, the cut edge part of the tab electrode 34 (34a and 34b) is protected to be insulated with the sealant 52 (52a and 52b) compressed and extended (i.e., the cut end face of the tab electrode 34 (34a and 34b) is covered to be twine with the sealant 52 (52a and 52b) in which the heat compressed is performed and then the sealing member is melted and extended). FIG. 13B shows an aspect that the edge part plane of the cut tab electrode 34 (34a and 34b) is exposed, and FIG. 14B shows an aspect that the edge part plane of the cut tab electrode 34 (34a and 34b) is covered with the compressed and extended sealant 52 (52a and 52b).
(j) Next, as shown in FIG. 15, the energy storage device shown in FIG. 14 is detached respectively to be completed as each laminated type energy storage device 18.

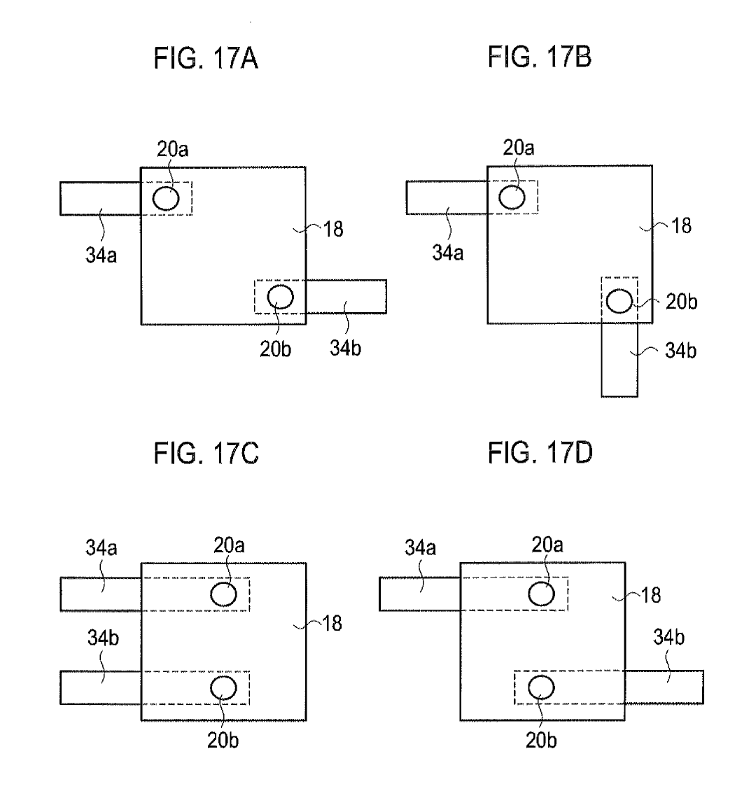

In addition, FIGS. 16A, 16B and 16C show various examples of positioning of the tab electrode extraction hole 20 (20a and 20b) formed in the laminated type energy storage device 18. FIG. 17 is a diagram showing various examples of the laminated type energy storage device 18 in which the tab electrode 34 (34a and 34b) is arranged, aligning with the tab electrode extraction hole 20 (20a and 20b) shown in FIG. 16. FIGS. 17A and 17B correspond to FIG. 16A. FIGS. 17C and 17D correspond to FIG. 16C.

As mentioned above, according to the laminated type energy device according to the first embodiment, and the fabrication method for the laminated type energy device, since the laminated type energy storage device 18 is provided with the contact holes (bonding hole) 20a and 20b for performing spot bonding of the laminated type energy storage device 18 to the module substrate 100, it contributes to mounting of the laminated type energy storage device 18 in a limited space. Moreover, since the spot bonding of the contact holes 20a and 20b is achieved at the time of module installation, a thermal load to an electrolysis solution impregnated into the layered structure 80 of the inside of the laminated type energy storage device 180 can be reduced, contribution of a coil component can also be reduced, and high frequency characteristics can be improved.

Moreover, according to the laminated type energy device according to the first embodiment, and the fabrication method for the laminated type energy device, since the contact holes 20a and 20b can function as the tab electrode extraction holes 20a and 20b for extracting the tab electrode 34 (34a and 34b), it is not necessary to be configured that the tab electrode 34 (34a and 34b) is extract to the external. Accordingly, in the case of modularization, it is not necessary to guide the tab electrode from the laminated type energy storage device, and therefore compact shaped device can be achieved to be easily incorporated in a module.

Moreover, according to the laminated type energy device according to the first embodiment, and the fabrication method for the laminated type energy device, although the tab electrodes 34a and 34b exposed from the sealant 36 are cut to be removed when the laminated type energy storage device 18 is productized, since the upper part of the tab electrodes 34a and 34b is left in that condition until the electrical aging (initial electrical conduction) is completed, the electrical aging can be performed.

According to the laminated type energy device according to the first embodiment, and the fabrication method for the laminated type energy device, as shown in FIG. 14, the laminate sheet 40 of the energy storage device 18 is compressed so that the cut end face of the tab electrode 34 (34a and 34b) is insulated. The cut edge part of the tab electrode 34 (34a and 34b) is covered with the compressed and extended sealant 52 (52a and 52b) to be insulated. Accordingly, it can be prevented from any troubles of short-circuiting due to the cut end face of the tab electrode (34a and 34b) being exposed, or electrical conduction by contacting with other devices 122, 140, 160 and 170. Moreover, since the perimeter of the tab electrode extraction holes 20a and 20b and the holes 44a and 44b is also covered with the compressed and extended sealants 52a and 52b, the electrolysis solution 44 impregnated to the layered structure 80 is prevented from leaking, and troubles (e.g., a short circuit by contacting the tab electrodes 34a and 34b with the exposed end face of the aluminum material exposed from the edge of the holes 44a and 44b formed in the laminate sheet 40) can be prevented.

### Second Embodiment

### (Fundamental Structure of Laminated Type Energy Device)

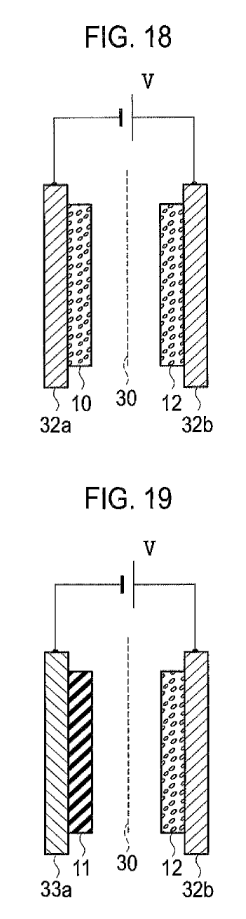

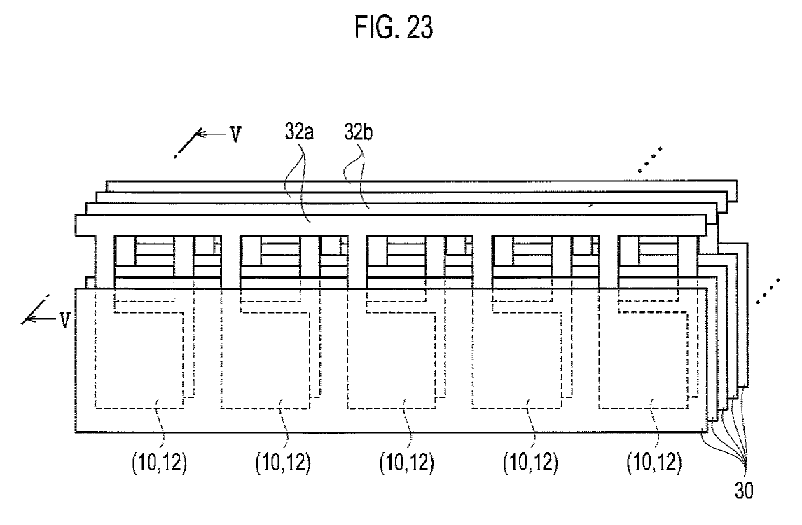

With reference to FIGS. 18-32, a fundamental structure of a laminated type energy device (e.g., an energy storage device) according to a second embodiment will be explained.

FIG. 18 shows a fundamental structure of an electric double layered capacitor internal electrode in the second embodiment. The electric double layered capacitor internal electrode according to the second embodiment is composed so that a separator 30 in which an electrolysis solution and ion pass therethrough is inserted between the active material electrodes 10 and 12 having at least one layer, and the extraction electrodes 32a and 32b are exposed from the active material electrodes 10 and 12. The extraction electrodes 32a and 32b are connected to power supply voltage. The extraction electrodes 32a and 32b are formed of aluminum foil, for example, and the active material electrodes 10 and 12 are formed of activated carbon, for example. The separator 30 whose size is larger (whose area is wider) than those of the active material electrodes 10 and 12 is used so that whole of the active material electrode 10 and the 12 is covered. Although the separator 30 is not theoretically dependent on a kind of energy device, high thermal resistance is required when in particular corresponding to a reflow is needed. As the separator 30, polypropylene etc. can be used when high thermal resistance is not required, or cellulosic based materials can be used when high thermal resistance is required. The electric double layered capacitor internal electrode is impregnated with the electrolysis solution 44, and the electrolysis solution 44 and ion are moved through the separator 30 at the time of charge and discharge.

FIG. 19 shows a fundamental structure of the lithium ion capacitor internal electrode in the second embodiment. The lithium ion capacitor internal electrode in the second embodiment is composed so that the separator 30 in which an electrolysis solution and ion pass therethrough is inserted between the active material electrodes 11 and 12 having at least one layer, and the extraction electrodes 33a and 32b are exposed from the active material electrodes 10 and 12. The extraction electrodes 33a and 32b are connected to power supply voltage. The active material electrode 12 of the positive electrode side is formed of activated carbon, for example, and the active material electrode 11 of the negative electrode side is formed of Li doped carbon, for example. The extraction electrode 32b of the positive electrode side is formed of aluminum foil, for example, and the extraction electrode 33a of the negative electrode side is formed of copper foil, for example. The separator 30 whose size is larger (whose area is wider) than those of the active material electrodes 11 and 12 is used so that whole of the active material electrode 11 and the 12 is covered. The lithium ion capacitor internal electrode is impregnated with the electrolysis solution 44, and the electrolysis solution 44 and ion are moved through the separator 30 at the time of charge and discharge.

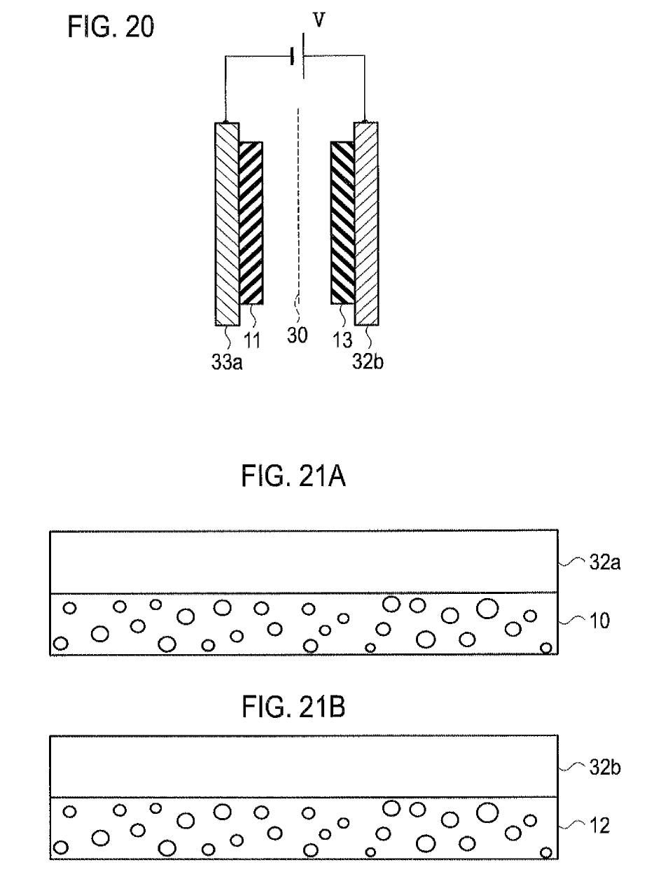

FIG. 20 shows a fundamental structure of the lithium ion battery internal electrode according to the second embodiment. The lithium ion battery internal electrode in the second embodiment is composed so that the separator 30 in which an electrolysis solution and ion pass therethrough is inserted between the active material electrodes 11 and 13 having at least one layer, and the extraction electrodes 33a and 32b are exposed from the active material electrodes 10 and 13. The extraction electrodes 33a and 32b are connected to power supply voltage. The active material electrode 13 of the positive electrode side is formed of LiCOO₂, for example, and the active material electrode 11 of the negative electrode side is formed of Li doped carbon, for example. The extraction electrode 32b of the positive electrode side is formed of aluminum foil, for example, and the extraction electrode 33a of the negative electrode side is formed of copper foil, for example. The separator 30 whose size is larger (whose area is wider) than those of the active material electrodes 11 and 13 is used so that whole of the active material electrode 11 and the 13 is covered. The lithium ion battery internal electrode is impregnated with the electrolysis solution 44, and the electrolysis solution 44 and ion are moved through the separator 30 at the time of charge and discharge.

The laminated type energy device according to the second embodiment includes: at least two (or more) layers of layered structure 80 in which the positive electrode and the negative electrode are alternately laminated so that the positive and negative extraction electrodes 32a and 32b may be exposed, inserting the separator 30 in which an electrolysis solution and ion pass therethrough between the positive and negative active material electrodes 10 and 12 connected with a series, and the separators 30 are respectively laminated on the topmost part and the lowermost part; and a bonded structure in which the separators 30 with respect to one another are punched collectively in the layered structure 80 including the active material electrodes 10 and 12 and the separator 30, and fiber structures of the edge faces of the separators 30 are entangled to be bonded mutually in the edge faces of the separators 30, wherein the separator 30 whose size is larger (whose area is wider) than those of the active material electrodes 10 and 12 is used so that whole of the active material electrode 10 and the 12 is covered.

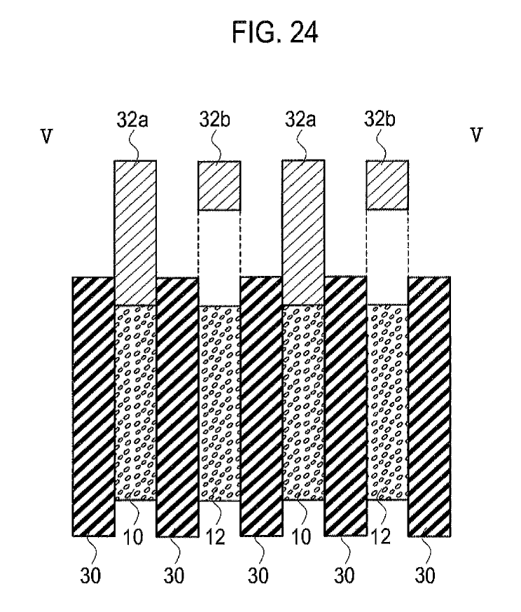

As shown in FIGS. 21-24, the internal electrode structure (e.g., storage element) 80 of the laminated type energy device (e.g., energy storage device) according to the second embodiment is a layered structure of multilayered structure in which the positive electrode and the negative electrode are alternately laminated so that the positive and negative extraction electrodes 32a and 32b may be exposed, while inserting the separator 30 in which an electrolysis solution and ion pass therethrough between at least two (or more) layers of the positive and negative active material electrodes 10 and 12, and the layered structure 80 including a series of the active material electrode structures and the separator 30 is composed respectively. As shown in FIG. 24, the separator 30 whose size is larger (whose area is wider) than those of the active material electrodes 10 and 12 is used so that whole of the active material electrode 10 and the 12 is covered, and not an electrode but the separator 30 is laminated respectively on the topmost part and the lowermost part of layered structure. Raw materials including fiber substance (e.g., cellulose or glass fiber) are used for the separator 30.

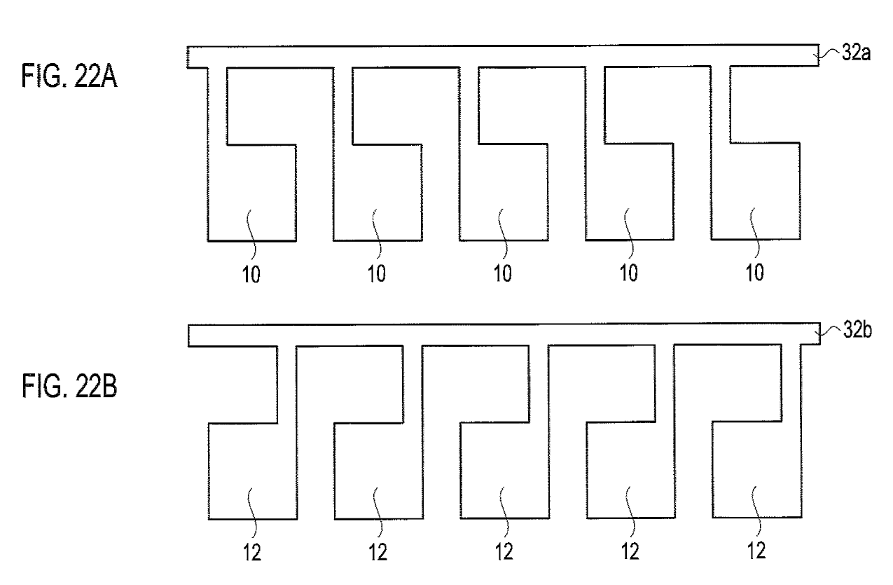

A series of active material electrodes 10 and 12 and the extraction electrodes 32a and 32b are formed respectively of one couple of the two electrode sheets composed of aluminum foil, for example. FIG. 21A shows the electrode sheet of the positive electrode side, and FIG. 21B shows the electrode sheet of the negative electrode side. A portion on which active materials (e.g., activated carbon) are coated on the respective electrode sheet is used as the active material electrodes 10 and 12 (the active material electrode 12 of the positive electrode side, the active material electrode 12 of the negative electrode side), and a portion (uncoated portion) on which the active materials are not coated is used as the extraction electrodes 32a and 32b (the extraction electrode 32b of the positive electrode side, the extraction electrode 32a of the negative electrode side). Thus, as shown in FIG. 22, the sheet electrode sheet on which the active materials are distinguished by different coats is punched by arbitrary electrode structures to be used as an aluminum electrode. In addition, a paste in which not only activated carbon but a binder (poly-tetrafluoroethylene (PTFE) or poly-vinylidene fluoride resin (PUDF)) and an auxiliary conducting agent (acetylene black or ketjen black) are mixed is coated on the electrode sheet.

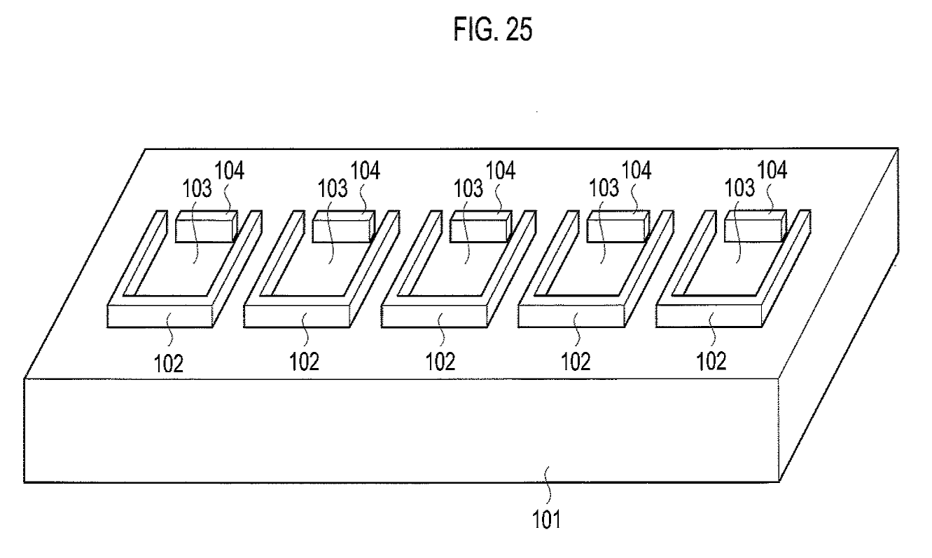

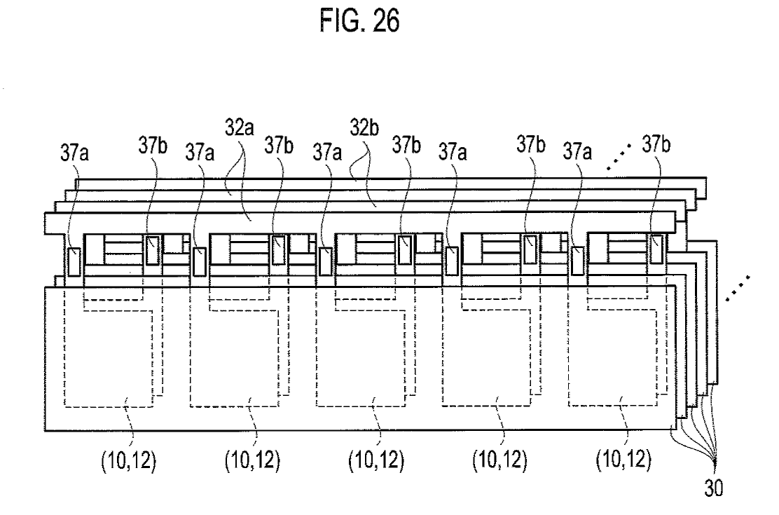

The layered structure (each cell) 80 including the active material electrode structure of the active material electrodes 10 and 12, and the separator 30 has a structure in which the edge faces of the separators 30 are bonded at the edge face of the separators 30 when punching the separators 30 with respect to one another collectively. That is, in the layered structure (each cell) 80 including the active material electrode structure of the active material electrodes 10 and 12 and the separator 30 which are connected with a series, if the separators 30 with respect to one another are collectively punched with the punching edges 102 and 104 shown in FIG. 25, the fiber structures of the edge faces of the separators 30 are entangled mutually, and thereby the separators 30 are bonded with respect to one another, as shown in FIGS. 26-28. Accordingly, it is not necessary to fasten the layered structure 80 with a tape, or to bind the exposed separators 30 with a cord etc., in order to prevent from the formed layered structure 80 being collapsed. Accordingly, when the layered structure 80 is sealed with the laminate sheet (aluminum) 40 since marks of the tape or the cord are not appear on the reinforced portion, and unevenness of adhesibility, inferiority of appearance, etc. is not occurred, a complicated process for providing a reinforcing means can also be skipped. Since only the edge faces of the separators 30 are bonded, the active material electrodes 10 and 12 are not pressed out. Accordingly the separator can be minimized as much as possible to the size of the active material electrodes 10 and 12. Accordingly, the laminate sheet 40 becomes small in proportionately, its package can also be miniaturized and is easy also for incorporating in a set.

As shown in FIGS. 22-25 and FIGS. 26-28, the active material electrode structure of the active material electrodes 10 and 12 has a structure where a plurality of the electrode structures is sequenced in a row with the common electrode members (extraction electrodes 32a and 32b) (e.g., five electrode structures are sequenced in a row, in the illustrated example), and the active material electrode structure of a series of the active material electrodes 10 and 12 is laminated alternately with one sheet of the corresponding separator 30. More specifically, as shown in FIG. 24, predetermined number of the sheets are laminated (e.g., the separator 30, the positive active material electrode 12, the separator 30, the negative active material electrode 10, the separator 30, the positive active material electrode 12, the separator 30, the negative active material electrode 10, the separator 30, . . . ) while aligning every sheet. Furthermore, as shown in FIG. 24, not an electrode but the separator 30 is laminated respectively on a topmost part and a lowermost part of the layered structure 80.

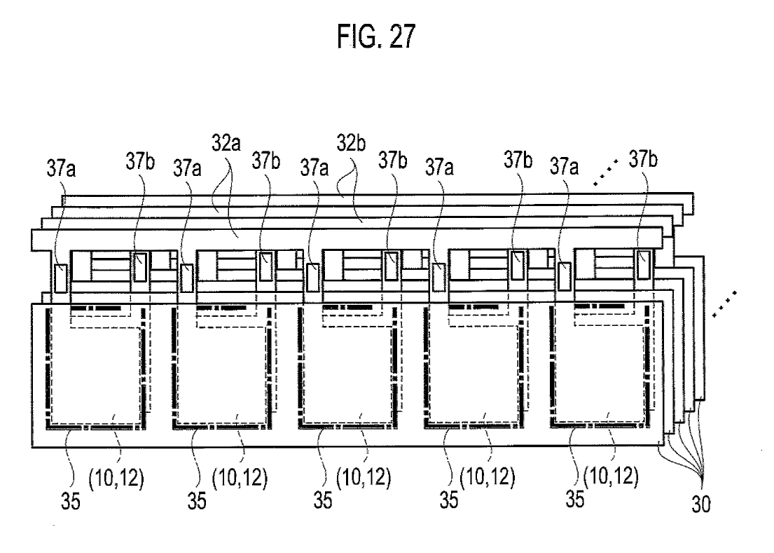

Moreover, as shown in FIG. 25, the layered structure 80 including the active material electrode structure of the active material electrodes 10 and 12, and the separator 30, the punching die used when the separators 30 are punched with respect to one another collectively includes: punching edges 102 and 104; and a cushion (e.g., sponge disposing part) 103 formed inside the punching edges 102 and 104, on a base 101 of the punching die. As shown in FIG. 27, in the layered structure 80 including the active material electrode structure of the active material electrodes 10 and 12, and the separator 30, the punching edges 102 and 104 are arranged so as to be aligned with the punching part 35 which is a portion for punching the separators 30 with respect to one another.

In addition, the so-called “escaping” portion is formed in the punching edges 102 and 104 arranged corresponding to the punching part 35 so that the positive and negative extraction electrodes 32a and 32b exposed from the separator 30 are not punched (are out of the punching range). That is, the punching edges 102 and 104 are formed and arranged on the base 101 of the punching die so that the separator 30 corresponding to a portion of the extraction electrode 32 (32a and 32b) is not punched. The cushion (sponge disposing part) 103 protects the layered structure 80 including the active material electrode structure of the active material electrodes 10 and 12, and the separator 30 when the punching process is performed.

In addition, as shown in FIG. 26, when the layered structure 80 including a series of the active material electrode structures and the separator 30 is laminated, the laminated extraction electrodes 32a of the positive electrodes are welded mutually in the welded part 37a and the laminated extraction electrodes 32b of the negative electrodes are welded mutually in the welded part 37b before the punching process, and thereby each extraction electrode 32a and 32b is not separated or shifted. Accordingly, since each electrode of each extraction electrode 32a and 32b is aligned to a lengthwise direction before the punching process, the edge faces of the separator 30 can be punched and bonded collectively, without the punching edges 102 and 104 being contacted with the extraction electrodes 32a and 32b at the time of the punching process. In addition, when each extraction electrode 32a and 32b is welded respectively in each welded part 37a and 37b, resistance welding, ultrasonic welding, etc. are used, for example.

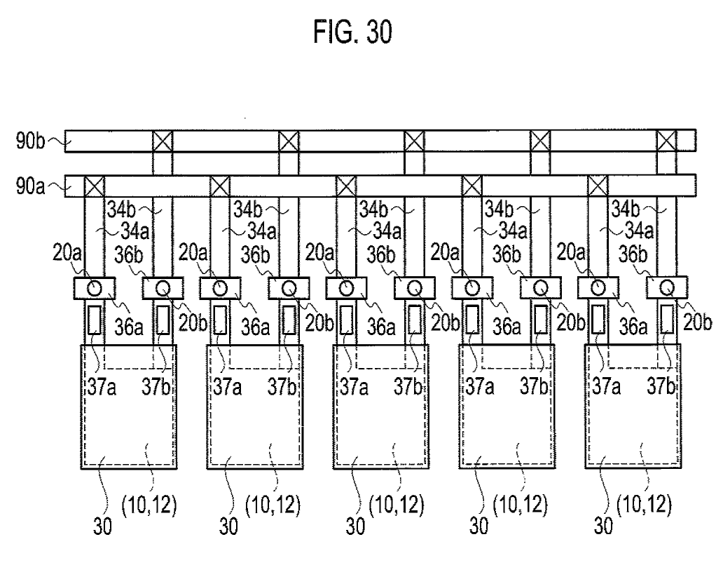

FIG. 30 shows an aspect that the aluminum tab electrodes 34a and 34b for use in external extraction are welded to the extraction electrodes 32a and 32b after the punching process of the separator 30, and thereby making a common electrode part as a tab electrode. At this time, the common electrode member (e.g., extraction electrodes 32a and 32b) is arranged above the tab electrodes 34a and 34b. After the positive and negative aluminum electrodes 90a and 90b having common tab are welded to the tab electrodes 34a and 34b, the common electrode member (e.g., extraction electrodes 32a and 32b) is cut off to be removed. Thermal welding between the extraction electrodes 32a and 32b and the aluminum tab electrodes 34a and 34b is performed respectively in the holes 20a and 20b of the sealants 36a and 36b. The sealants 36a and 36b are formed of resin materials (e.g., polypropylene), for example.

As shown in FIG. 31, a portion (space) in which the separator 30 is punched to be removed after the punching process of separator 30 with respect to one another in the layered structure (each cell) 80 including a series of the active material electrode structures and the separator 30 corresponds to a portion laminated from the back and front surface with two sheets of the laminate sheets 40. At this time, since the layered structure 80 including a series of the active material electrode structures and the separator 30 is laminated with the laminate sheet 40 held in a row, mass production volume efficiency can be increased. Moreover, as shown in FIG. 34, since the aluminum electrode 50 can be mass-produced in the laminated electrode structure 80 mounted on the resin mold base 82p by using a roll press (e.g., roll-to-roll technology) using a roll 110 on which a punching edge 106 is formed on the surface thereof, the mass production volume efficiency can also be increased.

When laminated with the laminate sheet 40, a portion of the laminate sheet 40 corresponding to the lower part of each layered structure (each cell) 80 is used as an electrolysis solution injection port 48, without being laminated. The electrolysis solution injection port 48 is laminated and sealed, after immersing the energy storage device 18 into the electrolytic bath 45 to be impregnated in the electrolysis solution 44, impregnating the electrolyte between the laminated active material electrodes 10 and 12 to perform the electrical aging, and pulling up the energy storage device 18 from the electrolytic bath 45. In this manner, since the electrolysis solution 44 can be simultaneously impregnated to each layered structure (each cell) 80 when laminated by forming the electrolysis solution injection port 48, the mass production volume efficiency can be increased. In addition, when injecting the electrolysis solution 44, since a series of the active material electrode structures are welded respectively to the aluminum electrodes 90a and 90b having common tab, the electrical aging can be subjected to a plurality of the layered structure (cell) 80 with one piece of the electrical conducting terminal, when being immersed in the electrolytic bath 45.

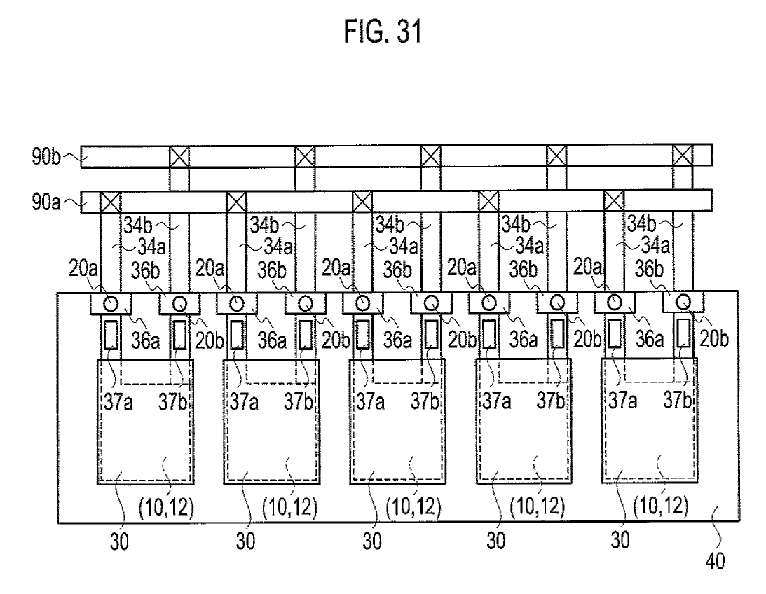

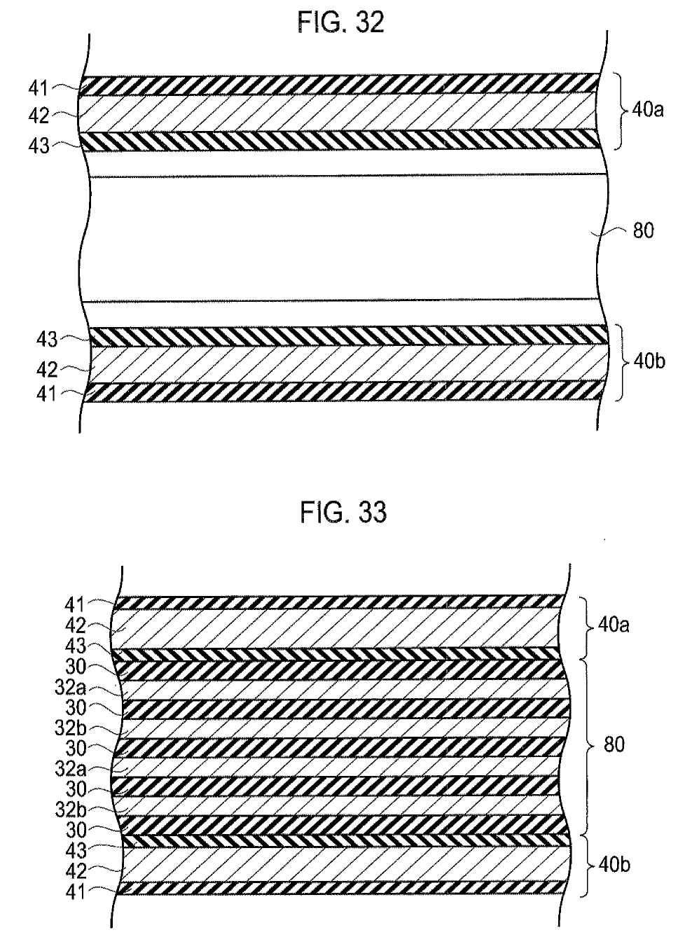

As for the laminate sheet 40, as shown in FIGS. 32 and 33, the surface 43 (i.e., thermal sealed surface) which becomes the inside at the time of being laminated is formed of polypropylene etc., for example, the surface 41 which becomes the outside at the time of being laminated is formed of raw materials (e.g., PET), and the aluminum foil 42 is sandwiched into the internal surface 43 and the external surface 41 to be formed as the laminate sheet 40 (40a and 40b). Although the layered structure 80 shown in FIG. 33 is a double layer structure, the number of the layers is not limited to the above number, but arbitrary numbers of layers can be adopted.

### (Fabrication Method of Laminated Type Energy Device)

With reference to FIGS. 21-32, a fabrication method of the laminated type energy device 18 (e.g., an energy storage device) according to the second embodiment will be explained.

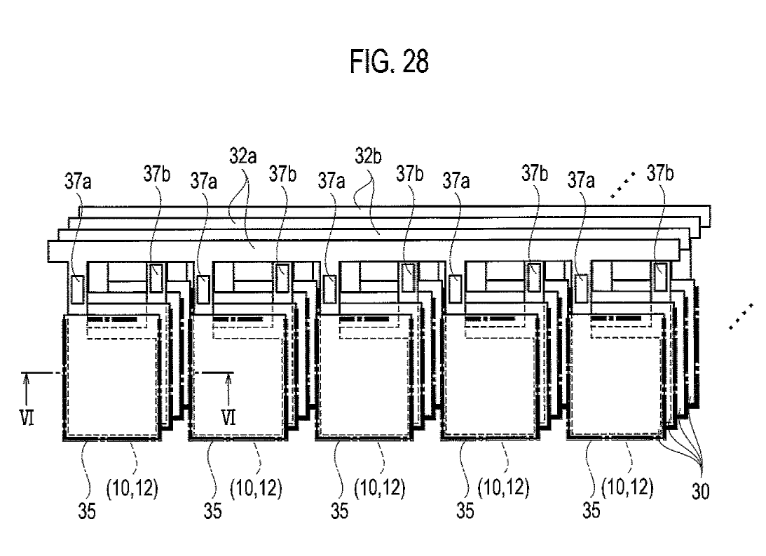

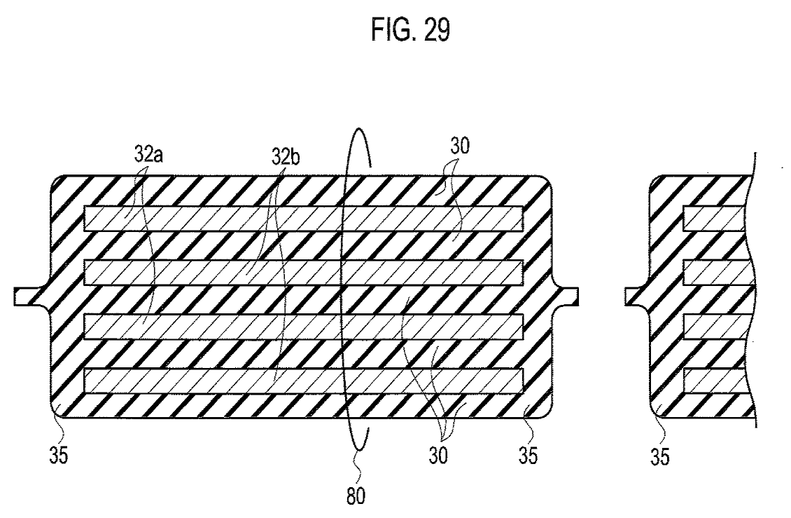

(a) As shown in FIG. 21, one couple of the two electrode sheets composed of aluminum foil is prepared, and the active material is distinguished by different coats on the upper surface of each electrode sheet. FIG. 21A shows the electrode sheet of the positive electrode side, and FIG. 21B shows the electrode sheet of the negative electrode side. A portion on which active materials (e.g., activated carbon) are coated on the respective electrode sheet is used as the active material electrodes 10 and 12 (the active material electrode 12 of the positive electrode side, the active material electrode 12 of the negative electrode side), and a portion (uncoated portion) on which the active materials are not coated is used as the extraction electrodes 32a and 32b (the extraction electrode 32b of the positive electrode side, the extraction electrode 32a of the negative electrode side).
(b) Next, each electrode sheet on which the active materials are coated is punched into arbitrary electrode structures to form aluminum electrode, as shown in FIG. 22. The active material electrode structure of the active material electrodes 10 and 12 has a structure where a plurality of the electrode structures is sequenced in a row with the common electrode members (i.e., extraction electrodes 32a and 32b) (e.g., five electrode structures are sequenced in a row, in the illustrated example). When actually mass-producing, each electrode sheet is lengthily rolled round to rolled form.
(c) Next, as shown in FIGS. 21-24, the layered structure 80 including a series of the active material electrode structures and the separator 30 is composed respectively, as a layered structure of multilayered structure in which the positive electrode and the negative electrode are alternately laminated so that the positive and negative extraction electrodes 32a and 32b may be exposed, while inserting the separator 30 in which an electrolysis solution and ion pass therethrough between at least two (or more) layers of the positive and negative active material electrodes 10 and 12. More specifically, as shown in FIG. 24, predetermined number of the sheets are laminated (e.g., the separator 30, the positive active material electrode 12, the separator 30, the negative active material electrode 10, the separator 30, the positive active material electrode 12, the separator 30, the negative active material electrode 10, the separator 30, . . . ) while aligning every sheet. Furthermore, not an electrode but the separator 30 is laminated respectively on the topmost part and the lowermost part of the layered structure
(c) On the other hand, as shown in FIG. 25, the punching die is prepared, used when punching the separators 30 with respect to one another collectively in the layered structure 80 including the active material electrode structure of the active material electrodes 10 and 12, and the separator 30.
(d) Next, as shown in FIG. 26, each laminated extraction electrode 32a of the positive electrode is welded in the welded part 37a, and each laminated extraction electrode 32b of the negative electrode is welded in the welded part 37b, before the punching process is performed. When each extraction electrode 32a and 32b is welded respectively in each welded part 37a and 37b, resistance welding, ultrasonic welding, etc. are used, for example.
(e) Next, as shown in FIGS. 27-28, in the layered structure 80 including the active material electrode structure of the active material electrodes 10 and 12 and the separator 30 which are connected in a series, if the separators 30 are punched with respect to one another collectively along with the punching part 35 by using the punching edges 102 and 104 shown in FIG. 25, the fiber structures of the edge faces of the separators 30 are entangled mutually, and thereby the separators 30 are bonded with respect to one another. As shown in FIG. 29, as for the punching part 35 of each layered structure 80 in which the separators 30 with respect to one another are punched, fibers of the separators 30 with respect to one another are intertwined, and thereby a portion which is squashed and cut becomes packs shape. Accordingly, it is not necessary to fasten the layered structure 80 with a tape, or to bind the exposed separators 30 with a cord etc., in order to prevent from the formed layered structure 80 being collapsed. Although the size of the separator 30 of the outermost layer is larger than that of the separator 30 near the center, the difference of the size is finely adjusted corresponding to the shape at the time of cutting.
(f) Next, as shown in FIG. 30, the aluminum tab electrodes 34a and 34b for use in external extraction are welded to the extraction electrodes 32a and 32b after the punching process of the separator 30, and thereby making a common electrode part as a tab electrode. At this time, the common electrode member (e.g., extraction electrodes 32a and 32b) is arranged above the tab electrodes 34a and 34b. After the positive and negative aluminum electrodes 90a and 90b having common tab are welded to the tab electrodes 34a and 34b, the common electrode member (e.g., extraction electrodes 32a and 32b) is cutoff to be removed. Thermal welding between the extraction electrodes 32a and 32b and the aluminum tab electrodes 34a and 34b is performed respectively in the holes 20a and 20b of the sealants 36a and 36b.
(g) Next, as shown in FIG. 31, the layered structure 80 including the active material electrode structure of the active material electrodes 10 and 12 and the separator 30 which are connected in series is laminated from the back and front with two sheets of the laminate sheets 40. In this case, a portion of the laminate sheet 40 corresponding to the lower part of each layered structure (each cell) 80 is used as the electrolysis solution injection port 48, without being laminated.
(g) Next, the layered structure 80 including the active material electrode structure of the active material electrodes 10 and 12 and the separator 30 which are laminated and connected in series is immersed into the electrolytic bath 45 to be impregnated in the electrolysis solution 44, and the electrolyte is impregnated between the active material electrodes 10 and 12 from the electrolysis solution injection port 48. Moreover, the electrical aging is performed simultaneously from the positive and negative aluminum electrodes 90a and 90b having common tab, and the degas process is performed. Although the electrical aging is performed by connecting respectively the electrical conducting terminal to the exposed aluminum tab electrodes 34a and 34b in every layered structure 80, in the first embodiment (refer to FIG. 11), since a series of the active material electrode structures are welded respectively to the aluminum electrodes 90a and 90b having common tab, in the second embodiment, the electrical aging can be subjected simultaneously to a plurality of the layered structures (cells) 80 with one piece of the electrical conducting terminal, when being immersed in the electrolytic bath 45.
(h) Next, after pulling up the layered structure 80 connected in series from the electrolytic bath 45, a portion of the electrolysis solution injection port 48 of each layered structure 80 is laminated and sealed.
(g) Next, the layered structure 80 including the active material electrode structure of the active material electrodes 10 and 12 and the separator 30 which are laminated and connected in series is separated respectively, the positive and negative aluminum electrodes 90a and 90b having common tab are also cut off to be removed, and thereby each energy storage device 18 is completed.

As mentioned above, according to the laminated type energy device according to the second embodiment, and the fabrication method for the laminated type energy device, if the separators 30 are punched with respect to one another collectively, the fiber structures of the edge faces of the separators 30 are entangled mutually, and thereby the separators 30 are bonded with respect to one another. Accordingly, it is not necessary to fasten the layered structure 80 with a tape, or to bind the exposed separators 30 with a cord etc., in order to prevent from the formed layered structure 80 being collapsed. Accordingly, when the layered structure 80 is sealed with the laminate sheet 40 since marks of the tape or the cord are not appear on the reinforced portion, and unevenness of adhesibility, inferiority of appearance, etc. is not occurred, a complicated process for providing a reinforcing means can also be skipped. Moreover, since only the edge faces of the separators 30 are bonded, the active material electrodes 10 and 12 are not pressed out. Accordingly the separator can be minimized as much as possible to the size of the active material electrodes 10 and 12. Accordingly, the laminate sheet 40 becomes small in proportionately, its package can also be miniaturized and is easy also for incorporating in a set.

Moreover, according to the laminated type energy device according to the second embodiment, and the fabrication method for the laminated type energy device, the so-called “escaping” portion is formed in the punching edges 102 and 104 arranged corresponding to the punching part 35 so that the positive and negative extraction electrodes 32a and 32b exposed from the separator 30 are not punched. Accordingly, it prevents from that the separator 30 of the extraction electrode 32a and 32b portion is punched. Furthermore, the cushion (sponge disposing part) 103 protects the layered structure 80 including the active material electrode structure of the active material electrodes 10 and 12, and the separator 30 when the punching process is performed.

Moreover, according to the laminated type energy device according to the second embodiment, and the fabrication method for the laminated type energy device, the active material electrode structure of the active material electrodes 10 and 12 has a structure where a plurality of the electrode structures are sequenced in a row with the common electrode members (extraction electrodes 32a and 32b) (e.g., five electrode structures are sequenced in a row, in the illustrated example), and the active material electrode structure of a series of the active material electrodes 10 and 12 is laminated alternately with one sheet of the corresponding separator 30. Moreover, each laminated extraction electrode 32a of the positive electrodes is welded mutually in the welded part 37a and each laminated extraction electrode 32b of the negative electrodes is welded mutually in the welded part 37b before the punching process, and thereby each extraction electrode 32a and 32b is not separated or shifted. Accordingly, since each electrode of each extraction electrode 32a and 32b is aligned to a lengthwise direction before the punching process, the edge faces of the separator 30 can be punched and bonded collectively, without the punching edges 102 and 104 being contacted with the extraction electrodes 32a and 32b at the time of the punching process.

Moreover, according to the laminated type energy device according to the second embodiment, and the fabrication method for the laminated type energy device, a portion (space) which the separator 30 is punched to be removed after the punching process of separator 30 with respect to one another in the layered structure 80 including a series of the active material electrode structures and the separator 30 corresponds to a portion laminated from the back and front surface with two sheets of the laminate sheets 40. At this time, since the layered structure 80 including a series of the active material electrode structures and the separator 30 is laminated with the laminate sheet 40 held in a row, the mass production volume efficiency can be increased. Moreover, as shown in FIG. 34, since the aluminum electrode 50 can be mass-produced in the laminated electrode structure 80 mounted on the resin mold base 82p by using a roll press (e.g., roll-to-roll technology) using a roll 110 on which a punching edge 106 is formed on the surface thereof, the mass production volume efficiency can also be increased.

Moreover, according to the laminated type energy device according to the second embodiment, and the fabrication method for the laminated type energy device, when laminated with the laminate sheet 40, a portion of the laminate sheet 40 corresponding to the lower part of each layered structure 80 is used as an electrolysis solution injection port 48, without being laminated. In this manner, since the electrolysis solution 44 can be simultaneously impregnated to each layered structure (each cell) 80 when laminated by forming the electrolysis solution injection port 48, the mass production volume efficiency can be increased. Moreover, when injecting the electrolysis solution 44, since a series of the active material electrode structures are welded respectively to the aluminum electrodes 90a and 90b having common tab, the electrical aging can be subjected to a plurality of the layered structures (cells) 80 with one piece of the electrical conducting terminal, when being immersed in the electrolytic bath 45.

As mentioned above, according to the laminated type energy device according to the first to second embodiments, and the fabrication method for the laminated type energy device, it can provide the laminated type energy device which can enhance the sealing ability and the adhesibility between the layered structure and the sealing body which houses the layered structure, and the degree of space-saving, and uses the sealing means with sufficient productivity and reliability.

Moreover, according to the laminated type energy device according to the first to second embodiments, and the fabrication method for the laminated type energy device, it can provide the laminated type energy device which is compact shaped, can enhance the high frequency characteristics, and uses the sealing means with sufficient productivity and reliability.

### Third Embodiment

### (Fundamental Structure of Chip Type Energy Device)

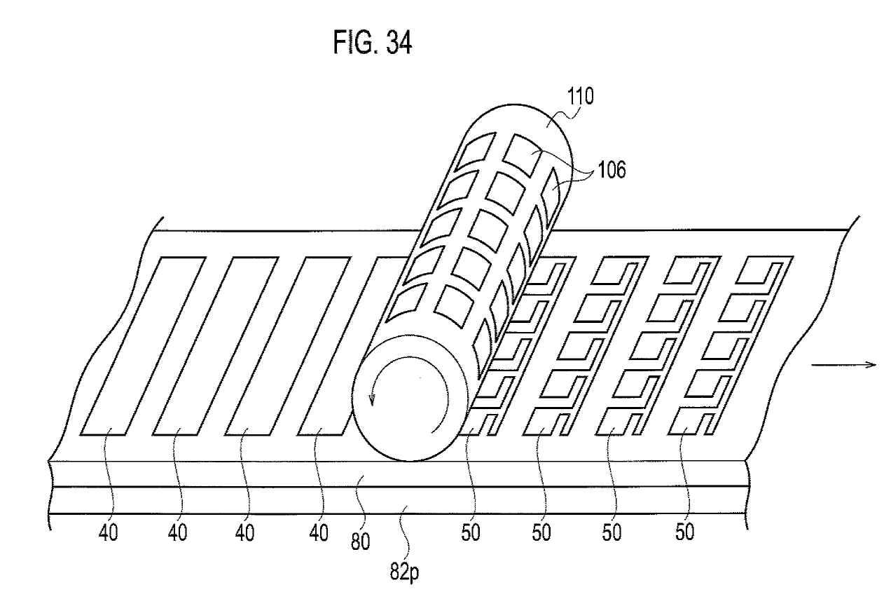

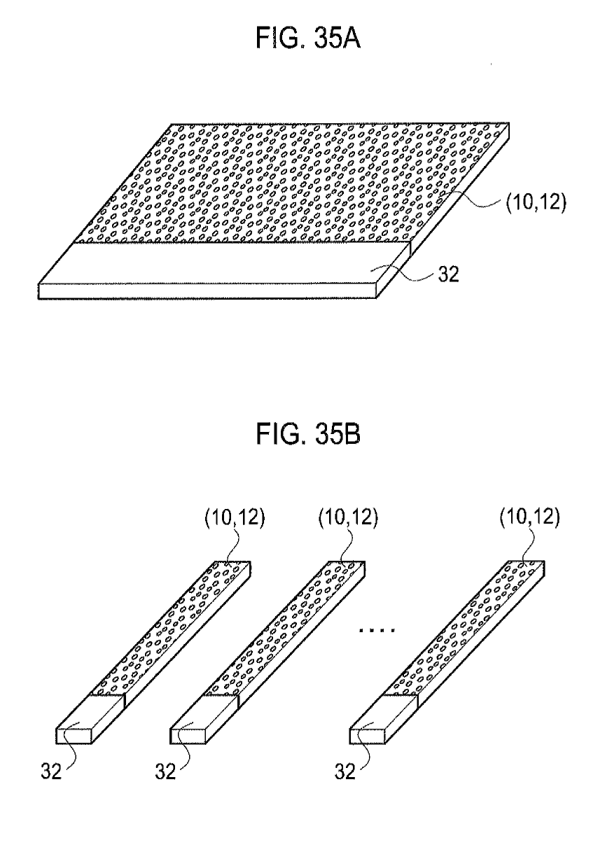

As shown in FIGS. 35-45, a chip type energy device according to a third embodiment includes: at least two (or more) layers of layered structure 80 in which a positive electrode and a negative electrode are alternately laminated so that the extraction electrodes 32a and 32b portions are exposed, inserting a separator 30 between active material electrode portions 10 and 12 of electrodes into which positive and negative active material electrodes 10 and 12 and positive and negative extraction electrodes 32a and 32b are integrated; a frame member 60 for housing the layered structure 80, wherein through-holes 63 and 64 for extracting terminal electrodes connected to the extraction electrodes 32a and 32b to the outside thereof are formed in the frame member; a sealing cover 70 for sealing an upper surface of the frame member 60; and a sealant 72 for sealing a bottom surface of the frame member 60 and the through-holes 63 and 64 to impregnate a layered portion of the layered structure 80 with an electrolyte.

The chip type energy device according to the third embodiment is configured to house the internal electrode structure 80 in the frame member (e.g., made from ceramics) 60 in which the through-holes 63 and 64 for passing the terminal electrodes 50 and 52 therethrough and a housing recess for housing the internal electrode structure 80 thereon are disposed.

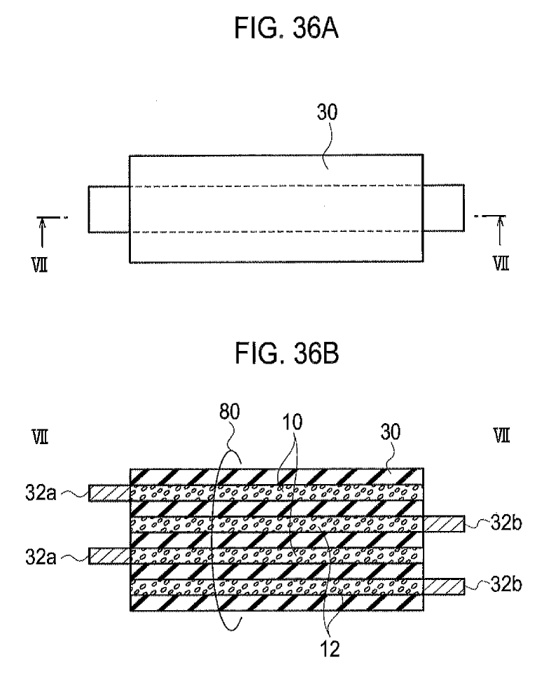

As shown in FIG. 36, the internal electrode structure (e.g., storage element) 80 is composed of a layered structure in which the positive electrode and the negative electrode are alternately laminated so that the positive and negative extraction electrodes 32a and 32b are exposed, while inserting the separator 30 in which an electrolysis solution and ion pass therethrough between at least two (or more) layers of the positive and negative active material electrodes 10. As shown in FIG. 35A, as for the active material electrodes 10 and 12 and the extraction electrodes, a portion on which an active material composed of activated carbon, for example, is coated among the upper surface of the electrode plate (e.g., aluminum foil) is used as the active material electrodes 10 and 12 (i.e., the positive active material electrode 12 and the negative active material electrode 12), and a portion which an active material (activated carbon) is not coated among the upper surface of the electrode plate is used as the extraction electrode 32 (the positive extraction electrode 32b and the negative extraction electrode 32a) Moreover, as shown in FIG. 35B, the aluminum foil is cut in rectangles. Each electrode plate which is cut in rectangles is used respectively as the electrode including the active material electrodes 10 and 12 and the extraction electrode 32. Since a high power aluminum electrode sheet is used as a material of the electrode plate, high power can be obtained also in a chip type energy device.

The separator 30 whose size is larger (whose area is wider) than those of the active material electrodes 10 and 12 is used so that whole of the active material electrode 10 and the 12 is covered as shown in FIG. 36A. Furthermore, as shown in FIG. 36B, not an electrode but the separator 30 is laminated respectively on a topmost part and a lowermost part of the layered structure 80. Although the separator 30 is not theoretically dependent on a kind of energy device, high thermal resistance is required when in particular corresponding to a reflow is needed. As the separator 30, polypropylene etc. can be used when high thermal resistance is not required, or cellulosic based materials can be used when high thermal resistance is required.

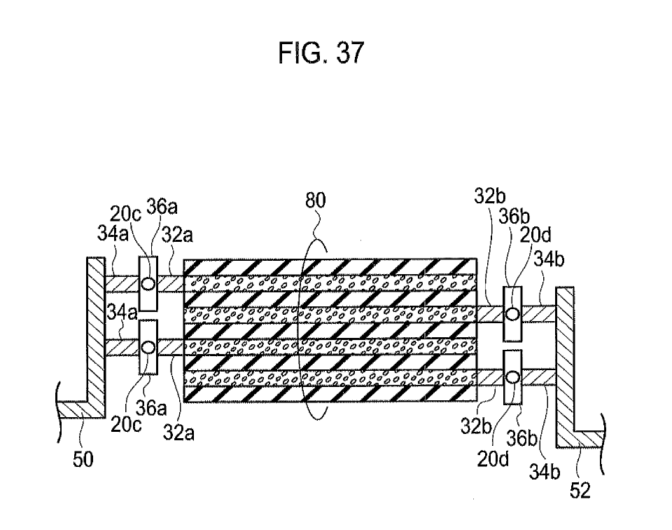

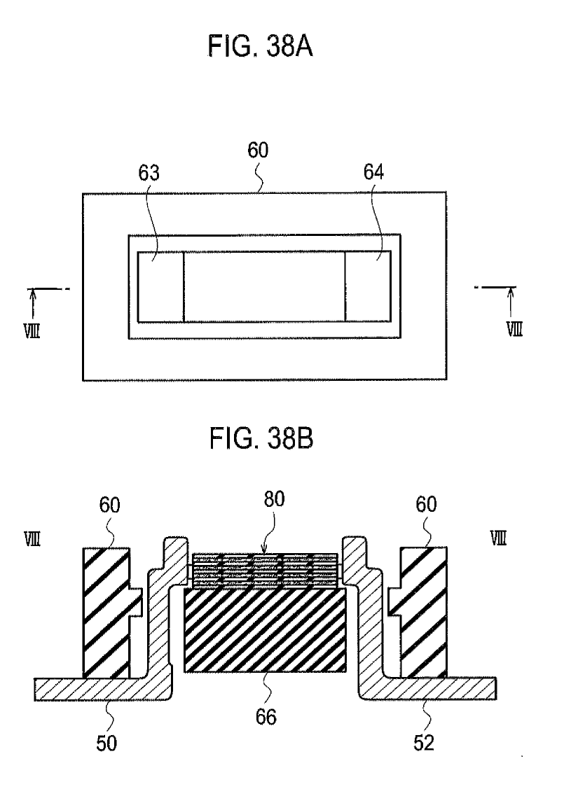

The extraction electrodes 32a and 32b exposed from the layered structure are directly welded to tab electrodes 34a and 34b, as shown in FIG. 37. Furthermore, as shown in FIG. 38, since the terminal electrodes 50 and 52 extended from the tab electrodes 34a and 34b can be extracted to the outside of the frame member 60 through the through-holes 63 and 64, the terminal electrodes 50 and 52 can be connected directly to the internal electrode structure 80. Accordingly, internal electrical resistance of the electrode structure 80 in the chip can be easily reduced. Although it is necessary to form an injected hole for impregnating the frame member 60 with the electrolysis solution 44, the injected hole for impregnating with the electrolysis solution 44 can be made to serve a double purpose with the through-holes 63 and 64 for passing the terminal electrodes 50 and 52 therethrough. A gap which is minimum required to pass the electrolysis solution 44 is formed respectively between each the through-hole 63 and 64 and each extracted terminal electrode 50 and 52. Moreover, the frame member 60 includes the housing recess for housing the internal electrode structure 80 thereon.

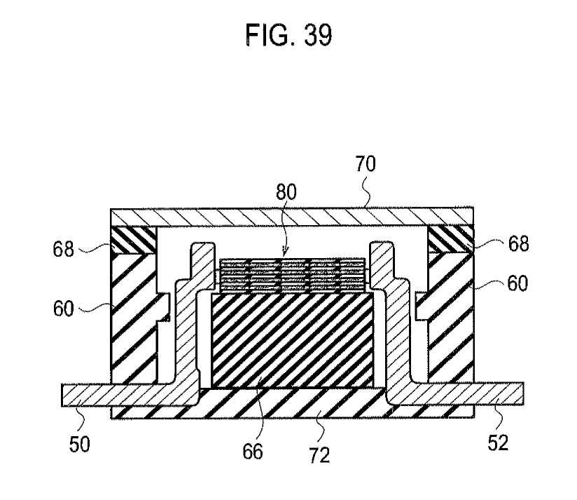

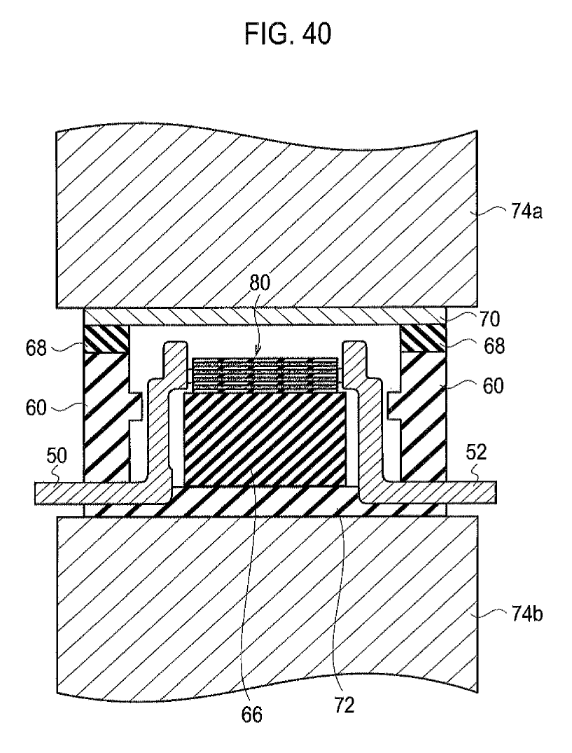

As shown in FIG. 39, the metal sealing cover 70 is bonded by the adhesive agent (e.g., chemical-resistant ceramics) 68 to be disposed on the upper surface of the frame member 60. Then, as shown in FIGS. 40-43, in order to improve the adhesion of the internal electrode structure 80, the metal sealing cover 70 disposed on the upper surface of the frame member 60 is pressed mechanically with the press machines 70a and 70b and let to dry, and thereby the metal sealing cover 70 is concaved to inside thereof in a concave shape. The metal sealing cover 70a concaved in a concave shape prevents the internal electrode structure 80 etc. from being broken even when internal pressure in the chip rises due to gas generated when overvoltage is applied. Moreover, the internal electrode structure 80 housed in the chip is pressed down by the concave shape structure, and thereby internal electrical resistance of the internal electrode structure 80 can be reduced.

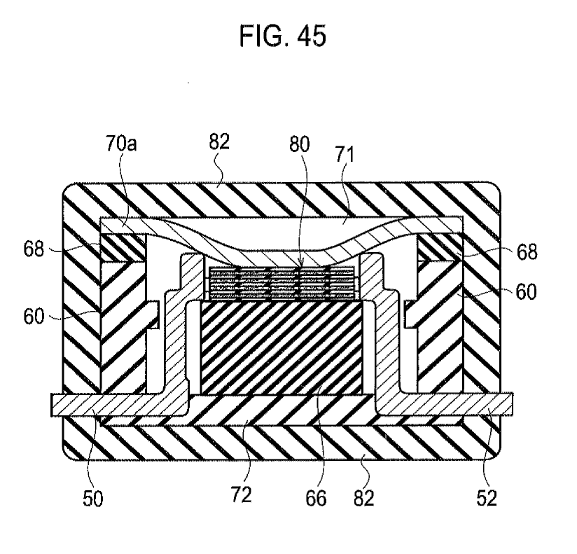

As shown in FIG. 44, the chip whose sealing cover 70a is concaved in the concave shape is immersed in the electrolytic bath 45 containing the electrolysis solution 44 to be impregnated with the electrolysis solution 44. As shown in FIG. 45, the adhesive agent (e.g., chemical-resistant ceramics) 72 is used for the sealant (i.e., sealant for preventing the electrolysis solution 44 from leaking) with which the electrolysis solution 44 impregnated in the chip contacts, thereby reducing an effect of degradation etc. of the electrolysis solution 44. Moreover, the through-holes 63 and 64 impregnated with the electrolysis solution 44 are also re-sealed with the chemical-resistant ceramic adhesive agent 72. Furthermore, since the sealant composed of the adhesive agent 72 (and the adhesive agent 68) has delicate characteristics mechanically, a resin mold 82 is used for covering the outer package of the chip in order to reinforce sealant, as shown in FIG. 45, and thereby a sealing structure package having two layers of the adhesive agent 72 and the resin mold 82 is composed.

Note that when covering the outer package of the chip with the resin mold 82, it is composed as a sealing structure covered so as to form a predetermined space part 71 shown in FIG. 45 between the recessed region of the sealing cover 70a concaved to inside thereof and the resin mold 82. That is, the outer package of the chip is covered so that the space part 71 formed on the recessed region of the sealing cover 70a is not filled with the resin mold 82. Accordingly, even when the internal pressure inside of the chip rises with the gas generated when the overvoltage is applied, the concave sealing cover 70a a margin for expanding in an upward direction (i.e., there is a margin for restoring to a situation before concaving a portion in which the sealing cover 70a is concaved), and thereby the internal electrode structure 80 etc. can be prevented from being broken.

### (Fabrication Method of Chip Type Energy Device)

With reference to FIGS. 35-45, a fabrication method of the chip type energy device according to the third embodiment will now be explained.

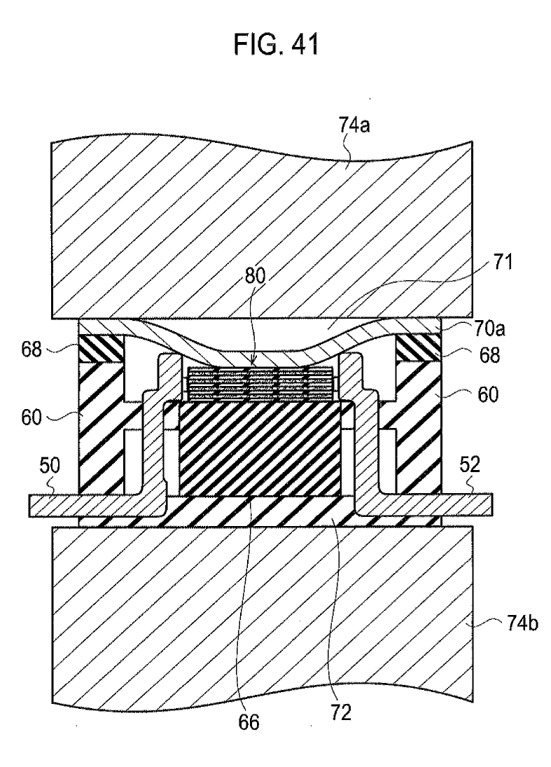

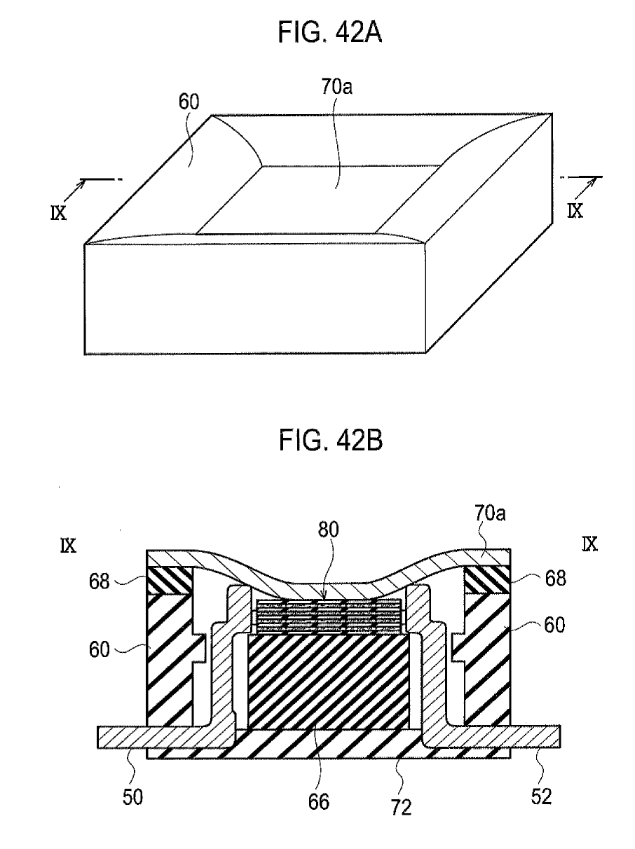

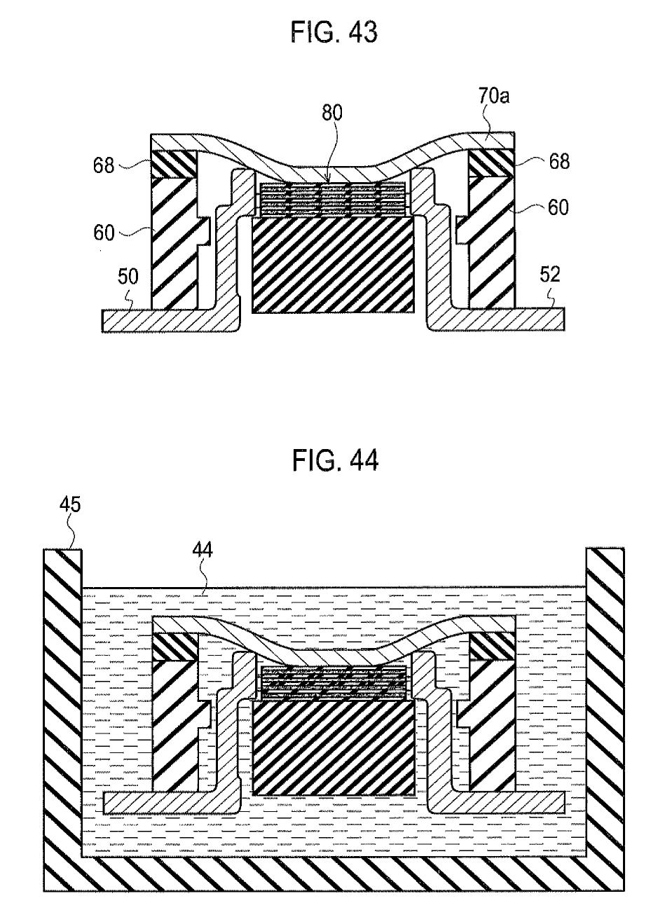

(a) First of all, as shown in FIG. 35A, an electrode plate composed of aluminum foil is prepared. As a material of the electrode plate, a high power aluminum electrode sheet is used, for example. A portion on which the active material (activated carbon) is coated among the upper surface of the electrode plate (e.g., aluminum foil) is used as the active material electrodes 10 and 12 (the positive electrode 10 and the negative electrode 12), and a portion which the active material (activated carbon) is not coated among the upper surface of the electrode plate is used as the extraction electrode 32. Furthermore, as shown in FIG. 35B, the electrode plate is cut in rectangles. Each electrode plate which is cut in rectangles is used respectively as the electrode including the active material electrodes 10 and 12 (the positive electrode 10 and the negative electrode 12) and the extraction electrode 32.
(b) As shown in FIG. 36, the internal electrode structure 80 (e.g., storage element) which is the layered structure is composed so that the internal electrode structure 80 is laminated with at least two (or more) layers of the active material electrodes 10 and 12, and the positive electrode 10 and the negative electrode 12 become alternately. At this time, the extraction electrodes 32a and 32b on which the active material is not coated is laminated so as to be exposed respectively from the internal electrode structure 80. Moreover, the internal electrode structure 80 is laminated to insert respectively the separator 30 between the layers of each active material electrode 10 and 12. Moreover, in order to prevent from a short circuit, the separator 30 whose size is larger (whose area is wider) than those of the active material electrodes 10 and 12 is used so that whole of the active material electrode 10 and the 12 is covered as shown in FIG. 36A, and not an electrode but the separator 30 is laminated respectively at least on the topmost part of the layered structure as shown in FIG. 36B.
(c) Next, as shown in FIG. 37, the extraction electrodes 32a and 32b exposed from the layered structure and the tab electrodes 34a and 34b are connected (electrode formation) using the sealants 36a and 36b in the weld holes 20c and 20d. Ultrasonic welding, soldering, etc., for example, are used for welding of such a electrode formation. The tab electrodes 34a and 34b can be formed of Al, Ni, etc., for example.
(d) Next, as shown in FIG. 38, the internal electrode structure 80 shown in FIG. 37 and the welded terminal electrode 50, and 52 etc. are housed in the frame member 60. The frame member 60 is formed of ceramics, for example. As shown in FIG. 38A, the through-holes 63 and 64 for passing the terminal electrodes 50 and 52 therethrough, and the housing recess for housing the internal electrode structure 80 are formed in the frame member 60. Accordingly, as shown in FIG. 38B, the terminal electrodes 50 and 52 extended from the tab electrodes 34a and 34b can be extracted to the outside of the frame member 60 through the through-holes 63 and 64. In addition, the internal electrode structure 80 is bonded to be mounted on the base 66 in the frame member 60.
(e) Next, as shown in FIG. 39, the metal sealing covers 70 is bonded with the adhesive agent 68 to be mounted on the upper surface of the frame member 60, and then the upper surface of the frame member 60 is sealed, and thereby the chip is composed. As the sealing cover 70, a comparatively soft metal plate, e.g. Al, is used, for example. As the adhesive agent 68, a ceramic adhesive agent is used, for example. Moreover, the through-holes 63 and 64 formed in the bottom surface of the frame member 60 and in the frame member 60 are also sealed with the adhesive agent 72. The same material as the adhesive agent 68 (e.g., a chemical-resistant ceramic adhesive agent) can also be used for the adhesive agent 72.
(f) Next, as shown in FIG. 40, the press machines 70a and 70b are placed on the upper surface and the bottom surface of the frame member 60 (chip) so as to sandwich the frame member 60 therebetween. More specifically, one side (70a) of the press machines is placed on the upper surface of the sealing cover 70 of the frame member 60, and another side (70b) of the press machines is placed on the bottom surface of the sealant of the adhesive agent 72.
(g) Next, as shown in FIG. 41, the chip is pressed from upward and downward by the press machines 70a and 70b, and let to dry as-is status. As the drying proceeds, internal pressure in the frame member 60 is decreased, and the sealing cover 70 formed with a comparatively soft metal plate is concaved to inside thereof (it is shifted to a situation of the sealing cover 70a shown in FIG. 41). Note that the press machines 70a and 70b are warmed beforehand before the pressing with the press machines 70a and 70b, and then cooled during the drying after the pressing, an effect of concaving in the concave shape of the sealing cover 70a can be improved. FIG. 42 shows an aspect that the press machines 70a and 70b are removed from the chip, after concaving the sealing cover 70a in the concave shape.
(h) Next, as shown in FIG. 43, the adhesive agent 72 is removed from the frame member 60. A reason for removing the adhesive agent 72 is because the ceramic adhesive agent is delicate in strength, and the chip is impregnated with the electrolysis solution 44 in the following process from the through-holes 63 and 64 formed in the frame member 60 (chip) after removing the adhesive agent 72. Note that it should take care so that the sealing cover 70a bonded with the adhesive agent 68 to be mounted are not removed from the frame member 60 when removing the adhesive agent 72 from the frame member 60.
(i) Next, as shown in FIG. 44, the chip is immersed in the electrolytic bath 45 containing the electrolysis solution 44, the electrolysis solution 44 is impregnated in the layered structure 80 from the through-holes 63 and 64, and thereby the electrolyte is impregnated between the laminated active material electrodes 10 and 12. At this time, the electrical aging is also performed simultaneously and the degas process is performed.
(j) As shown in FIG. 45 next, the through-holes 63 and 64 of the chip pulled up from the electrolytic bath 45 are re-sealed with the adhesive agent 72. As shown in FIG. 45, the adhesive agent (e.g., chemical-resistant ceramics) 72 is used for the sealant (i.e., sealant for preventing the electrolysis solution from leaking) with which the electrolysis solution 44 impregnated in the chip contacts, thereby reducing effect of degradation etc. of the electrolysis solution 44. Moreover, the through-holes 63 and 64 impregnated with the electrolysis solution 44 are also sealed with the chemical-resistant ceramic adhesive agent 72.
(k) Furthermore, since the sealant composed of the adhesive agent 72 (and the adhesive agent 68) has delicate characteristics mechanically, the resin mold 82 is used for covering the outer package of the chip in order to reinforce sealant, as shown in FIG. 45, and thereby a sealing structure package having two layers of the adhesive agent 72 and the resin mold 82 is composed. Note that when covering the outer package of the chip with the resin mold 82, it is composed as a sealing structure covered so as to form a predetermined space part 71 shown in FIG. 45 between the recessed region of the sealing cover 70a concaved to inside thereof and the resin mold 82. If the chip is dried up as-is status, the chip type energy device according to the third embodiment is completed.

As mentioned above, according to the chip type energy device according to the third embodiment, and the fabrication method for the chip type energy device, the internal electrode structure 80 is composed of the layered structure in which the positive electrode and the negative electrode are alternately laminated so that the extraction electrode 32 (32a and 32b) is exposed, while inserting the separator 30 between at least two (or more) layers of the positive and negative active material electrodes 10. High power can be obtained also with the chip type energy device by using the high power aluminum electrode sheet as a material of the electrode plate for forming the active material electrodes 10 and 12 and the extraction electrode 32 (32a and 32b).

Moreover, since the through-holes 63 and 64 for passing the terminal electrodes 50 and 52 therethrough are formed in the frame member 60, the terminal electrodes 50 and 52 can be extracted to the outside of the frame member 60 through the through-holes 63 and 64. Accordingly, the terminal electrodes 50 and 52 can be connected directly to the internal electrode structure 80, thereby reducing the internal electrical resistance of the electrode structure 80 in the chip easily. The injected hole for impregnating with the electrolysis solution 44 can be made to serve a double purpose with the through-holes 63 and 64 for passing the terminal electrodes 50 and 52 therethrough.

Furthermore, in order to reinforce sealant composed of the adhesive agent 72 (and the adhesive agent 68), the resin mold 82 is used for covering the outer package of the chip, and thereby the sealing structure package having two layers of the adhesive agent 72 and the resin mold 82 is composed. The chemical-resistant ceramic adhesive agent is used for the adhesive agent 72, thereby reducing the effect of degradation etc. of the electrolysis solution 44. Furthermore, the through-holes 63 and 64 impregnated with the electrolysis solution 44 are also re-sealed with the chemical-resistant ceramic adhesive agent 72. Moreover, the space part 71 formed between the metal sealing covers 70a which concaved in concave shape and the resin mold 82 prevents the internal electrode structure 80 etc. from being broken even when internal pressure in the chip rises due to gas generated when overvoltage is applied. Furthermore, according to the concave shape structure, the internal electrode structure 80 housed in the chip is pressed down, and thereby the internal electrical resistance of the internal electrode structure 80 can be reduced.

Moreover, since high airtightness can be kept and high sealing ability can be obtained according to the sealing structure of two layers of the adhesive agent 72 and the resin mold 82, can prevent that the electrolysis solution etc. impregnated in the chip is leaked from the chip or moisture etc. is invaded in the chip.

### Fourth Embodiment

A chip type energy device according to a fourth embodiment is different from the chip type energy device according to the third embodiment, in respect of the following.

That is, as shown in FIGS. 40 and 45, according to the chip type energy device according to the third embodiment, the through-holes 63 and 64 of the chip are sealed, for example, with the chemical-resistant ceramic adhesive agent 72 (and the adhesive agent 68), and the outer package of the chip is also covered with the resin mold 82, and thereby the sealing structure package having two layers of the adhesive agent 72 and the resin mold 82 is composed.

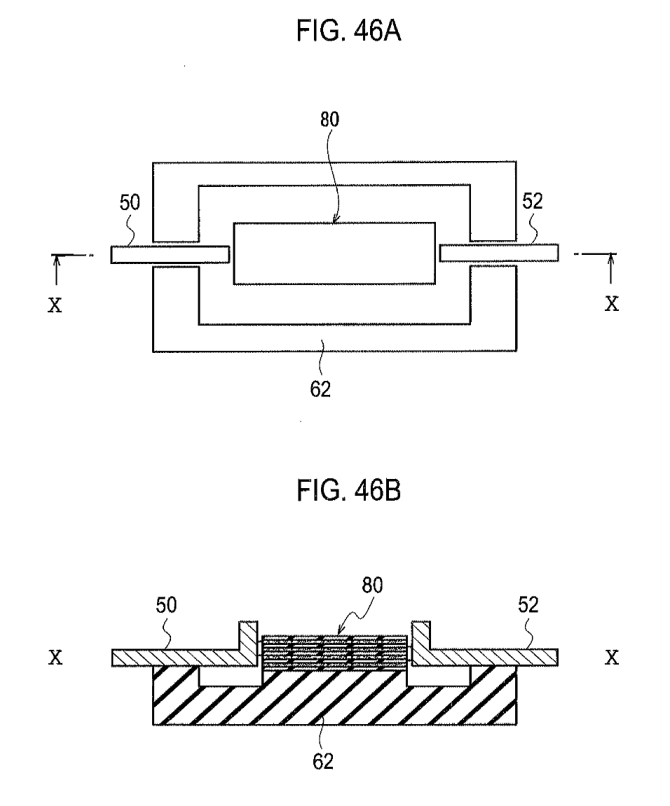

On the other hand, in accordance with the chip type energy device according to the fourth embodiment, as shown in FIGS. 46-50, the through-holes for extracting the terminal electrodes 50 and 52 are formed in the base 62 on which the internal electrode structure 80 is bonded to be mounted. The base 62 is formed of a chemical-resistant ceramic raw material, for example. The through-holes formed in the base 62 have the purpose of not only extracting the terminal electrodes 50 and 52 to the outside of the chip, but also impregnating the chip with the electrolysis solution 44 from the through-holes. For that reason, as shown in FIG. 46A, a minimum required gap for passing the electrolysis solution 44 therethrough at least is formed respectively between each through-hole and each the extracted terminal electrode 50 and 52. In addition, the through-holes may be formed in the frame member 60 in the same manner as that of the third embodiment, without forming in the base 62, and may be formed in both the base 62 and the frame member 60 to form the aforementioned through-holes by combining the base 62 and the frame member 60.

Moreover, the terminal electrodes 50 and 52 are extracted to outside from the through-holes in parallel at the almost same height as the internal electrode structure 80.

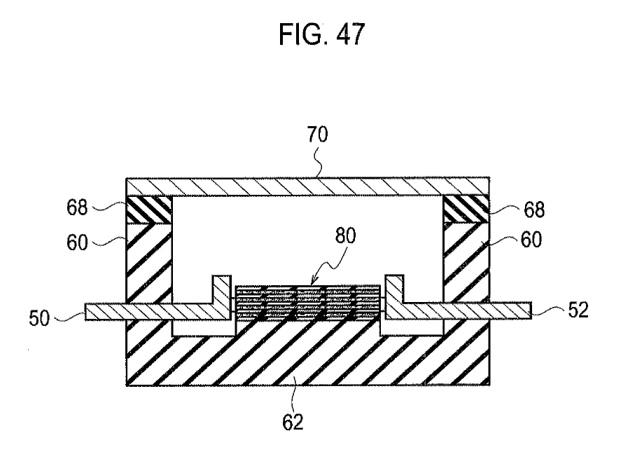

As shown in FIG. 47, the internal electrode structure 80 is housed in the frame member 60, after mounting the internal electrode structure 80 on the base 62 and extracting the terminal electrodes 50 and 52. Then, the sealing cover 70 formed of a relatively soft metal plate (e.g., Al), for example, is bonded with the adhesive agent 68 (e.g., chemical-resistant ceramic adhesive agent) to be mounted on the upper surface of the frame member 60, in the same manner as that of the third embodiment, and thereby the upper surface of the frame member 60 is sealed.

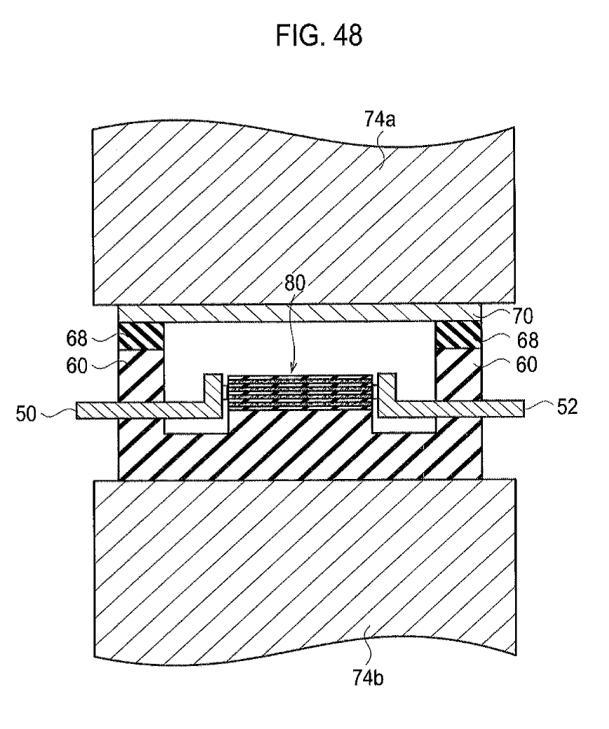

Next, as shown in FIG. 48, the press machines 70a and 70b are placed on the upper surface and the bottom surface of the frame member 60 (chip) so as to sandwich the frame member 60 therebetween. More specifically, one side (70a) of the press machines is placed on the upper surface of the sealing cover 70 of the frame member 60, and another side (70b) of the press machines is placed on the bottom surface of the base 62.

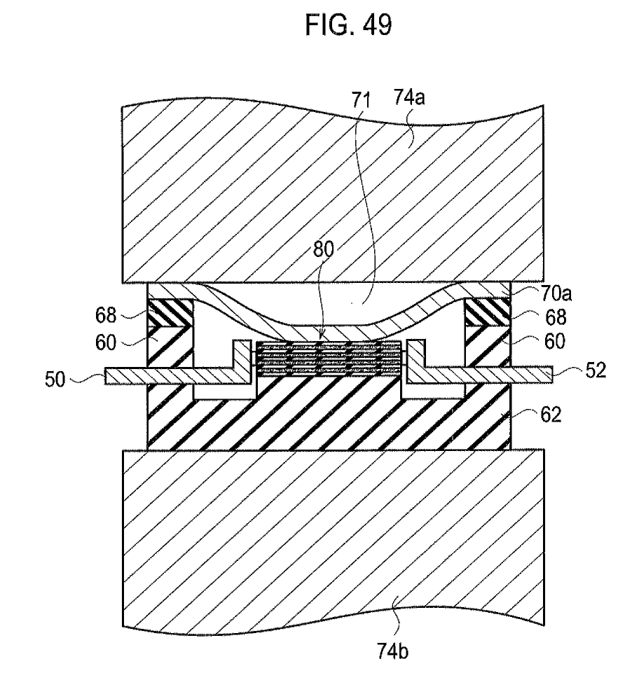

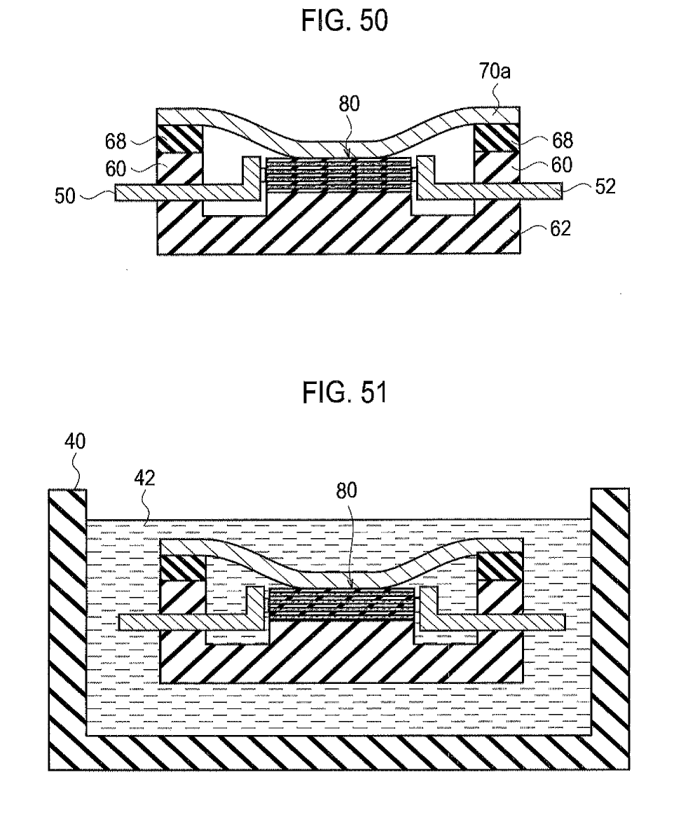

Next, as shown in FIG. 49, the chip is pressed from upward and downward by the press machines 70a and 70b and is let to dry as-is status. As the drying proceeds, internal pressure in the frame member 60 is decreased, and the sealing cover 70 formed with the comparatively soft metal plate is concaved to inside thereof. FIG. 50 shows an aspect that the press machines 70a and 70b are removed from the chip, after concaving the sealing cover 70a in the concave shape.

In contrast to the third embodiment, the ceramic adhesive agent 72 is not used as the sealant of the lower part of the frame member 60, in the fourth embodiment. Accordingly, it becomes unnecessary to perform a process of removing the adhesive agent 72 (i.e., process (h) in the third embodiment), taking care so that the sealing cover 70a is not removed from the frame member 60 as mentioned in the third embodiment. Moreover, in the fourth embodiment, it also becomes unnecessary to perform a process of re-sealing the through-holes 63 and 64 of the chip, pulled up from the electrolytic bath 45, with the adhesive agent 72 (i.e., process (j) in the third embodiment).

Next, as shown in FIG. 51, the chip is immersed in the electrolytic bath 45 containing the electrolysis solution 44, the electrolysis solution 44 is impregnated in the layered structure 80 from the through-holes 63 and 64, and thereby the electrolyte is impregnated between the laminated active material electrodes 10 and 12, in the same manner as that of the third embodiment. At this time, the electrical aging is also performed simultaneously and the degas process is performed.

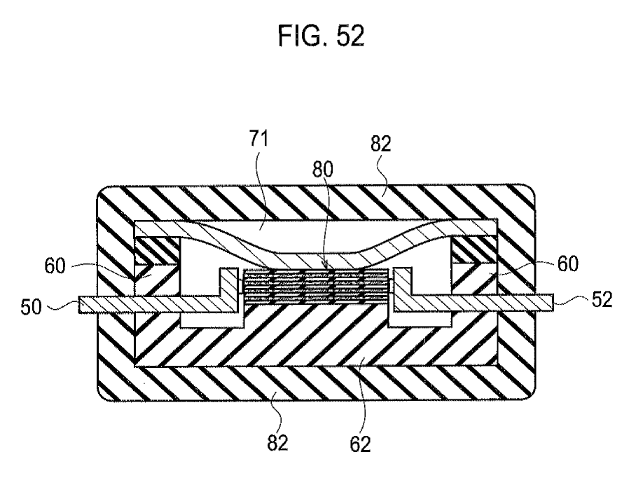

Finally, in order to reinforce the chip pulled up from the electrolytic bath 45, as shown in FIG. 52, the outer package of the chip is covered with the resin mold 82, and thereby the package having the double layer structure of the ceramic base 62 and the resin mold 82 is composed. Note that when covering the outer package of the chip with the resin mold 82, it is composed as a sealing structure covered so as to form a predetermined space part 71 shown in FIG. 52 between the recessed region of the sealing cover 70a concaved to inside thereof and the resin mold 82. If the chip is dried up as-is status, the chip type energy device according to the fourth embodiment is completed.

According to the fourth embodiment, it can achieve the fabrication method of the chip type energy device by the process simplified rather than the fabricating process according to the third embodiment, with maintenance of the performance and airtightness equivalent to the chip type energy device according to the third embodiment.

Moreover, according to the fourth embodiment, since the terminal electrodes 50 and 52 are extracted to outside from the through-holes in parallel at the almost same height as the internal electrode structure 80, it can be provide the more small-sized (reduced height) chip type energy device, with maintenance of the performance and airtightness equivalent to the chip type energy device according to the third embodiment.

According to the chip type energy device according to the third and fourth embodiments, and the fabrication method for the chip type energy device, it can provide the chip type energy device which can obtain the high power and can reduce the internal electrical resistance, and the fabrication method for the chip type energy device, even in a field of chip type energy device.

Moreover, according to the chip type energy device according to the third and fourth embodiments, and the fabrication method for the chip type energy device, it can provide the chip type energy device which can improve the adhesibility, can suppress the effect of the electrolysis solutions on degradation etc., and can be sealed with the package having high strength.

### Fifth Embodiment

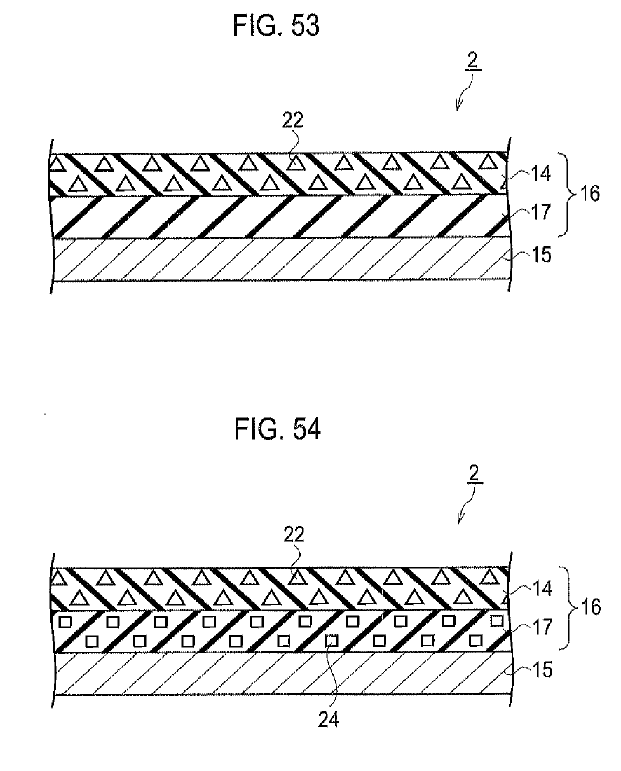

As shown in FIG. 53, an energy device electrode structure 2 according to a fifth embodiment includes: a collector electrode 15; un undercoat layer 17 disposed on the collector electrode 15; and an active material electrode layer 14 disposed on the undercoat layer 17 and including a first binder 22 with high-temperature thermal resistance, a melting point of the first binder 22 being higher than 200 degrees C.

As shown in FIG. 54, an energy device electrode structure 2 according to a modified example 1 of the fifth embodiment includes: a collector electrode 15; un undercoat layer 17 disposed on the collector electrode 15; and an active material electrode layer 14 disposed on the undercoat layer 17 and including a first binder 22 with high-temperature thermal resistance, a melting point of the first binder 22 being higher than 200 degrees C., wherein the undercoat layer 17 includes a second binder 24, and a melting point of the first binder 22 is different from a melting point of the second binder 24.

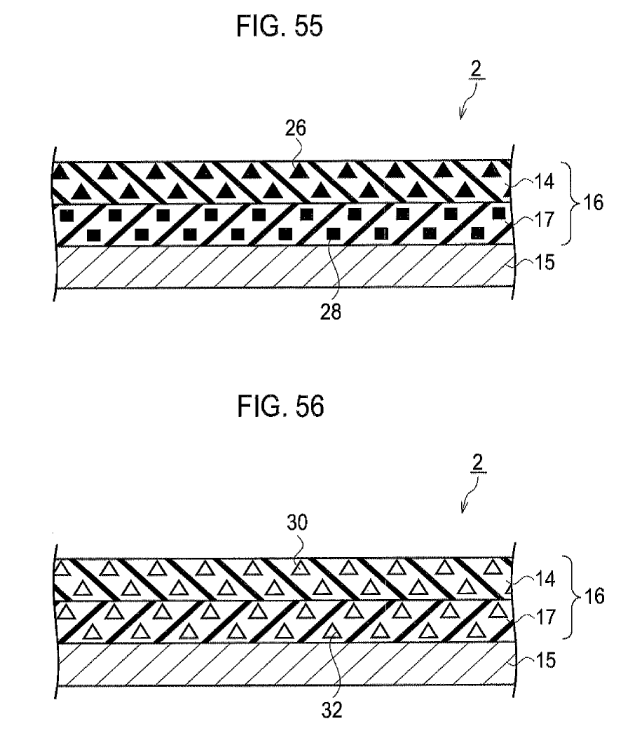

As shown in FIG. 55, a schematic cross-sectional structure of an energy device electrode structure 2 according to a modified example 2 of the fifth embodiment includes: a collector electrode 15; un undercoat layer 17 disposed on the collector electrode 15; and an active material electrode layer 14 disposed on the undercoat layer 17 and including a first binder 26 with high-temperature thermal resistance, a melting point of the first binder 26 being higher than 200 degrees C., wherein the first binder 26 is aramid resin, and the undercoat layer 17 includes a second binder 28 different from the aramid resin. In this case, the aramid resin can be formed of poly-meta-phenyleneisophthalamide, for example. Moreover, the second binder 28 can be formed of poly-tetrafluoroethylene (PTFE), for example. In addition, a resin etc. which are the same fluororesin as the PTFE and have a branching portion and a cross-linking portion in structure of the PTFE, for example are applicable except the PTFE. For example, it is a resin etc. having PMVE (: perfluoromethylvinyl ether) in a branching portion of the structure of the PTFE.

As shown in FIG. 56, a schematic cross-sectional structure of an energy device electrode structure 2 according to a modified example 3 of the fifth embodiment includes: a collector electrode 15; un undercoat layer 17 disposed on the collector electrode 15; and an active material electrode layer 14 disposed on the undercoat layer 17 and including a first binder 30 with high-temperature thermal resistance, a melting point of the first binder 30 being higher than 200 degrees C., wherein the undercoat layer 17 includes a second binder 32, and a melting point of the first binder 30 is equal to a melting point of the second binder 32. Moreover, both of the first binder and the second binder may be formed of aramid resin. In this case, the aramid resin can be formed of poly-meta-phenyleneisophthalamide, for example.

In the energy device electrode structures 2 according to the fifth embodiment and its modified examples 1-3, as shown in FIGS. 53-56, an active material electrode structure 16 is formed of the layered structure composed of the undercoat layer 17 and the active material electrode layer 14.

In the energy device electrode structures 2 according to the fifth embodiment and its modified examples 1-3, formed is the layered structure in which the binder with the high heat resistance whose melting point is higher than 200 degrees C. is applied to one side or both of the undercoat layer 17 and the active material electrode layer 14. The aramid resin, for example, can be applied as the binder with high heat resistance whose melting point is higher than 200 degrees C. Since the melting point of the aramid resin is approximately 250 degrees C., for example, and is sufficiently high temperature higher than 200 degrees C., the active material electrode layer 14/undercoat layer 17 including the aramid binder has high heat resistance.

In the energy device electrode structures 2 according to the fifth embodiment and its modified examples 1-3, since the binder with the high heat resistance whose melting point is higher than 200 degrees C. is applied to one side or both of the undercoat layer 17 and the active material electrode layer 14, degradation and denaturation due to high temperature drying subjected to the binder applying layer can be prevented, adhesibility between the collector electrode 15 which is composed of aluminum foil etc. and the active material electrode structure 16 and between each layers can be maintained, and thereby preventing removal due to the degradation and denaturation.

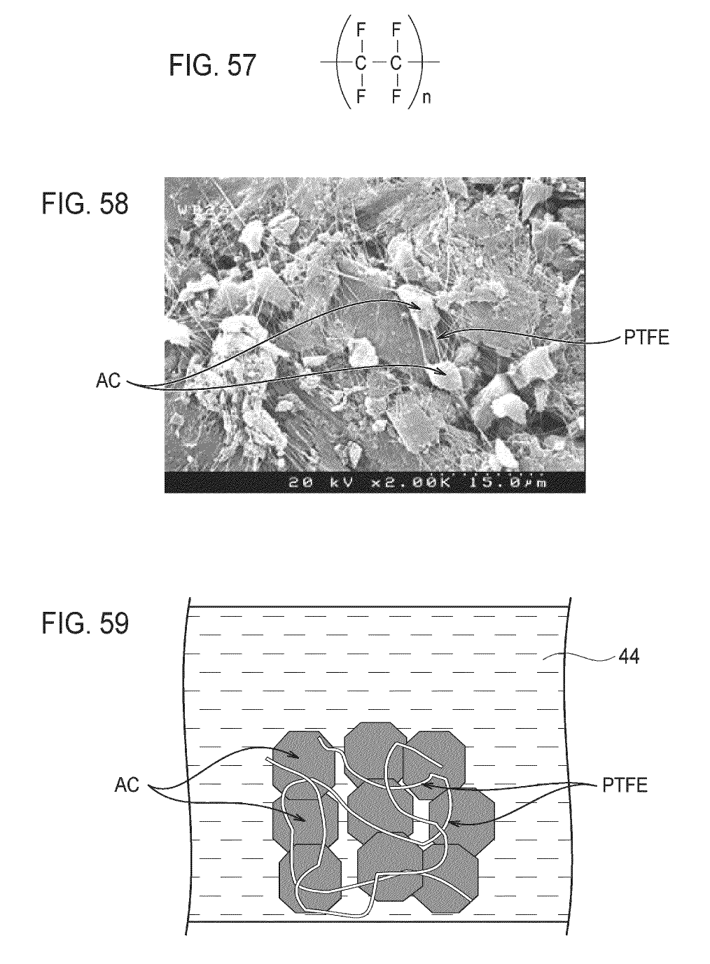

FIG. 57 shows a chemical formula of poly-tetrafluoroethylene (PTFE) as the binder applied to the energy device electrode structure 2 according to the fifth embodiment. Moreover, FIG. 58 shows an example of an SEM photograph of the active material electrode layer to which the PTFE is applied, and FIG. 59 shows a schematic explanatory diagram of the active material electrode layer of FIG. 58. As shown in FIG. 58, in the active material electrode layer to which the PTFE is applied as the binder, activated carbons AC are bound with the PTFE in a fibrous state. Moreover, as schematically shown in FIG. 59, the active material electrode layer in which the activated carbon AC surfaces are bound with the PTFE in a fibrous state is obtained, in the electrolysis solution 44. The melting point of the PTFE is approximately 260 degrees C., for example. Since the PTFE has high heat resistance, the PTFE is applicable as the binder of the undercoat layer or the active material electrode layer.

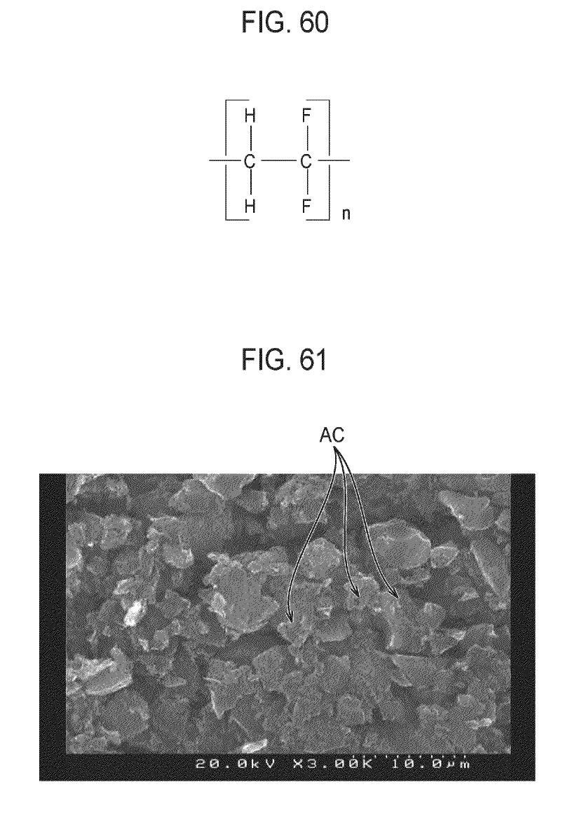

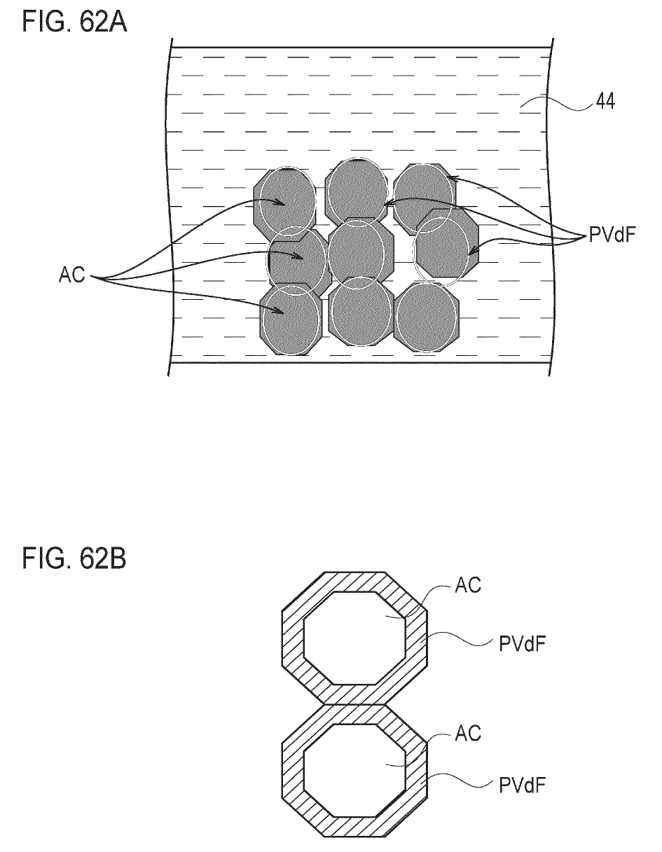

FIG. 60 shows a chemical formula of poly-vinylidene fluoride (PVdF) as the binder of the comparative example. Moreover, FIG. 61 shows an example of an SEM photograph of the active material electrode layer to which the PVdF is applied, FIG. 62A schematically shows the active material electrode layer of FIG. 61, and FIG. 62B shows details of FIG. 62A. In the active material electrode layer to which the PVdF is applied, since the PVdF covered the activated carbon AC surfaces and binds between the activated carbons AC as the binder, the PVdF itself does not appear in FIG. 61. Moreover, as schematically shown in FIGS. 62A and 62B, the active material electrode layer in which the PVdF covers the activated carbon AC surfaces and binds between the activated carbons AC by face binding is obtained, in the electrolysis solution 44. The melting point of the PVdF is approximately 150 degrees C., for example.

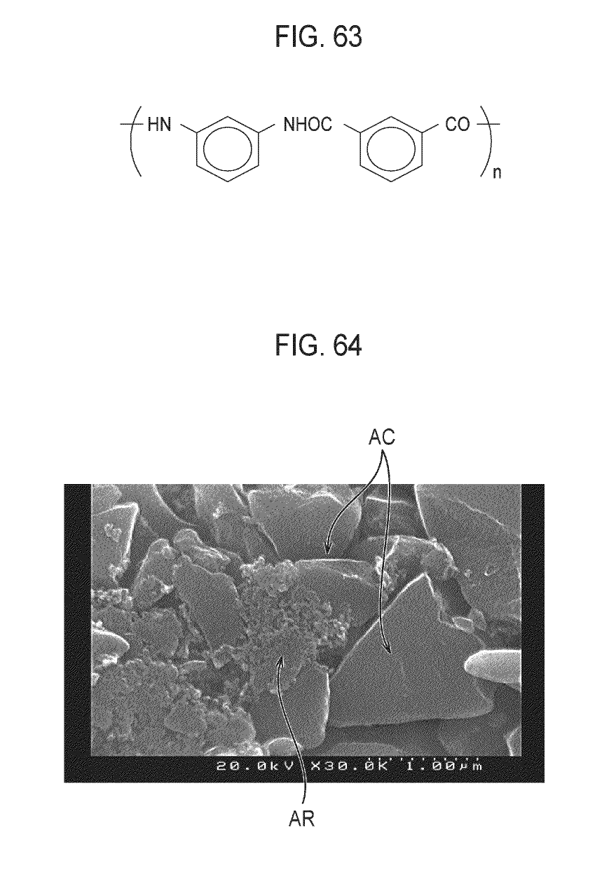

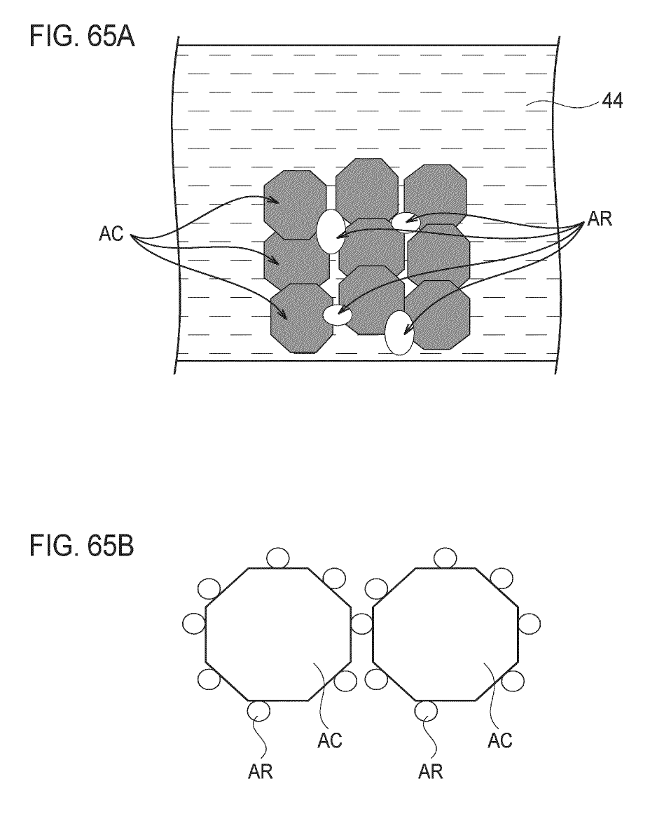

FIG. 63 shows a chemical formula of the aramid resin (poly-meta-phenyleneisophthalamide) as the binder applied to the energy device electrode structure 2 according to the fifth embodiment. Moreover, FIG. 64 shows an example of an SEM photograph of the active material electrode layer to which the aramid resin (poly-meta-phenyleneisophthalamide) is applied as the binder, FIG. 65A schematically shows the active material electrode layer of FIG. 64, and FIG. 65D shows details of FIG. 65A. In the active material electrode layer to which the aramid resin (poly-meta-phenyleneisophthalamide) is applied as the binder, the aramid resin AR binds between the activated carbons AC by spot binding. Moreover, as schematically shown in FIGS. 65A and 65B, the active material electrode layer in which the aramid resin AR adheres to the activated carbon AC surfaces and binds between the activated carbons AC by spot binding is obtained, in the electrolysis solution 44. The melting point of the aramid resin (poly-meta-phenyleneisophthalamide) is approximately 250 degrees C., for example.

### (Fabrication Method)

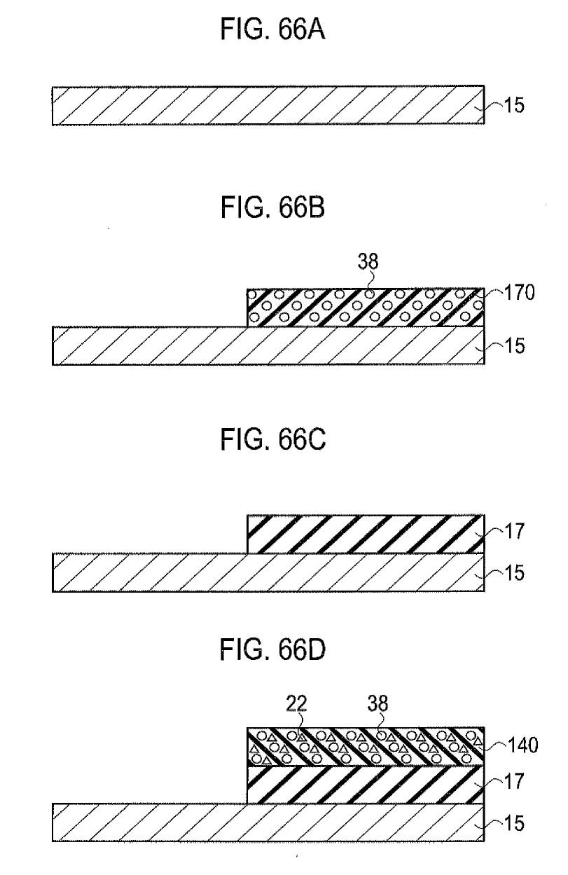

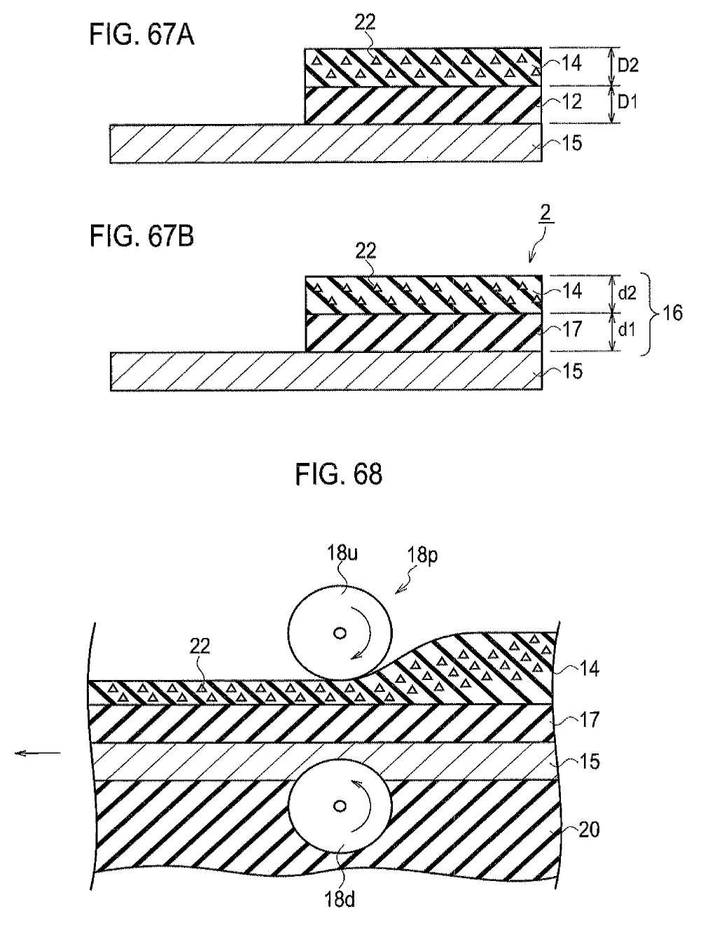

FIGS. 66A-66D and FIGS. 67A-67B show a fabrication method of the energy device electrode structure according to the fifth embodiment, and schematic cross-sectional structures for explaining one process of the fabrication method. Moreover, FIG. 68 shows a schematic cross-sectional structure for explaining one process of the fabrication method of the energy device electrode structure according to the fifth embodiment, and a schematic cross-sectional structure for explaining a roll press process.

As shown in FIGS. 66A-66B, FIGS. 67A-67B and FIG. 68, the fabrication method of the energy device electrode structure according to the fifth embodiment includes: coating the coating liquid 170 for use in the undercoat layer on the collector electrode 15; drying the coating liquid 170 for use in the undercoat layer to form the undercoat layer 17; forming the coating liquid 140 for use in the active material electrode layer including the first binder on the undercoat layer 17; drying the coating liquid 140 for use in the active material electrode layer to form the active material electrode layer 14; and subjecting the layered structure composed of the collector electrode 15, the undercoat layer 17, and the active material electrode layer 14 to a roll press.

Moreover, the process of drying the active material electrode layer 14 may include vacuum drying.

Moreover, the process of the roll press may use in conjunction with a heating process.

Hereinafter, each process of the fabrication method of energy device electrode structure according to the fifth embodiment will be explained in detail.

(a) First of all, as shown in FIG. 66A, the collector electrode 15 is prepared. The collector electrode 15 can be formed using aluminum foil, copper foil, etc., for example.
(b) Next, as shown in FIG. 66B, the coating liquid 170 for use in the undercoat layer is coated on a portion on the collector electrode 15. Ingredients of the coating liquid 170 for use in the undercoat layer include auxiliary conducting agents (e.g., acetylene black, ketjen black), binders (e.g., an aramid binder), and solvents thereof. As clearly from FIG. 66B, the collector electrode 15 is exposed in an uncoated portion of the coating liquid 170 for use in the undercoat layer on the collector electrode 15. As shown in FIG. 66B, residual water 38 is included in the coating liquid 170 for use in the undercoat layer.
(c) Next, as shown in FIG. 66C, the coating liquid 170 for use in the undercoat layer is dried, and thereby the undercoat layer 17 is formed on the collector electrode 15. In the drying process shown in FIG. 66C, the above-mentioned solvent is removed and the residual water 38 is reduced.
(d) Next, as shown in FIG. 66D, the coating liquid 140 for use in the active material electrode layer is coated on the undercoat layer 17. The coating liquid 140 for use in the active material electrode layer includes auxiliary conducting agents (e.g., acetylene black, ketjen black), binders (e.g., an aramid binder), solvents thereof, and a mixture of activated carbon. As clearly from FIG. 66D, the collector electrode 15 is exposed in an uncoated portion of the coating liquid 140 for use in the active material electrode layer on the collector electrode 15. As shown in FIG. 66D, the residual water 38 is included in the coating liquid 140 for use in the active material electrode layer.
(e) Next, as shown in FIG. 67A, the coating liquid 140 for use in the active material electrode layer is dried, and thereby the active material electrode layer 14 is formed on the undercoat layer 17 on the collector electrode 15. In this case, the process for drying the coating liquid 140 for use in the active material electrode layer may include vacuum drying. As a result, as shown in FIG. 67A, a thickness of the active material electrode layer 14 after drying is D1, a thickness of the undercoat layer 17 after drying is D2. In this case, as a detailed numerical example, the thickness of the active material electrode layer 14 before drying is approximately 50 μm, for example, and the thickness D2 of the active material electrode layer 14 after drying is approximately 35 μm, for example.
(f) Next, as shown in FIG. 68 the layered structure composed of the collector electrode 15, the undercoat layer 17, and the active material electrode layer 14 is subjected to a roll press using a roll press machine 18p (18u and 18d). The roll press machine 18p is disposed on the workbench 20, and is adjustable in a width between rolls 18u and 18d by adjusting a height of the upper roll 18u against the lower roll 18d. In addition, the roll press process may use in conjunction with a heating process using a heater etc.

As a result of the above-mentioned roll press process, as shown in FIG. 67B, the thickness of the active material electrode layer 14 becomes d1, and the thickness of the undercoat layer 17 becomes d2. In this case, as a detailed numerical example, the thickness d2 of the active material electrode layer 14 is approximately 28 μm, for example. A reason that the thickness of the active material electrode layer 14 is reduced is because the adhesibility of the activated carbons AC is improved due to the roll press.

In the fabrication method of the energy device electrode structure according to the fifth embodiment, since the high heat resistance binder is applied as the binder, the drying can be performed at high temperature (temperature higher than 200 degrees C.), and thereby the residual water volume can be reduced.

Moreover, in the fabrication method of the energy device electrode structure according to the fifth embodiment, since the drying can be performed at high temperature, and then the roll press can be performed after removing the solvent, removal of the active material etc. at the time of the roll press can be reduced.

Moreover, in the fabrication method of the energy device electrode structure according to the fifth embodiment, the roll press is performed with applying of heat, and thereby the reduction of the residual water volume can be improved.

According to the fifth embodiment, it can provide the energy device electrode structure and the fabrication method for the energy device electrode structure in which degradation and denaturation due to the high temperature drying subjected to the binder applying layer can be suppressed, removal of the active material electrode layer can be prevented, and the reliability can be enhanced.

### Sixth Embodiment

An energy device electrode structure 2 according to a sixth embodiment includes a layered structure including undercoat layers 17u and 17d and active material electrode layers 14u and 14d on front-back both surfaces of the collector electrode 15. Moreover, the energy device electrode structure 2 may include a structure in which such a layered structure is laminated repeatedly.

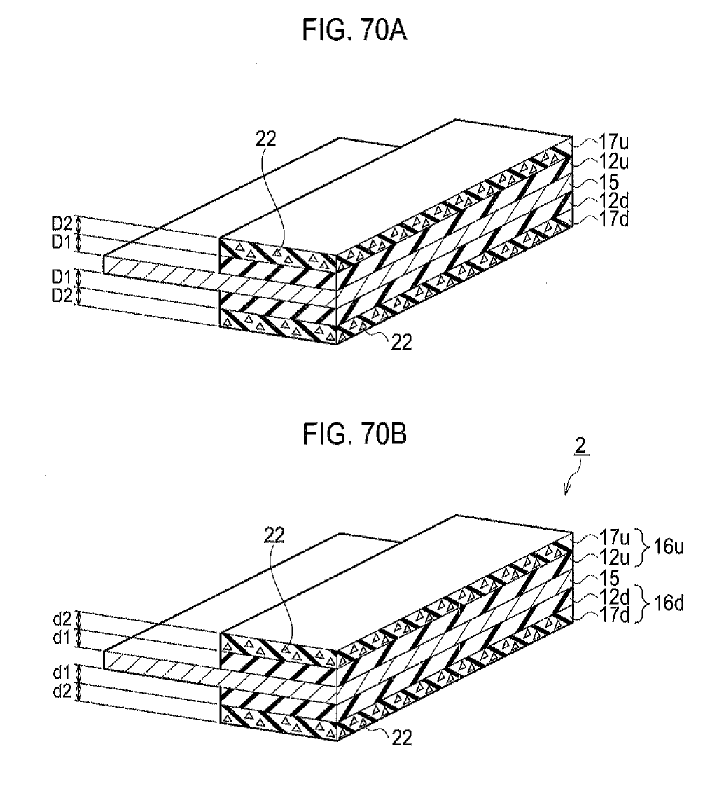

As shown in FIG. 70B, an energy device electrode structure 2 according to the sixth embodiment includes: a collector electrode 15; undercoat layers 17u and 17d disposed on the collector electrode 15; and active material electrode layers 14u and 14d disposed on the undercoat layers 17u and 17d, and including a first binder 22 (the same as that of FIG. 53) with high-temperature thermal resistance, a melting point of the first binder 22 is higher than 200 degrees C.

As in the case of FIG. 54, an energy device electrode structure 2 according to a modified example 1 of the sixth embodiment includes: a collector electrode 15; undercoat layers 17u and 17d disposed on the collector electrode 15; and active material electrode layers 14u and 14d disposed on the undercoat layers 17u and 17d, and including a first binder 22 with high-temperature thermal resistance, a melting point of the first binder 22 is higher than 200 degrees C., wherein the undercoat layers 17u and 17d include a second binder 24, and a melting point of the first binder 22 is different from a melting point of the second binder 24.

As in the case of FIG. 55, a schematic cross-sectional structure of an energy device electrode structure 2 according to a modified example 2 of the sixth embodiment includes: a collector electrode 15; undercoat layers 17u and 17d disposed on the collector electrode 15; and active material electrode layers 14u and 14d disposed on the undercoat layers 17u and 17d, and including a first binder 26 with high-temperature thermal resistance, a melting point of the first binder 26 is higher than 200 degrees C., wherein the first binder 26 is aramid resin, and the undercoat layers 17u and 17d include a second binder 28 different from the aramid resin. In this case, poly-meta-phenyleneisophthalamide, for example, can be applied to the aramid resin. Moreover, poly-tetrafluoroethylene (PTFE), for example, can be applied to the second binder 28.

As in the case of FIG. 56, a schematic cross-sectional structure of an energy device electrode structure 3 according to a modified example 2 of the sixth embodiment includes: a collector electrode 15; undercoat layers 17u and 17d disposed on the collector electrode 15; and active material electrode layers 14u and 14d disposed on the undercoat layers 17u and 17d, and including a first binder 30 with high-temperature thermal resistance, a melting point of the first binder 30 is higher than 200 degrees C., wherein the undercoat layers 17u and 17d include a second binder 32, and a melting point of the first binder 30 is equal to a melting point of the second binder 32. Moreover, both of the first binder and the second binder may be formed of aramid resin. In this case, poly-meta-phenyleneisophthalamide, for example, can be applied to the aramid resin.

In the energy device electrode structures 2 according to the sixth embodiment and its modified examples 1-3, as shown in FIG. 70B and FIGS. 53-55, active material electrode structures 16u and 16d is formed of the layered structures composed of the undercoat layers 17u and 17d and the active material electrode layer 14u and 14d.

In the energy device electrode structures 2 according to the sixth embodiment and its modified examples 1-3, formed is the layered structure in which the binder with the high heat resistance whose melting point is higher than 200 degrees C. is applied to one side or both of the undercoat layers 17u and 17d and the active material electrode layers 14u and 14d. The aramid resin, for example, can be applied as the binder with high heat resistance whose melting point is higher than 200 degrees C. Since the melting point of the aramid resin is approximately 250 degrees C., for example, and is sufficiently high temperature higher than 200 degrees C., the active material electrode layers 14u and 14d/undercoat layers 17u and 17d including the aramid binder has high heat resistance.

In the energy device electrode structures 2 according to the sixth embodiment and its modified examples 1-3, since the binder with the high heat resistance whose melting point is higher than 200 degrees C. is applied to one side or both of the undercoat layers 17u and 17d and the active material electrode layers 14u and 14d, degradation and denaturation due to high temperature drying subjected to the binder applying layer can be prevented, adhesibility between the collector electrode 15 composed of aluminum foil etc. and the active material electrode structures 16u and 16d and between each layers can be maintained, and thereby preventing removal due to the degradation and denaturation.

### (Fabrication Method)

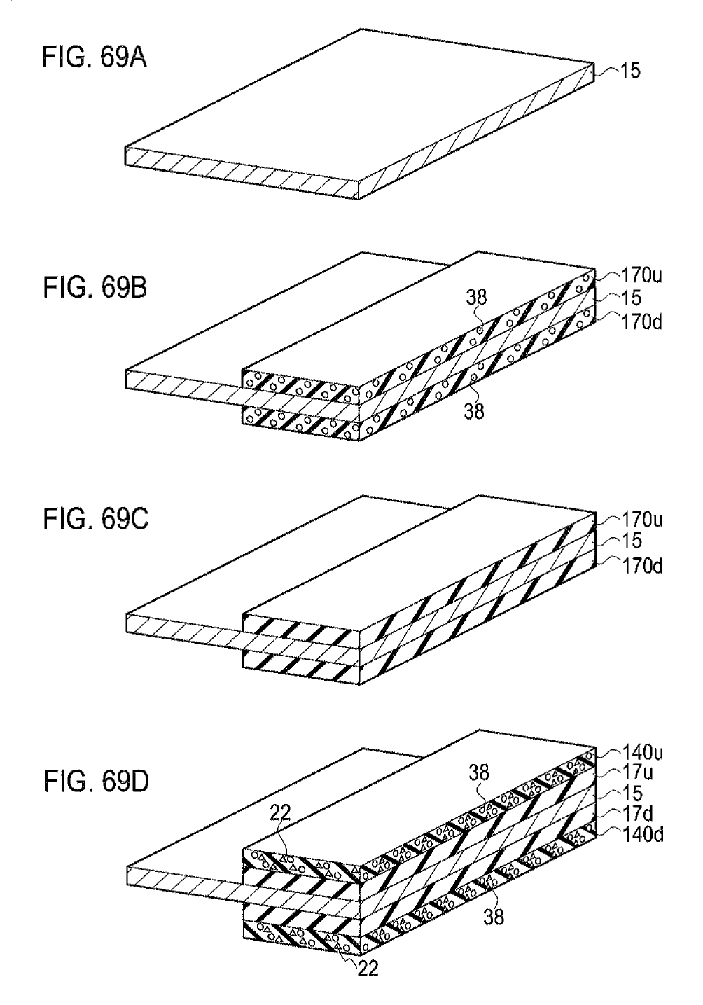

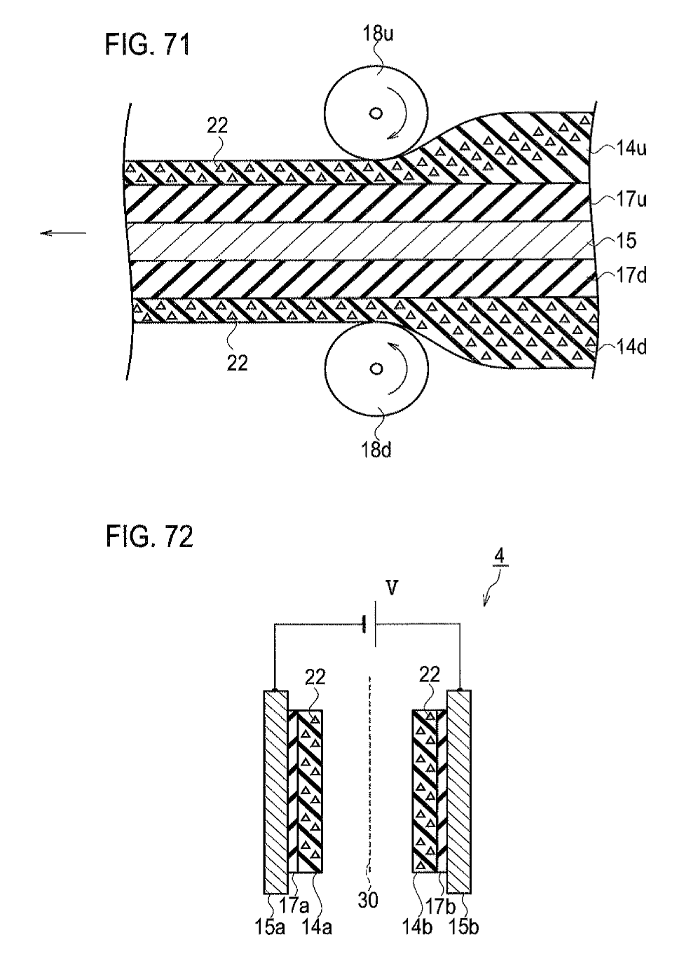

FIGS. 69A-69D and FIGS. 70A-70B show a fabrication method of the energy device electrode structure according to the fifth embodiment, and schematic bird's-eye view structures for explaining one process of the fabrication method. Moreover, FIG. 71 shows a schematic cross-sectional structure for explaining one process of the fabrication method of the energy device electrode structure according to the sixth embodiment, and a schematic cross-sectional structure for explaining a roll press process.

In the fabrication method of the energy device electrode structure according to the sixth embodiment, a process for forming the undercoat layers 17u and 17d on the collector electrode 15 is performed to front-back both surfaces of the collector electrode 15.

Moreover, a process for forming the active material electrode layers 14u and 14d including the first binder on the undercoat layers 17u and 17d is performed on the undercoat layers 17u and 17d formed on the front-back both surfaces of the collector electrode 15.

Hereinafter, each process of the fabrication method of energy device electrode structure according to the sixth embodiment will be explained in detail.

(a) First of all, as shown in FIG. 69A, the collector electrode 15 is prepared. The collector electrode 15 can be formed using aluminum foil, copper foil, etc., for example.
(b) Next, as shown in FIG. 69B, the coating liquids 170u and 170d for use in the undercoat layer are coated on a portion on the front-back both surfaces of the collector electrode 15. Ingredients of the coating liquids 170u and 170d for use in the undercoat layer include auxiliary conducting agents (e.g., acetylene black, ketjen black), binders (e.g., an aramid binder), and solvents thereof. As clearly from FIG. 69B, the collector electrode 15 is exposed in uncoated portions of the coating liquids 170u and 170d for use in the undercoat layer on the collector electrode 15. As shown in FIG. 69B, residual water 38 is included in the coating liquids 170u and 170d for use in the undercoat layer.
(c) Next, as shown in FIG. 69C, the coating liquids 170u and 170d for use in the undercoat layer are dried, and thereby the undercoat layers 17u and 17d are formed on the collector electrode 15. In the drying process shown in FIG. 69C, the above-mentioned solvent is removed and the residual water 38 is reduced.
(d) Next, as shown in FIG. 69D, the coating liquids 140u and 140d for use in the active material electrode layer are coated on the undercoat layers 17u and 17d. The coating liquids 140u and 140d for use in the active material electrode layer include auxiliary conducting agents (e.g., acetylene black, ketjen black), binders (e.g., an aramid binder), solvents thereof, and a mixture of activated carbon. As clearly from FIG. 69D, the collector electrode 15 is exposed in uncoated portions of the coating liquids 140u and 140d for use in the active material electrode layer on the collector electrode 15. As shown in FIG. 69D, the residual water 38 is included in the coating liquids 140u and 140d for use in the active material electrode layer.
(e) Next, as shown in FIG. 70A, the coating liquids 140u and 140d for use in the active material electrode layer are dried, and thereby the active material electrode layers 12u and 12d are formed on the undercoat layers 17u and 17d on the collector electrode 15. In this case, the process for drying the coating liquids 140u and 140d for use in the active material electrode layer may include vacuum drying. As a result, as shown in FIG. 70A, a thickness of each of the active material electrode layers 12u and 12d after drying is D1, a thickness of each of the undercoat layers 17u and 17d after drying is D2. In this case, as a detailed numerical example, the thickness of each of the active material electrode layers 12u and 12d before drying is approximately 50 μm, for example, and the thickness D2 of each of the active material electrode layers 12u and 12d after drying is approximately 35 μm, for example.
(f) Next, as shown in FIG. 71 the layered structure composed of the collector electrode 15, the undercoat layers 17u and 17d, and the active material electrode layers 12u and 12d is subjected to a roll press using a roll press machine 18p. The roll press machine 18p is disposed on the workbench 20, and is adjustable in a width between rolls 18u and 18d by adjusting a height of the upper roll 18u against the lower roll 18d. In addition, the roll press process may use in conjunction with a heating process using a heater etc.

As a result of the above-mentioned roll press process, as shown in FIG. 70B, the thickness of each of the active material electrode layers 12u and 12d becomes d1, and the thickness of each of the undercoat layers 17u and 17d becomes d2. In this case, as a detailed numerical example, the thickness d2 of each of the active material electrode layers 12u and 12d is approximately 28 μm, for example. A reason that the thickness of the active material electrode layers 12u and 12d is reduced is because the adhesibility of the activated carbons AC is improved due to the roll press.

In the fabrication method of the energy device electrode structure according to the sixth embodiment, since the high heat resistance binder is applied as the binder, the drying can be performed at high temperature (temperature higher than 200 degrees C.), and thereby the residual water volume can be reduced.

Moreover, in the fabrication method of the energy device electrode structure according to the sixth embodiment, since the drying can be performed at high temperature, and then the roll press can be performed after removing the solvent, removal of the active material etc. at the time of the roll press can be reduced.

Moreover, in the fabrication method of the energy device electrode structure according to the sixth embodiment, the roll press is performed with applying of heat, and thereby the reduction of the residual water volume can be improved.

According to the sixth embodiment, it can provide the energy device electrode structure and the fabrication method for the energy device electrode structure in which degradation and denaturation due to the high temperature drying subjected to the binder applying layer can be suppressed, removal of the active material electrode layer can be prevented, and the reliability can be enhanced.

### (Energy Device)

FIG. 72 shows a schematic cross-sectional structure of the electric double layered capacitor 4 to which the energy device electrode structure according to the fifth or sixth embodiment is applied.

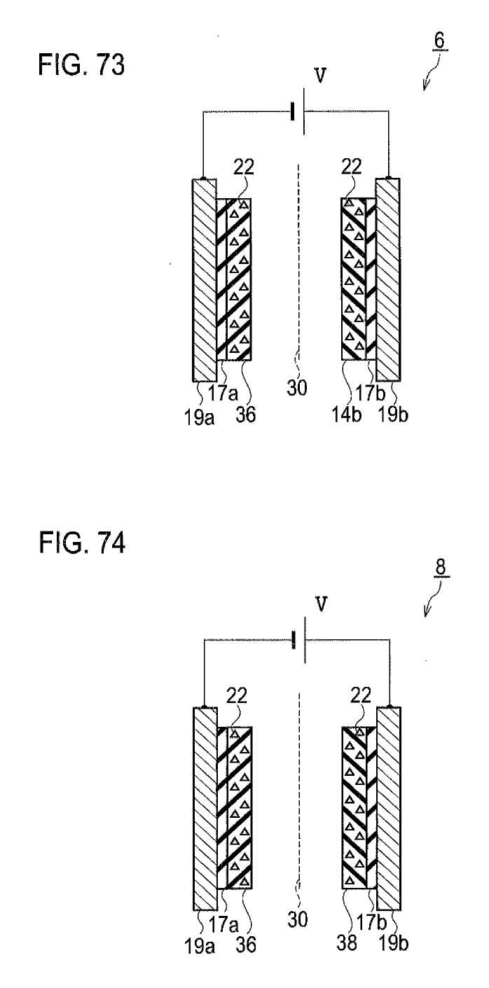

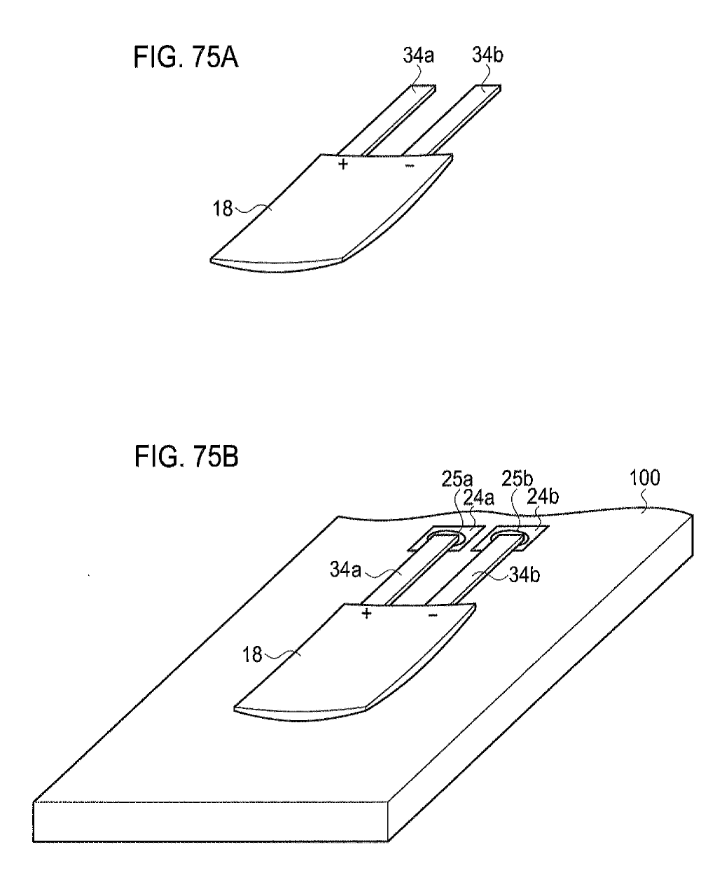

FIG. 73 shows a schematic cross-sectional structure of a lithium ion capacitor 6 to which the energy device electrode structure according to the fifth or sixth embodiment is applied.

FIG. 74 shows a schematic cross-sectional structure of a lithium ion battery 8 to which the energy device electrode structure according to the fifth or sixth embodiment is applied.

With reference to FIGS. 72-74, a fundamental structure of the energy device (for example, energy storage device) to which the energy device electrode structure according to the fifth or sixth embodiment is applied will now be explained. In addition, the energy device electrode structures according to the modified examples 1-3 of the fifth or sixth embodiment are applicable similarly. In FIGS. 72-74, although the electrolysis solution is infiltrated and ion moves through the separator 30 at the time of charge and discharge, the electrolysis solution is omitted from illustrating.

The electric double layered capacitor 4 including the positive and negative active material electrode structure in the energy device electrode structure according to the fifth or sixth embodiment is configured so that the separator 30 in which the electrolysis solution and ion pass therethrough is inserted between the active material electrode layer 14a and the active material electrode layer 14b. The active material electrode layers 14a and 14b are disposed via the undercoat layers 17a and 17b on the collector electrodes 15a and 15b. The collector electrodes 15a and 15b are connected to power supply voltage. In FIG. 72, the active material electrode structures are formed respectively of the layered structure composed of the undercoat layer 17a and the active material electrode layer 14a, and the layered structure composed of the undercoat layer 17b and the active material electrode layer 14b.

As the separator 30, polypropylene etc. can be used when high thermal resistance is not required, or cellulosic based materials can be used when high thermal resistance is required.

The electric double layered capacitor 4 to which the energy device electrode structure according to the fifth or sixth embodiment is applied is impregnated with the electrolysis solution, and the electrolysis solution and the ion are moved through the separator 30 at the time of charge and discharge.

The electric double layered capacitor to which the energy device electrode structure according to the fifth or sixth embodiment is applied is applicable to an LED flash, a power supply for use in motor driving (e.g., suited for toys), a storage element for use in electric motorcars (as an object for regeneration, starters), an energy storage element from a solar battery or a vibration power generation, a power storage element suited for high power communications, an environment-resistant storage element (e.g., a storage element of a road network, a railway network, and a light for use in bicycles), etc.

The lithium ion capacitor 6 to which the energy device electrode structure according to the fifth or sixth embodiment is applied is configured so that the separator 30 in which the electrolysis solution and ion pass therethrough is inserted between the active material electrode layer 36 and the active material electrode layer 14b. The active material electrode layers 36 and 14b are disposed via the undercoat layers 17a and 17b on the collector electrodes 19a and 15b. The collector electrodes 19a and 15b are connected to power supply voltage. In this case, the collector electrode 19a is formed of copper foil, for example, and the collector electrode 15b is formed of aluminum foil, for example. In FIG. 73, the active material electrode structures are formed respectively of the layered structure composed of the undercoat layer 17a and the active material electrode layer 36, and the layered structure composed of the undercoat layer 17b and the active material electrode layer 14b.

The negative active material electrode layer 36 is formed of Li doped carbon (activated carbon) including a binder (e.g., an aramid binder), for example.

The lithium ion capacitor 6 is impregnated with the electrolysis solution, and the electrolysis solution and ion are moved through the separator 30 at the time of charge and discharge.

The lithium ion capacitor to which the energy device electrode structure according to the fifth or sixth embodiment is applied is applicable to an energy storage element from a solar battery or wind power generation, a power supply for use in motor driving, etc.

The lithium ion battery 8 to which the energy device electrode structure according to the fifth or sixth embodiment is applied is configured so that the separator 30 in which the electrolysis solution and ion pass therethrough is inserted between the active material electrode layer 36 and the active material electrode layer 38. The active material electrode layers 36 and 38 are disposed via the undercoat layers 17a and 17b on the collector electrodes 19a and 15b. The collector electrodes 19a and 15b are connected to power supply voltage. In this case, the collector electrode 19a is formed of copper foil, for example, and the collector electrode 15b is formed of aluminum foil, for example. In FIG. 74, the active material electrode structures are formed respectively of the layered structure composed of the undercoat layer 17a and the active material electrode layer 36, and the layered structure composed of the undercoat layer 17b and the active material electrode layer 38.

The positive active material electrode layer 38 is formed of LiCoO₂ including a binder (e.g., an aramid binder), for example. The negative active material electrode layer 36 is formed of Li doped carbon (activated carbon) including a binder (e.g., an aramid binder), for example.

The lithium ion battery 8 is impregnated with the electrolysis solution, and the electrolysis solution and ion are moved through the separator 30 at the time of charge and discharge.

The lithium ion battery to which the energy device electrode structure according to the fifth or sixth embodiment is applied is applicable to a battery for use in portable devices, a storage element for use in electric motorcars (at the time of constant driving), a large-scale storage element (suited for general households), etc.

According to the fifth or sixth embodiment, it can provide the energy device electrode structure and the fabrication method for the energy device electrode structure in which degradation and denaturation due to the high temperature drying subjected to the binder applying layer can be suppressed, removal of the active material electrode layer can be prevented, and the reliability can be enhanced.

The energy device to which the energy device electrode structure is applied can also be provided.

### Seventh Embodiment

### (Fundamental Structure of Laminated Type Energy Device)

With reference to FIGS. 1-3, FIGS. 16-17 and FIGS. 76-79, a fundamental structure applied to a laminated type energy device according to a seventh embodiment will now be explained.

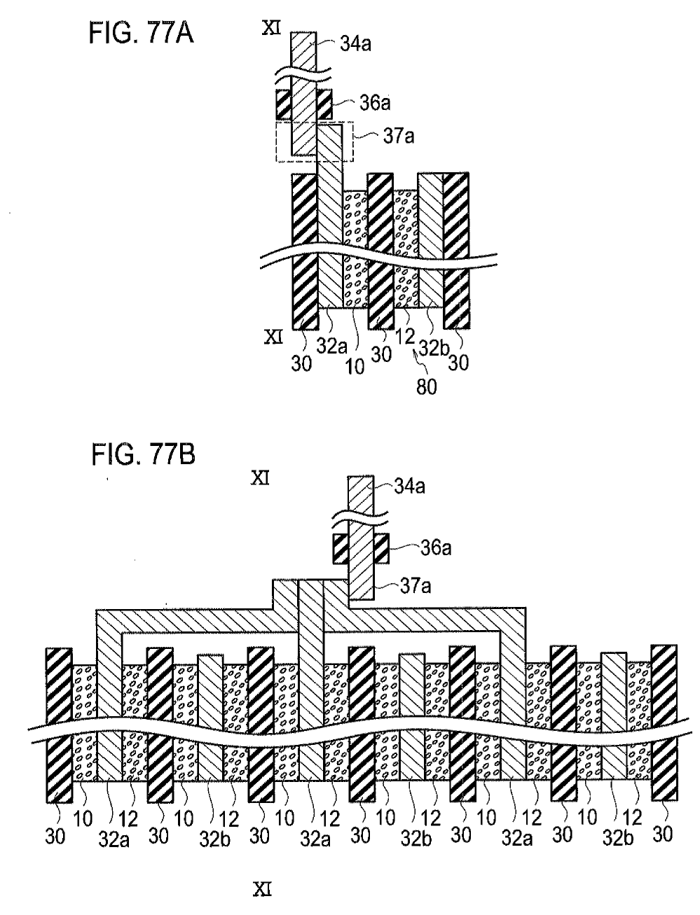

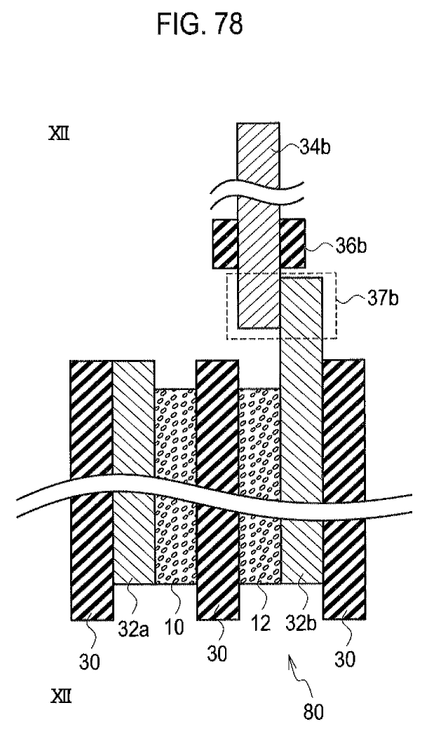

As shown, for example in FIGS. 77 and 78, a laminated type energy device 18 include at least (or more) layers of a layered structure 80 in which a positive electrode and a negative electrode are alternately laminated so that positive and negative extraction electrodes 32a and 32b are exposed, wherein laminate sheets 40a and 40b overlaid from a front surface and aback surface of a layered structure 80 to compressively seal the layered structure 80.

The laminated type energy device 18 includes: the contact holes (bonding hole) 20a and 20b for use in spot bonding between the laminated type energy device 18 and the module substrate 100 as shown in FIG. 1. As the laminated type energy device 18, a thing used as a basic module and mounted on a printed circuit board is assumed, for example. Generally, plenty of parts (e.g., IC chips 160 and 170, a transformer 122 and other device parts 140) except the laminated type energy device 18 are mounted on the module substrate 100. Accordingly, the point of forming the contact holes 20a and 20b in the laminated type energy device 18 contributes to mounting of the laminated type energy device 18 within a limited space. Moreover, since the spot bonding of the contact holes (bonding holes) 20a and 20b is achieved at the time of module installation, a thermal load to an electrolysis solution impregnated into the layered structure 80 of the inside of the laminated type energy device 18 can be reduced, contribution of a coil component can also be reduced, and high frequency characteristics can be improved.

More specifically, as shown in FIGS. 2-3 and FIGS. 76-78, a part of both surfaces of the sealant 36 of the tab electrode 34 (34a and 34b) which is composed of Al, Ni, Cu which performed Ni plating, etc. and is used for the extraction electrodes 32a and 32b composed of aluminum is shaved until an aluminum material of the tab electrode 34 (34a and 34b) is exposed to form the tab electrode extraction holes 20a and 20b. Then, holes are beforehand bored also in the aluminum laminate to be aligned with the same position as the tab electrode extraction holes 20a and 20b. When sealing the layered structure 80 of an internal electrode, the laminate sheet is compressed to be sealed from a front face and a rear surface of the layered structure 80, aligning the tab electrode extraction holes 20a and 20b with the holes. In addition, since the tab electrode extraction holes 20a and 20b and the holes do not need to be circular holes, the desired shaped hole can also be used for the tab electrode extraction holes 20a and 20b and the holes.

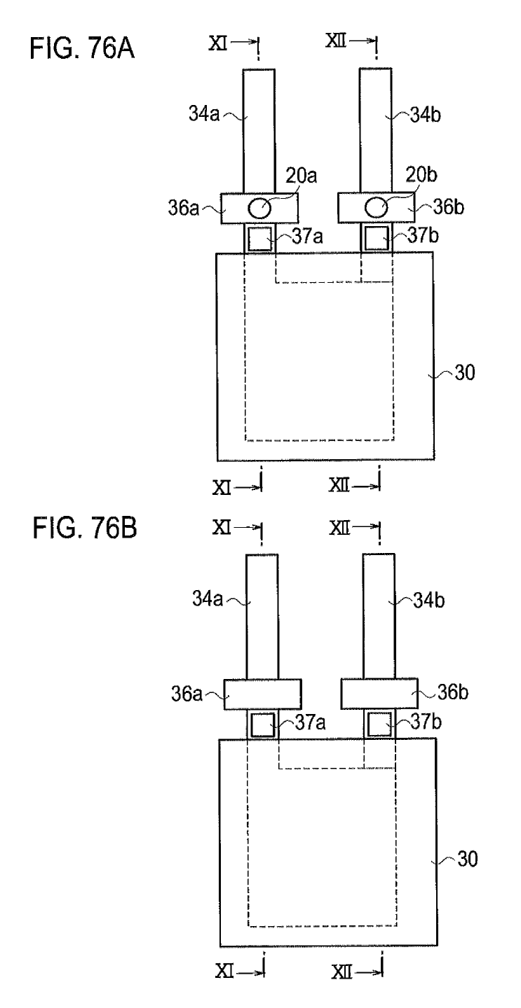

Moreover, the tab electrode extraction holes 20a and 20b shown in FIG. 1 etc. are not indispensable structures. In the structures shown in FIGS. 2-3 and FIGS. 76-78, it is effective also as the structure in which the tab electrode extraction holes 20a and 20b is not formed. That is, the tab electrode extraction holes 20a and 20b may be formed as shown in FIG. 76A, or no tab electrode extraction hole may be formed as shown in FIG. 76B. When not forming the tab electrode extraction hole, it performs incorporating to various devices via the tab electrode 34 (34a and 34b) instead of incorporating via the tab electrode extraction holes 20a and 20b.

As shown in FIGS. 77 and 78, the internal electrode structure (e.g., a storage element) in the laminated type energy device 18 is composed of a layered structure 80 of multilayered structure in which the positive electrode and the negative electrode are alternately laminated so that the positive and negative extraction electrodes 32a and 32b are exposed, while inserting the separator 30 in which an electrolysis solution and ion pass therethrough between at least two (or more) layers of the positive and negative active material electrodes 10.

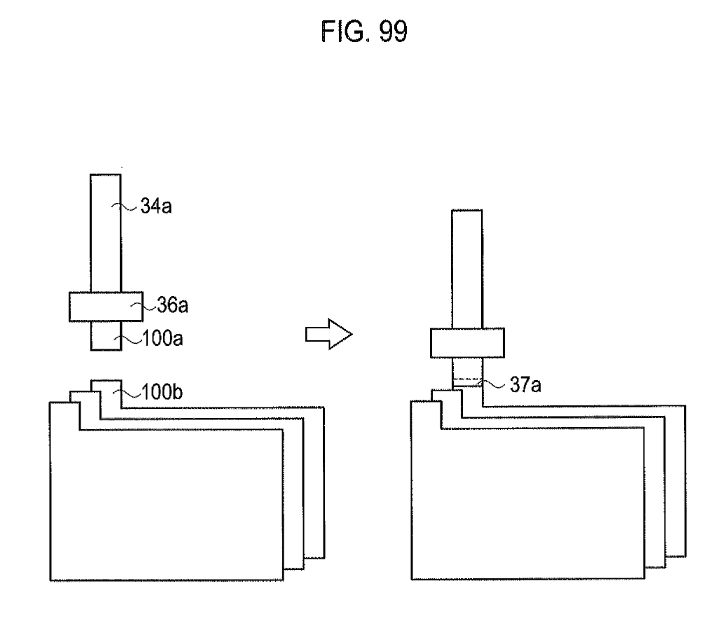

As shown in FIGS. 77A, 78 and 99, an edge part 100b of an upper side of the extraction electrode 32 (32a and 32b) is welded with an edge part 100a of the tab electrode 34 (34a and 34b). Reference numeral 37a denotes a welded part.

Moreover, FIG. 77B shows a configuration example in the case of three pairs of the positive and negative electrodes. In addition, since the outermost active material electrodes 10 and 12 do not become a pair so as to sandwich the separator 30, the outermost active material electrodes 10 and 12 do not affect a capacitor. Moreover, although it is also possible to omit the outermost separator 30, the outermost separator 30 is needed when the separator itself is covered to be packs shape. Moreover, although illustrating is omitted in FIG. 77B, electrode wirings are constructed respectively in common for the active material electrodes 10 and 12 and the extraction electrodes 32a and 32b, in the case of the three pairs of positive and negative electrodes. The separator 30 whose size is larger (whose area is wider) than those of the active material electrodes 10 and 12 is used so that whole of the active material electrode 10 and the 12 is covered as shown in FIGS. 77 and 78.

Although the separator 30 is not theoretically dependent on a kind of energy device, high thermal resistance is required when in particular corresponding to a reflow is needed. As the separator 30, polypropylene etc. can be used when high thermal resistance is not required, or cellulosic based materials can be used when high thermal resistance is required.

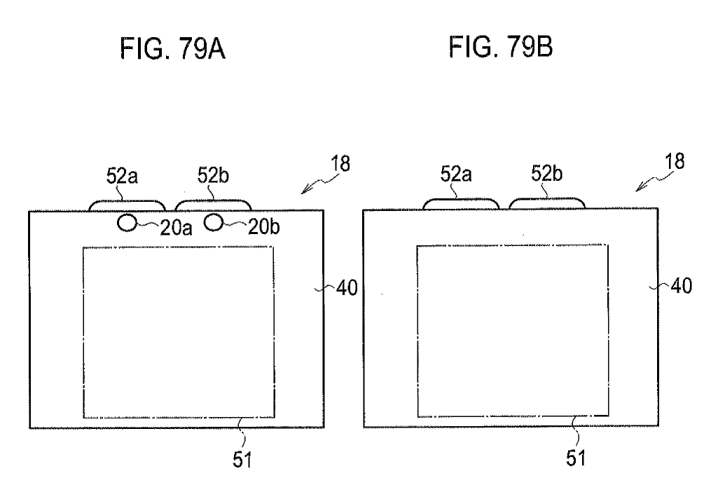

The outer sealing (packaging) laminate sheet 40 is recompressed from the front and back surfaces, and thereby the aluminum of the cut end face of the tab electrodes 34 (34a and 34b) is insulated. At this time, the cut edge part of the tab electrode 34 (34a and 34b) is covered to be insulated with the compressed and extended sealant 36 (36a and 36b) (i.e., the cut end face of the tab electrode 34 (34a and 34b) is covered to be twine with the sealant 52 (52a and 52b) in which the heat compressed is performed and then the sealing member of the sealant 36 (36a and 36b) is melted and extended) (Refer to FIG. 79A).

In addition, when not forming the tab electrode extraction holes 20a and 20b, it will become in a situation shown in FIG. 79B.

FIGS. 16A, 16B and 16C show various examples of positioning of the tab electrode extraction hole 20 (20a and 20b) formed in the laminated type energy device 18. FIG. 17 is a diagram showing various examples of the laminated type energy device 18 in which the tab electrode 34 (34a and 34b) is arranged, aligning with the tab electrode extraction hole 20 (20a and 20b) shown in FIG. 16. FIGS. 17A and 17B correspond to FIG. 16A. FIGS. 17C and 17D correspond to FIG. 16C.

### Comparative Example

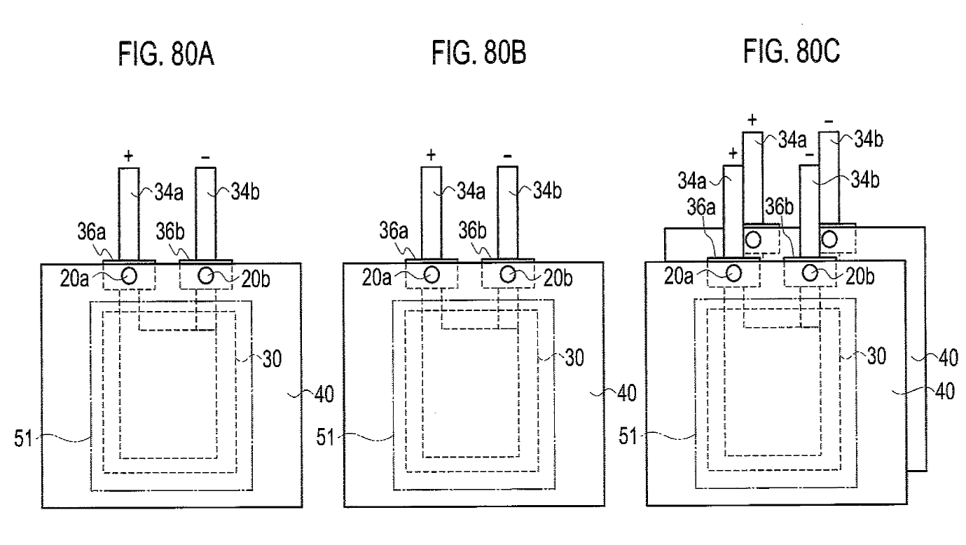

With reference to FIGS. 80-82, a configuration example of a laminated type energy device according to a comparative example will now be explained.

First of all, with reference to FIG. 80, a comparative example in the case where the laminated type energy devices are connected in parallel will now be mentioned.

A standalone device of the laminated type energy device according to the comparative example is shown in FIGS. 80A and 80B.

The standalone device of the laminated type energy device has a structure in which a structure of the energy device shown in above-mentioned FIG. 76 is sealed with the outer sealing laminate sheet 40.

When two laminated type energy devices are connected in parallel, as shown in FIG. 80C, the laminated type energy devices are overlaid, and then the positive tab electrodes 34a are welded to be bonded and the negative tab electrode 34b are welded to be bonded in the tab electrode extraction hole 20 (20a and 20b).

Moreover, the tab electrode extraction holes 20a and 20b are not indispensable structures. It is effective also as a structure in which the tab electrode extraction holes 20a and 20b are not formed. In that case, the tab electrode 34 (34a and 34b) are welded to be bonded, instead of welding via the tab electrode extraction holes 20a and 20b.

When the two laminated type energy devices are connected in parallel, since each standalone device of the respective laminated type energy devices is subjected to laminated-packaging, space will be formed between laminated packages, and thereby the whole capacity will be increased.

Moreover, each laminated type energy device subjected to the laminated-packaging includes the tab electrodes 34a and 34b. Since the tab electrode is composed of Cu with which Ni is plated, Al, Ni, etc., if the number of the connection of the laminated type energy device is increased, the tab electrode will affect the whole cost.

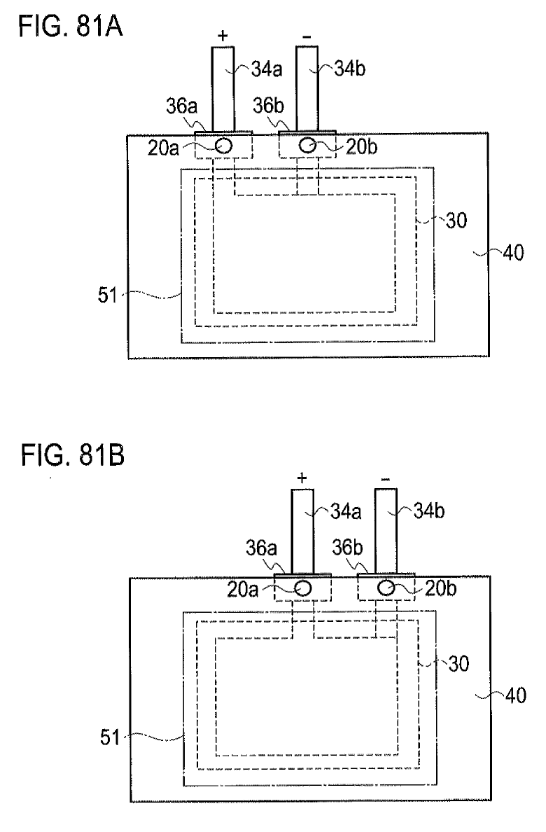

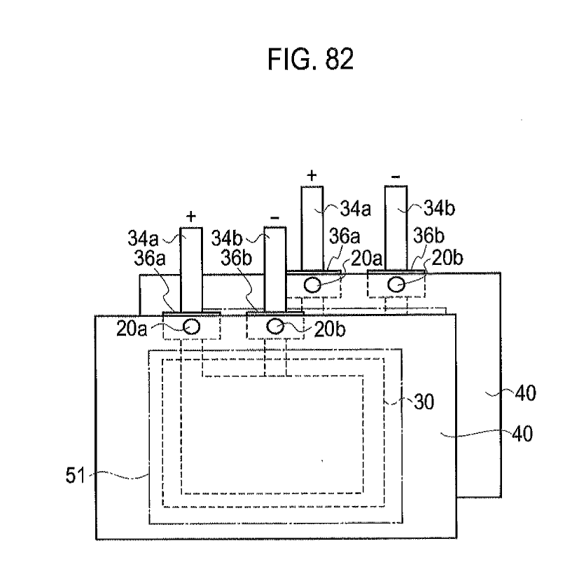

Next, with reference to FIGS. 81 and 82, a comparative example in the case where the laminated type energy devices are connected in series will now be mentioned.

FIG. 81A shows a standalone device of a laminated type energy device in which the positive tab electrode 34a is formed in placing to the left rather than the negative tab electrode 34b, and FIG. 81B shows a standalone device of a laminated type energy device in which the negative tab electrode 34b is formed in placing to the right rather than the positive tab electrode 34a.

The standalone device of the laminated type energy device has a structure in which the structure of the energy device shown in FIG. 76 is sealed with the outer sealing laminate sheet 40.

When two laminated type energy devices are connected in series, as shown in FIG. 82, the laminated type energy device is overlaid, and then the positive tab electrode 34a and the negative tab electrode 34b which are opposed in central substantially are welded to be bonded in the position of the tab electrode extraction hole 20 (20a, 20b).

In addition, when not forming the tab electrode extraction hole 20, the tab electrodes 34a and 34b are welded in the outside of the outer sealing laminate sheet 40.

When the two laminated type energy devices are connected in parallel, since each standalone device of the respective laminated type energy devices is subjected to laminated-packaging, space will be formed between laminated packages, and thereby the whole capacity will be increased.

Moreover, each laminated type energy device subjected to the laminated-packaging includes the tab electrodes 34a and 34b, thereby increasing the cost.

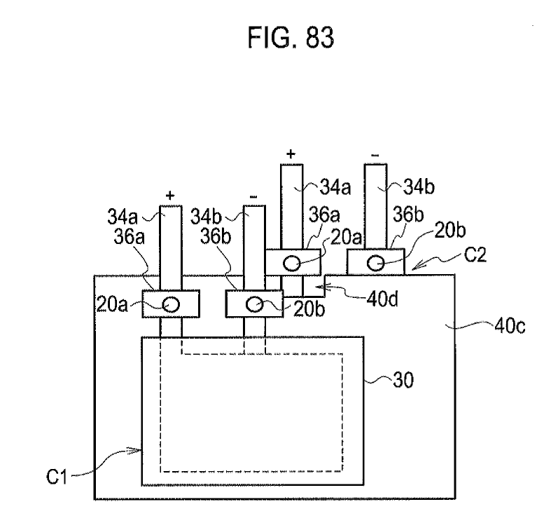

As shown in FIGS. 83-95, the laminated type energy device according to the seventh embodiment includes: a plurality of single cells C1 and C2 having at least two (or more) layers of layered structure 80 in which a positive electrode and a negative electrode are alternately laminated so that positive and negative extraction electrodes 32a and 32b are exposed, inserting a separator 30, in which an electrolysis solution and ion pass therethrough, between positive and negative active material electrodes 10 and 12; a dividing laminate sheet 40c by which the single cells C1 and C2 are overlaid with respect to one another, the dividing laminate sheet 40c being intervened between the single cells C1 and C2; an outer sealing laminate sheet 40 which seals the whole of the single cells C1 and C2 which are connected; and an electrolysis solution 44 injected between the outer sealing laminate sheet 40 and the dividing laminate sheet 40c, wherein the plurality of the single cells C1 and C2 are electrically connected via the extraction electrodes 32a and 32b.

The positive electrode and the negative electrode are mutually connected as for the extraction electrodes 32a and 32b of each single cell C1 and C2, and thereby the whole of the plurality of the single cells C1 and C2 is connected in series.

The connection is achieved by welding exposed parts of the extraction electrodes 32a and 32b.

When the two single cells C1 and C2 are overlaid with respect to one another, the single cells C1 and C2 are disposed so that the positive electrode of one side thereof is opposed to the negative electrode of another side thereof.

The tab electrodes 34c and the tab electrodes 34a and 34b are bonded to the connected extraction electrodes 32a and 32b and the extraction electrodes 32a and 32b of both terminals side.

The number of tab electrodes becomes the total number which added 1 to the number of the single cells connected in series.

The dividing laminate sheet 40c has a structure in which the metallic foil 42 is sandwiched between two sheets of the thermoplastic resin film 49.

The sealant 36b and the sealants 36a and 36b composed of a thermoplastic resin are disposed on edge parts of the single cells C1 and C2 side of the tab electrode 34c and the tab electrodes 34a and 34b, and a notched part 40d in which the sealants 36a and 36b are set therein is formed in an edge of the dividing laminate sheet 40c.

The notched part 40d is sealed by melting the thermoplastic resin film 49, so that the metallic foil 42 is not be exposed from the edge part.

The number of the dividing laminate sheets 40c becomes and the total number which subtracted 1 from the number of the connected single cells C1 and C2.

The extraction electrodes 32a and 32b are bonded to the tab electrodes 34a and 34b in the sealants 36a and 36b, and when the outer sealing laminate sheet 40 is compressively sealed, the edge parts of the tab electrodes 34a and 34b are covered to be insulated with the sealants 52a and 52b compressed simultaneously to be extended.

The outer sealing laminate sheet 40 has the structure in which the metallic foil is sandwiched between the thermoplastic resin film and the high melting point resin film, and covers the single cells C1 and C2 which are connected, so that the film side of the high melting point resin is faced to the outside.

### (Fabrication Method)

With reference to FIGS. 83-95, a fabrication method of the laminated type energy device according to the seventh embodiment will now be explained.

As shown in FIGS. 83-95, the fabrication method of the laminated type energy device according to the seventh embodiment includes: overlaying a plurality of single cells C1 and C2 including at least two (or more) layers of layered structure 80 in which a positive electrode and a negative electrode are alternately laminated so that positive and negative extraction electrodes 32a and 32b are exposed, inserting a separator 30 in which an electrolysis solution and ion pass therethrough between positive and negative active material electrodes 10 and 12; welding the extraction electrodes 32a and 32b be connected to the plurality of the single cells C1 and C2 in series; welding tab electrodes 34c and tab electrodes 34a and 34b to the connected extraction electrodes 32a and 32b and the extraction electrodes 32a and 32b of both terminals side; disposing a sealant 36b and sealants 36a and 36b composed of a thermoplastic resin on edge parts of the single cells C1 and C2 side of the tab electrode 34c and the tab electrodes 34a and 34b; inserting a dividing laminate sheet 40c in which a notched part 40d in which the sealants 36a and 36b are set therein is formed between each single cell C1 and C2; covering the connected single cell C1 and C2 with the outer sealing laminate sheet 40; fusing an edge of the outer sealing laminate sheet 40 in the condition that opening 40e is formed in part thereof; injecting an electrolysis solution 44 via the opening 40e between the outer sealing laminate sheet 40 and the dividing laminate sheet 40c; and fusing the opening 40e to be sealed.

In this case, the process of fusing the opening 40e to be sealed may be performed in a vacuum.

(a) First of all, two energy devices (hereinafter, single cell) C1 and C2 having the structure shown in FIG. 76 are prepared. In this case, one single cell C1 is configured to form the positive tab electrode 34a in placing to the left rather than the negative tab electrode 34b, and other single cell C2 is configured to form the negative tab electrode 34b in placing to the right rather than the positive tab electrode 34a.
(b) Next, as shown in FIG. 83, the single cells C1 and C2 are opposed mutually via the dividing laminate sheet 40c. In this case, the negative tab electrode 34b of the single cell C1 and the positive tab electrode 34a of the single cell C2 are aligned so as to be opposed mutually via the notched part 40d (described later) formed in the dividing laminate sheet 40c.

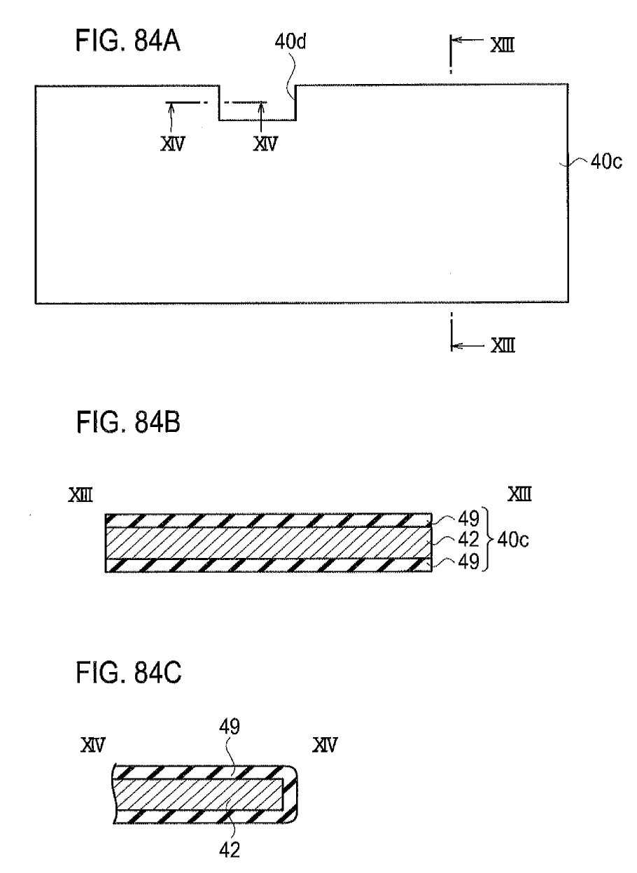

Here, a configuration example of the dividing laminate sheet 40c is shown in FIG. 84.

As shown in FIG. 84B, the dividing laminate sheet 40c has a structure in which the metallic foil 42 (e.g., aluminum foil, copper foil) is sandwiched between two sheets of the thermoplastic resin film (polypropylene etc.) 49.

Moreover, as shown in FIG. 84A, the notched part 40d is formed in an edge of upper side of the dividing laminate sheet 40c so as to be aligned to a position to which the tab electrodes of the single cells C1 and C2 are opposed mutually.

In addition, the notched part 40d is formed by cutting the edge part of the dividing laminate sheet 40c using a specialized cutter etc. However, since the metallic foil 42 exposed from the cutting plane may short-circuit with the tab electrodes 34a and 34b of the single cells C1 and C2 side, the edge of the notched part 40d as heated to around 160 degrees C. to be fused, and thereby the metallic foil 42 of the cutting plane is covered with the thermoplastic resin to be insulated (Refer to FIG. 84C).

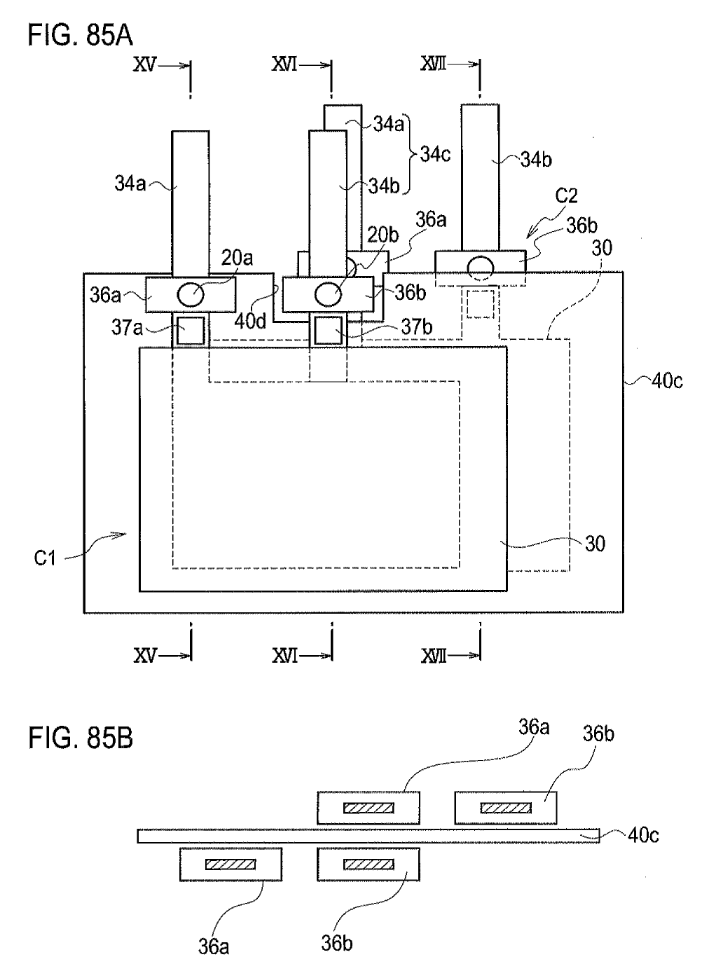

(c) Next, as shown in FIG. 85A, two single cells C1 and C2 are overlaid via the dividing laminate sheet 40c, and then the negative electrode 34b of the single cell C1 and the positive electrode 34a of the single cell C2 are welded to be bonded in a position of the tab electrode extraction hole 20 (20a, 20b).

Note that a structure in which the tab electrode extraction hole 20 (20a, 20b) are not formed can also be applied.

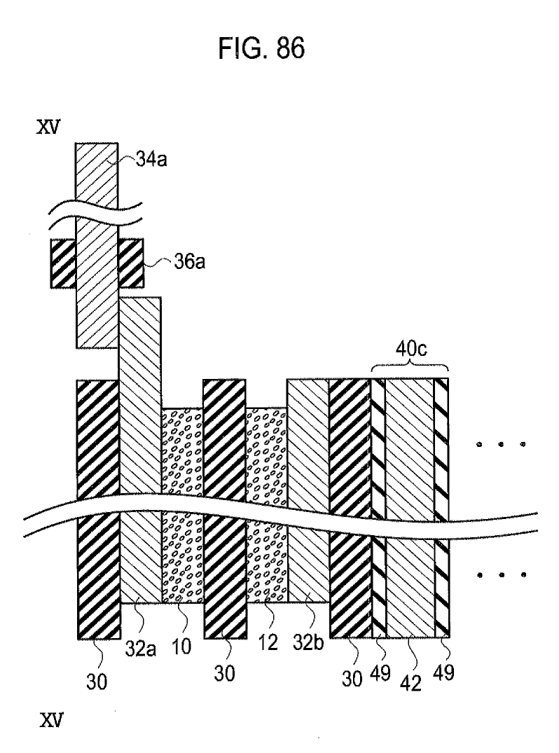

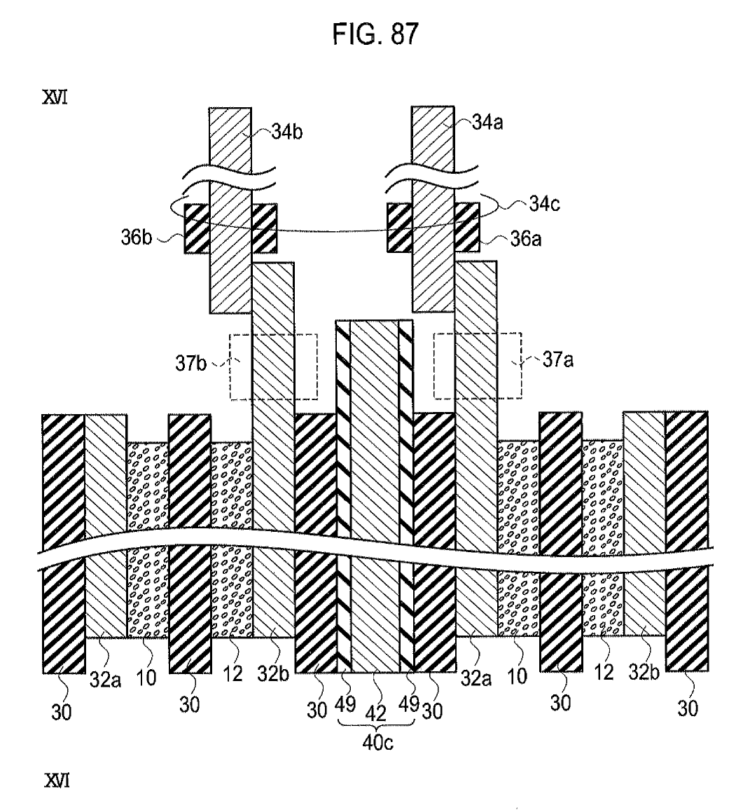

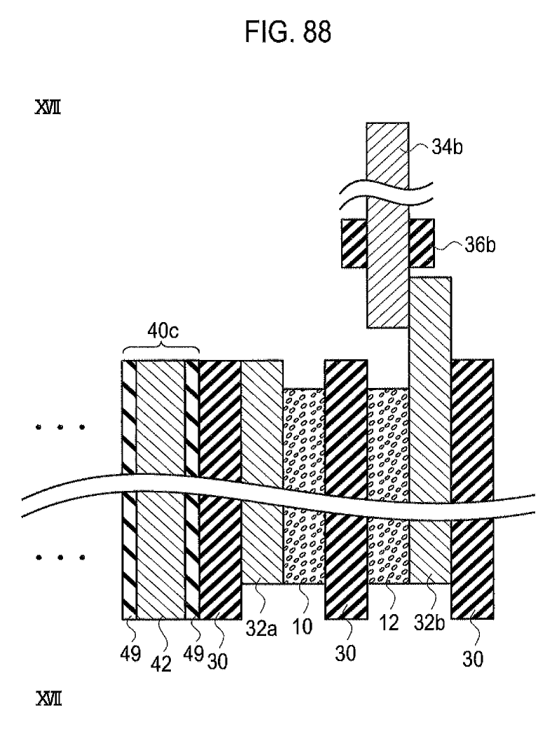

In this case, a cross section taken in the line XV-XV of FIG. 85A in the structure in which the single cells C1 and C2 are overlaid via the dividing laminate sheet is corresponding to a structure shown in FIG. 86, a cross section taken in the line XVI-XVI of FIG. 85 is corresponding to a structure shown in FIG. 87, and a cross section taken in the line XVII-XVII of FIG. 85 is corresponding to a structure shown in FIG. 88.

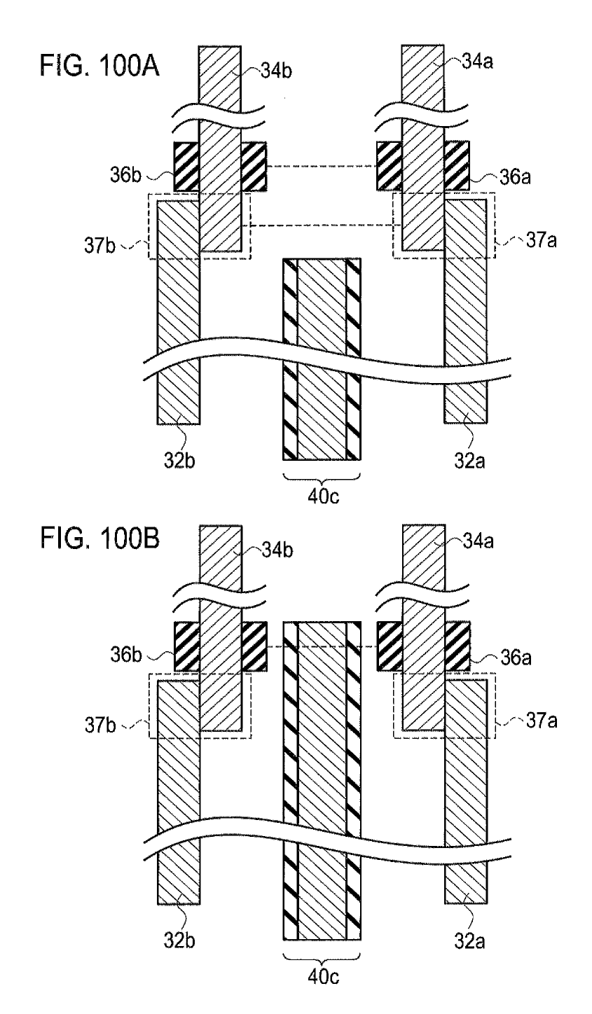

Moreover, as shown in FIGS. 85B and 100B, a structure in which the notched part aligned to the position to which the tab electrodes are opposed mutually is not formed can also be applied. In this case, the sealants 36a and 36b are subjected to thermal fusion, and then the tab electrodes 34a and 34b are welded to be bonded outside of the sealants 36a and 36b.

That is, as shown in FIG. 100A, when forming the notched part in the dividing laminate sheet 40c, the welded parts 37a and 37b between the tab electrodes 34a and 34b and the extraction electrodes 32a and 32b are welded collectively. Furthermore, the sealants 36a and 36b are subjected to thermal fusion.

On the other hand, as shown in FIG. 100B, when not forming the notched part in the dividing laminate sheet 40c, the sealant 36a and the dividing laminate sheets 40c and the sealant 36b are subjected to thermal fusion in the position to be opposed. Moreover, the tab electrodes 34a and 34b are welded to be bonded in arbitrary positions of the upper side of the sealant 36a and 36b.

According to the above process, the single cells C1 and C2 are overlaid via the dividing laminate sheet, and it is achieved in a situation where the negative tab electrode 34b of the single cell C1 and the positive tab electrode 34a of the single cell C2 are welded to be bonded. As a welding method of the tab electrodes 34a and 34b, ultrasonic welding, resistance welding, etc. are applied, for example.

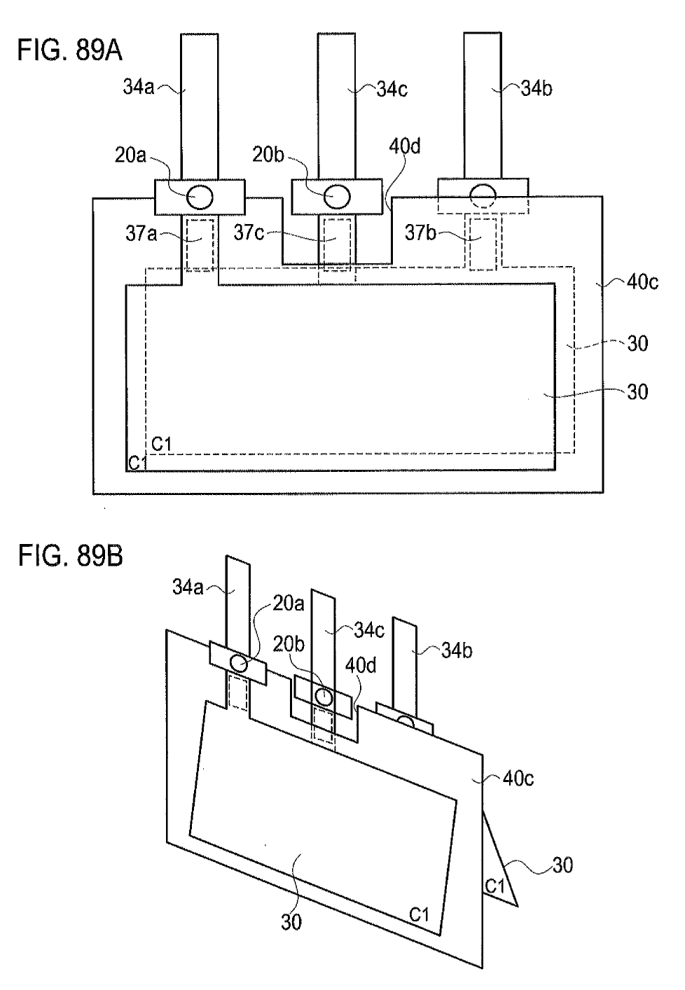

Moreover, although FIG. 85 shows the case where both of the tab electrode 34b of the single cell C1 side and the tab electrode 34a of the single cell C2 side are disposed in the to be opposes thereto, with regard to the tab electrode 34c bonded by welding, it is not limited to the above-mentioned example, but either one of the tab electrode 34b of the single cell C1 side or the tab electrode 34a of the single cell C2 can be omitted. That is, the tab electrode 34c shown in FIG. 89 can be composed either one of the tab electrode 34b of the single cell C1 side, or the tab electrode 34a of the single cell C2 side.

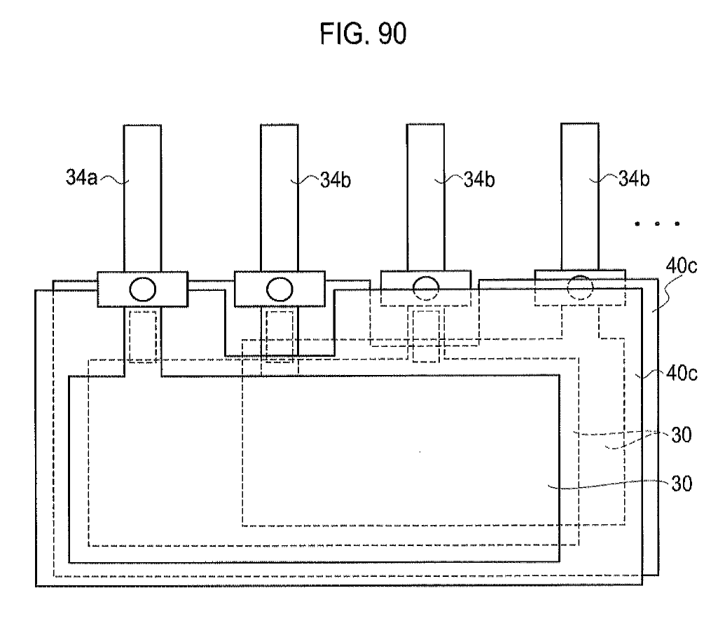

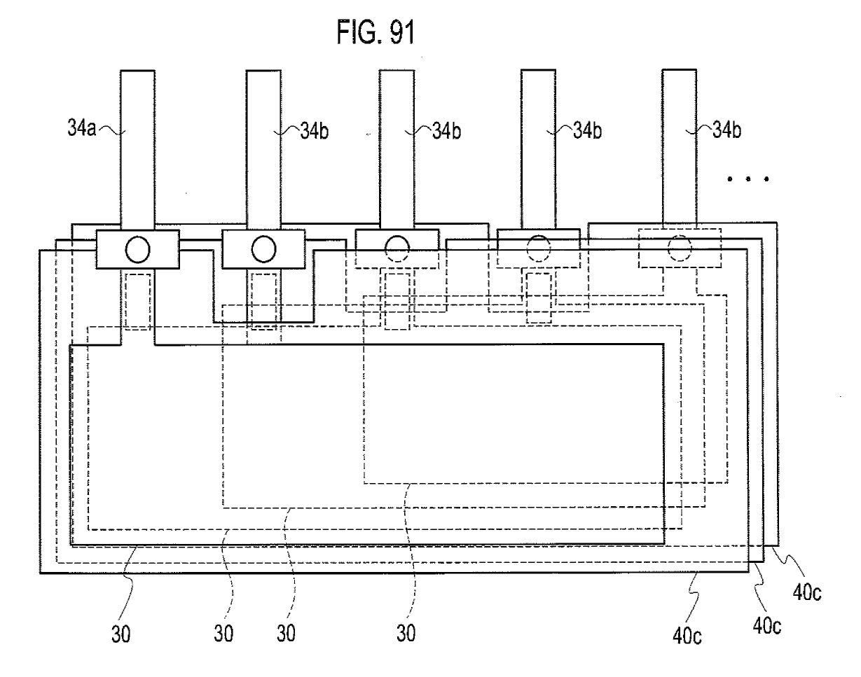

In this case, in the laminated type energy device according to the seventh embodiment, the number of the tab electrodes becomes the total number which added 1 to the number of the single cells connected in series. That is, in the example shown in FIG. 89, since the number of the single cells connected in series is “2”, the number of the tab electrodes is “2+1=3.” Similarly, if the number of the single cells connected in series is “3”, for example, the number of the tab electrodes is “4” (refer to FIG. 90), and if the number of the single cells is “4”, the number of the tab electrodes is “5” (refer to FIG. 91).

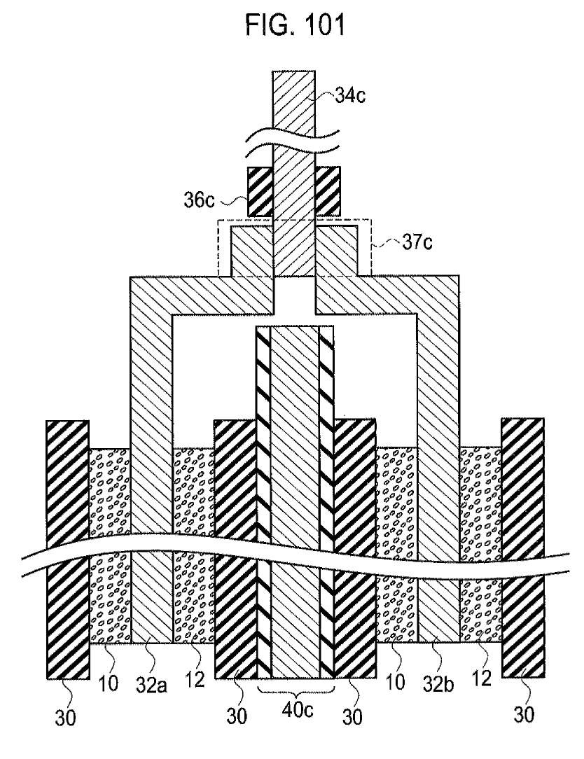

Note that the tab electrode extraction holes 20a and 20b shown in FIGS. 89A and 89B are not indispensable structures, and therefore it is effective also as a structure in which the tab electrode extraction holes 20a and 20b are not formed. In this case, as shown in FIG. 101, the extraction electrodes 32a and 32b are welded in the outside of the sealant 36c. In FIG. 89A, reference numerals 37a, 37b and 37c denote a welded part.

On the other hand, in the comparative example (refer to FIG. 82), the number of the tab electrodes is twice the number of the single cells connected in series. That is, if the number of the single cells connected in series is “2”, the number of the tab electrodes is “4”; if the number of the single cells is “3”, the number of the tab electrodes is “6”; and if the number of the single cells is “4”, the number of the tab electrodes is “8.”

Thus, according to the laminated type energy device according to the seventh embodiment, the usage number of the tab electrodes can be reduced compared with the comparative example, and thereby cost reduction can be achieved.

Moreover, according to the laminated type energy device according to the seventh embodiment, voltage corresponding to the number of the single cells connected in series can be extracted. For example, if the number of the single cells connected in series is 2 as shown in FIG. 89, voltage of approximately 2.5 V, for example, can be obtained between the tab electrodes 34a and 34c, and voltage of approximately 5 V, for example, can be obtained between the tab electrodes 34a and 34b. Moreover, as shown in FIG. 90, if the number of the single cells connected in series is 3, voltage of approximately 2.5 V, voltage of approximately 5 V, and voltage of approximately 7.5 V, for example, can be obtained sequentially from the left-hand side of the tab electrodes. Moreover, as shown in FIG. 91, if the number of the single cells connected in series is 4, voltage of approximately 2.5 V, voltage of approximately 5 V, voltage of approximately 7.5 V, and voltage of approximately 10 V, for example, can be obtained sequentially from the left-hand side of the tab electrodes.

In addition, the number of the dividing laminate sheets 40c becomes the total number which subtracted 1 from the number of the single cells connected. That is, if the number of the single cells connected is 2, the number of the dividing laminate sheets 40c is 1 (refer to FIG. 89); if the number of the single cells is 3, the number of the dividing laminate sheets 40c is 2 (refer to FIG. 90); and if the number of the single cells is 4, the number of the dividing laminate sheets 40c is 3 (refer to FIG. 91).

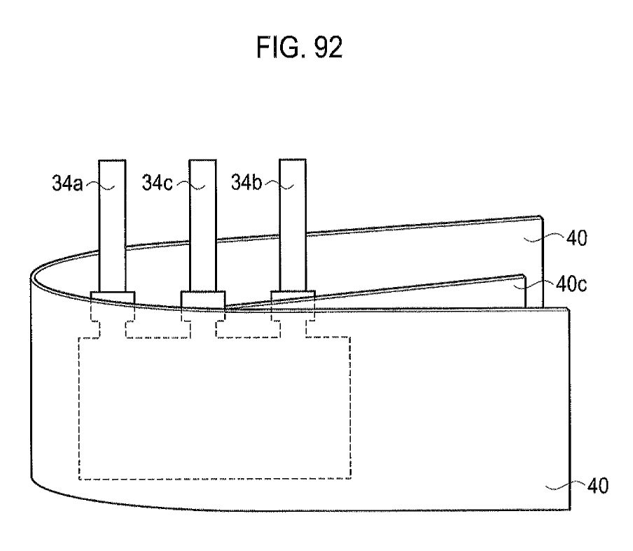

(d) Next, as shown in FIG. 92, the single cells C1 and C2 are overlaid via the dividing laminate sheet 40c, and then the whole is covered with the outer sealing laminate sheet 40, in the condition that the negative tab electrode 34b of the single cell C1 and the positive tab electrode 34a of the single cell C2 are welded to be bonded.

The outer sealing laminate sheet 40 has a structure in which the metallic foil (aluminum foil) is sandwiched between the thermoplastic resin film (polypropylene etc.) and the high melting point resin (nylon, PET, etc.) film.

The outer sealing laminate sheet 40 covers the whole of the connected single cells so that the tab electrodes 34a, 34c and 34b are exposed, as the high melting point resin film side becomes to the outside.

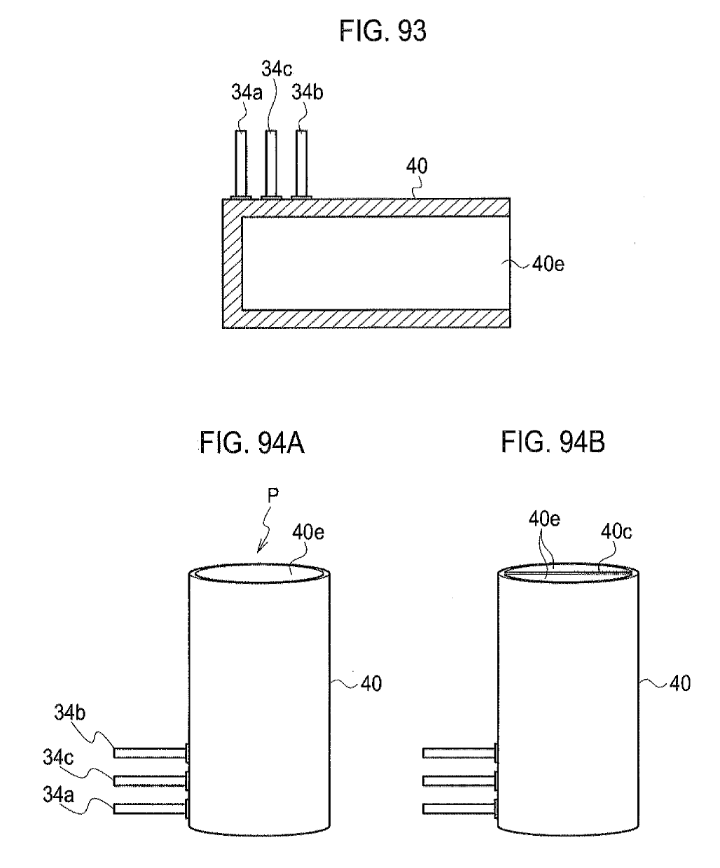

(e) Next, as shown in FIG. 93, the edge of the outer sealing laminate sheet 40 is heated to around 160 degrees C. to be fused, in the condition that the opening 40e is formed in part thereof. In an example shown in FIG. 93, the right-hand side edge is applied as the opening 40e, and other edges are fused.

In this case, the sealant 36 is also melted and extended, and thereby the tab electrode 34c is sealed to be insulated.

Moreover, when the edges of the dividing laminate sheet 40c and the outer sealing laminate sheet 40 are melted, the tab electrodes 34a and 34b are also sealed to be insulated.

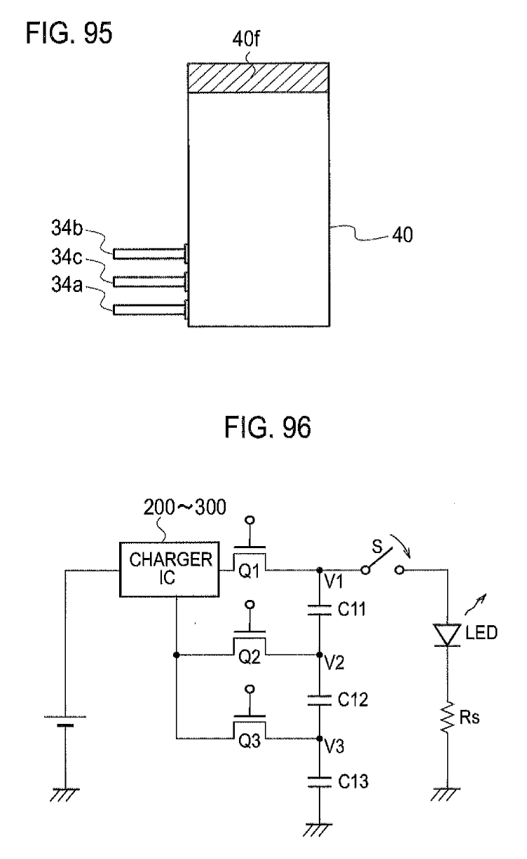

(f) Next, as shown in FIG. 94A, the electrolysis solution 44 is injected as the arrow P between the outer sealing laminate sheet 40 and the dividing laminate sheet 40c, and then the single cells are impregnated with the electrolysis solution via the opening 40e. In addition, as shown in FIG. 94B, since two openings 40e are formed in the dividing laminate sheets 40c when the cells is connected in 2 series, the electrolysis solution 44 is injected from each opening 40e.
(g) Next, as shown in FIG. 95, the edge of the side in which the opening 40e is formed is heated to around 160 degrees C. to be fused, and then the laminated type energy device is completed.

In addition, the process of fusing the opening 40e to be sealing is effective to be carried out in a vacuum. In this case, since the atmospheric pressure is received after the sealing, and thereby the adhesibility in the cells can be enhanced.

The laminated type energy device according to the seventh embodiment fabricated by the above process can reduce the capacity to achieve a miniaturization, and can reduce the usage number of the tab electrodes to achieve cost reduction.

### (Example of Application)

FIG. 96 shows a configuration example of an emitting circuit of an LED flash in which the laminated type energy device according to the seventh embodiment is applied.

In the emitting circuit, a laminated type energy device to which three single cells shown in FIG. 90 are connected in series is applied, as the capacitors C11, C12 and C13, voltage of approximately 2.5 V is obtained as V3, voltage of approximately 5 V is obtained as V2, and voltage of approximately 7.5 V is obtained as V1.

Moreover, a rechargeable battery is connected to the switching transistors (MOS transistors) Q1, Q2 and Q3 via a charger IC 200.

Moreover, the laminated type energy device to which the single cells of the capacitors C11, C12 and C13 are connected in series is connected to a light emitting diode (LED) and a resistor Rs via a switch S.

When the switching transistor Q3 is ON, the capacitor C13 is charged from the charger IC 200.

Moreover, when the switching transistor Q2 is ON, the capacitors C13 and C12 are charged from the charger IC 200.

Moreover, when the switching transistor Q1 is ON, the capacitor C11, C12 and C13 are charged from the charger IC 200.

If the switching transistors Q1, Q2 and Q3 are turned OFF and the switch S is turned ON, the capacitors C11, C12 and C13 will be discharged, and then the light emitting diode (LED) will be driven.

Thus, the advantage of the characteristics of the laminated type energy device in which the miniaturization and cost reduction can be achieved according to the seventh embodiment can achieve a miniaturization and cost reduction of the luminescent device of the LED flash.

### Eighth Embodiment

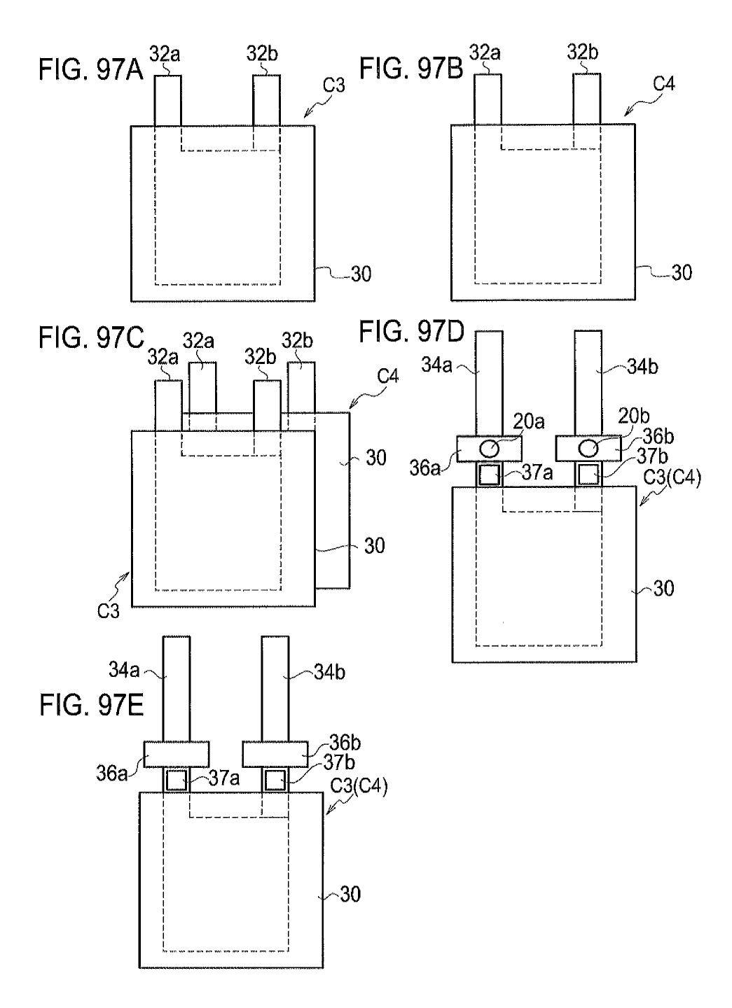

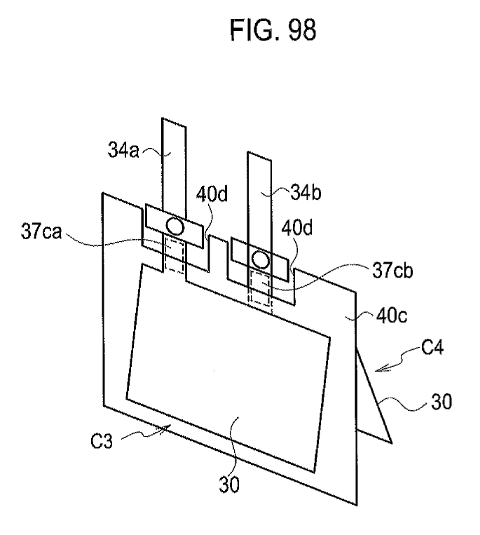

As shown in FIGS. 97 and 98, a laminated type energy device according to an eighth embodiment includes: a plurality of single cells C3 and C4 having at least two (or more) layers of layered structure in which a positive electrode and a negative electrode are alternately laminated so that positive and negative extraction electrodes 32a and 32b are exposed, inserting a separator 30 in which an electrolysis solution and ion pass therethrough between positive and negative active material electrodes 10 and 12; a dividing laminate sheet 40c by which the single cells C3 and C4 are overlaid with respect to one another, the dividing laminate sheet 40c being intervened between the single cells C3 and C4; an outer sealing laminate sheet 40 which seals the whole of the single cells C3 and C4 which are connected; and an electrolysis solution 44 injected between the outer sealing (packaging) laminate sheet 40 and the dividing laminate sheet 40c, wherein the plurality of the single cells C3 and C4 are electrically connected via the extraction electrodes 32a and 32b.

The positive electrode and the negative electrodes are mutually connected as for the extraction electrodes 32a and 32b of each single cell C4 and C3, and thereby the whole the plurality of the single cells C3 and C4 is connected in parallel.

The connection is achieved by welding exposed parts of the extraction electrodes 32a and 32b.

The tab electrodes 34a and 34b are bonded to the connected extraction electrodes 32a and 32b.

The dividing laminate sheet 40c has a structure in which the metallic foil 42 is sandwiched between two sheets of the thermoplastic resin film 49.

The sealants 36a and 36b composed of thermoplastic resin is disposed in an edge part of the single cells C3 and C4 side of the tab electrodes 34a and 34b, a notched part 40d in which the sealant 36a and 36b are settled is formed in an edge of the dividing laminate sheet 40c.

The notched part 40d is sealed by melting the thermoplastic resin film 49 so that the metallic foil 42 is not be exposed from the edge part.

The number of the dividing laminate sheets 40c becomes connected and the total number which subtracted 1 from the number of the single cells C3 and C3.

The extraction electrodes 32a and 32b are bonded to the tab electrodes 34a and 34b in the sealants 36a and 36b, and when the outer sealing laminate sheet 40 is compressively sealed, the edge parts of the tab electrodes 34a and 34b are covered to be insulated with the sealants 52a and 52b compressed simultaneously to be extended.

The outer sealing laminate sheet 40 has the structure in which the metallic foil is sandwiched between the thermoplastic resin film and the high melting point resin film, and covers the single cells C3 and C4 which are connected, so that the film side of the high melting point resin is to the outside.

With reference to FIGS. 97 and 98, a fabrication method of the laminated type energy device according to the eighth embodiment will now be explained.

Note that the same configurations as the laminated type energy device according to the seventh embodiment are attached as same reference numeral, and therefore the duplicating explanation will be omitted.

In this case, a point of difference between the laminated type energy device according to the seventh embodiment and the laminated type energy device according to the eighth embodiment is that the latter is configured to connect the single cells in parallel, but the former is configured to connect the single cells in series.

As shown in FIGS. 97-98, the fabrication method of the laminated type energy device according to the eighth embodiment includes: overlaying a plurality of single cells C3 and C4 including at least two (or more) layers of layered structure 80 in which a positive electrode and a negative electrode are alternately laminated so that positive and negative extraction electrodes 32a and 32b are exposed, inserting a separator 30 in which an electrolysis solution and ion pass therethrough between positive and negative active material electrodes 10, 12 and 13; welding the extraction electrodes 32a and 32b to connect the plurality of the single cells C3 and C4 in parallel; welding tab electrodes 34a and 34b to the connected extraction electrodes 32a and 32b and the extraction electrodes 32a and 32b of both terminals side; disposing the sealants 36a and 36b composed of thermoplastic resin in an edge part of the single cells C3 and C4 side of the tab electrodes 34a and 34b; inserting a dividing laminate sheet 40c in which a notched part 40d in which the sealants 36a and 36b are set therein is formed between each single cell C3 and C4; covering the connected single cell C3 and C4 with the outer sealing laminate sheet 40; fusing an edge of the outer sealing laminate sheet 40 in the condition that opening 40e is formed in part thereof; injecting an electrolysis solution 44 via the opening 40e between the outer sealing laminate sheet 40 and the dividing laminate sheet 40c; and fusing the opening 40e to be sealed.

In this case, the process of fusing the opening 40e to be sealed may be performed in a vacuum.

(a) First of all, as shown in FIGS. 97A and 97B, two energy devices (hereinafter, single cells) C3 and C4 having the structure shown in FIG. 2 described in the explanation of the seventh embodiment are prepared.
(b) Next, as shown in FIG. 97C, the single cells C3 and C4 are overlaid so that the extraction electrodes 32a and 32b are oppose mutually.
(c) Next, the extraction electrodes 32a and 32b are welded mutually to be bonded. Ultrasonic welding, resistance welding, etc. are applied, for example, as the welding method.
(d) Next, as shown in FIG. 97D, the tab electrodes 34a and 34b are welded to be bonded to the bonded extraction electrodes 32a and 32b.

Accordingly, the usage number of the tab electrodes can be reduced. In the laminated type energy device according to the eighth embodiment, since it is enough to only dispose one tab electrode every for the bonded extraction electrode, cost of the tab electrode can be reduced.

(e) Next, the device in the situation shown in FIG. 97D is subjected to laminate-packaging. The process of the laminate-packaging is the same as that of the fabrication method of the laminated type energy device according to the seventh embodiment.

That is, first of all, the dividing laminate sheet shown in FIG. 84 is prepared. In this case, in the dividing laminate sheet, a notched part is formed in a position corresponding to the sealants 36a and 36b of the energy device shown in FIG. 97D.

Note that a point that the edge of the thermoplastic resin is subjected to heating and melting, and the cutting plane is insulated beforehand about each notched part is the same as that of the fabrication method of the laminated type energy device according to the seventh embodiment.

(f) Next, as shown in FIG. 98, the dividing laminate sheet 40c is inserted between the single cells C3 and C4. In this case, it is aligned so that each notched part 40d of the dividing laminate sheet 40c is arrived at the sealants 36a and 36b of the tab electrodes 34a and 34b.
(g) Next, the whole is covered with the outer sealing laminate sheet (aluminum laminate), in the condition that the tab electrodes 34a and 34b are exposed (refer to FIG. 92).
(h) Next, the edge of the outer sealing laminate sheet 40 and the dividing laminate sheet 40c is fused in the condition that the opening 40e is formed, the opening 40e is fused to be sealed after injecting the electrolysis solution 44, and thereby the laminated type energy device is completed.

The laminated type energy device fabricated in this manner can reduce the number of tab electrodes, and thereby cost reduction can be achieved and a miniaturization can also be achieved.

Note that the tab electrode extraction holes 20a and 20b shown in FIG. 97D are not indispensable structures. As shown in FIG. 97E, it is effective also as a structure in which no tab electrode extraction hole is disposed.

In FIG. 98, reference numerals 37ca and 37cb denote a welded part. More specifically, as shown in FIG. 101, for example, an edge parts of the extraction electrodes 32a and 32b and an edge part of the tab electrode 34c are welded. In FIG. 101, reference numeral 37c denotes a welded part.

In the laminated type energy device according to the eighth embodiment, since the device is packed with one sheet of the outer sealing laminate sheet after bonding the single cells, capacity can be reduced and thereby a miniaturization of the device can be achieved.

In addition, when the process of fusing and sealing the opening is performed in a vacuum, atmospheric pressure is received after sealing, and thereby the adhesibility in the cells can be enhanced.

Moreover, the number of the single cells connected in parallel is not limited to two. It can also be applied to the case of connecting three or more single cells in parallel.

### (Electric Double Layered Capacitor)

In an example, the structure and the fabrication method according to the seventh embodiment or eighth embodiment are applied to an electric double layered capacitor, and thereby the usage number of the tab electrodes can be reduced and cost reduction and a miniaturization of the capacitor can be achieved. The electric double layered capacitor internal electrode is composed so that the separator 30 in which the electrolysis solution and ion pass therethrough is inserted between the active material electrodes 10 and 12 having at least one layer, and the extraction electrode 32a and 32b are exposed from the active material electrodes 10 and 12, wherein the extraction electrodes 32a and 32b are connected to power supply voltage. The extraction electrodes 32a and 32b are formed of aluminum foil, for example, and the active material electrodes 10 and 12 are formed of activated carbon, for example. The separator 30 whose size is larger (whose area is wider) than those of the active material electrodes 10 and 12 is used so that whole of the active material electrode 10 and the 12 is covered. Although the separator 30 is not theoretically dependent on a kind of energy device, high thermal resistance is required when in particular corresponding to a reflow is needed. As the separator 30, polypropylene etc. can be used when high thermal resistance is not required, or cellulosic based materials can be used when high thermal resistance is required. The electrolysis solution is impregnated in the electric double layered capacitor internal electrode, and the electrolysis solution and ion are moved through the separator 30 at the time of charge and discharge.

### (Lithium Ion Capacitor)

Moreover, in an example, the structure and the fabrication method according to the seventh embodiment or eighth embodiment are applied to a lithium ion capacitor, and thereby the usage number of the tab electrodes can be reduced and cost reduction and a miniaturization of the capacitor can be achieved. The lithium ion capacitor internal electrode is composed so that the separator 30 in which the electrolysis solution and ion pass therethrough is inserted between the active material electrodes 11 and 12 having at least one layer, and the extraction electrode 33a and 32b are exposed from the active material electrodes 10 and 12, wherein the extraction electrodes 33a and 32b are connected to power supply voltage. The active material electrode 12 of the positive electrode side is formed of activated carbon, for example, and the active material electrode 11 of the negative electrode side is formed of Li doped carbon, for example. The extraction electrode 32b of the positive electrode side is formed of aluminum foil, for example, and the extraction electrode 33a of the negative electrode side is formed of copper foil, for example. The separator 30 whose size is larger (whose area is wider) than those of the active material electrodes 11 and 12 is used so that whole of the active material electrode 11 and the 12 is covered. The electrolysis solution is impregnated in the lithium ion capacitor internal electrode, and the electrolysis solution and ion are moved through the separator 30 at the time of charge and discharge.

### (Lithium Ion Battery)

Moreover, in an example, the structure and the fabrication method according to the seventh embodiment or eighth embodiment are applied to a lithium ion battery, and thereby the usage number of the tab electrodes can be reduced and cost reduction and a miniaturization of the battery can be achieved.

FIG. 20 shows a fundamental structure of a lithium ion battery internal electrode. The lithium ion battery internal electrode is composed so that the separator 30 in which the electrolysis solution and ion pass therethrough is inserted between the active material electrodes 11 and 13 having at least one layer, and the extraction electrode 33a and 32b are exposed from the active material electrodes 10 and 13, wherein the extraction electrodes 33a and 32b are connected to power supply voltage. The active material electrode 13 of the positive electrode side is formed of LiCoO₂, for example, and the active material electrode 11 of the negative electrode side is formed of Li doped carbon, for example. The extraction electrode 32b of the positive electrode side is formed of aluminum foil, for example, and the extraction electrode 33a of the negative electrode side is formed of copper foil, for example. The separator 30 whose size is larger (whose area is wider) than those of the active material electrodes 11 and 13 is used so that whole of the active material electrode 11 and the 13 is covered. The electrolysis solution is impregnated in the lithium ion battery internal electrode, and the electrolysis solution and ion are moved through the separator 30 at the time of charge and discharge.

As explained above, according to the seventh or eighth embodiment, it can provide the laminated type energy device in which a miniaturization and cost reduction can be achieved by reducing the usage number of the tab electrodes, and the fabrication method of the laminated type energy device.

### Other Embodiments

While the present invention is described in accordance with the aforementioned embodiment, it should be understood that the description and drawings that configure part of this disclosure are not intended to limit the present invention. This disclosure makes clear a variety of alternative embodiments, working examples, and operational techniques for those skilled in the art.

Such being the case, the present invention covers a variety of embodiments, whether described or not.

### INDUSTRIAL APPLICABILITY

The laminated type energy device according to the present invention is applicable as an LED-Flash module, a communication (high power communication) module, a solar cell module, a power supply module, and backup electronic power supply (e.g. for a toy, etc.). Moreover, it is applicable to an electric double layered capacitor, a lithium ion capacitor, a lithium ion battery, etc., as the laminated type energy storage device.

Moreover, as the electric double layered capacitor internal electrode, it is applicable to LED-Flash, power supply for use in motor driving (for example, suited for toys), a storage element for use in electric motorcars (as an object for regeneration, starters), an energy storage element from a solar battery or a vibration power generation, a power storage element suited for high power communications, an environment-resistant storage element (e.g., storage element of a road stud or a light for use in bicycles), etc. As the lithium ion capacitor internal electrode, it is applicable to an energy storage element from a solar battery or wind power generation, power supply for use in motor driving, etc. As the lithium ion battery capacitor internal electrode, it is applicable to a battery for use in portable devices, a storage element for use in electric motorcars (at the time of constant driving), a large-scale storage element (suited for general households), etc.

As the lithium ion battery capacitor internal electrode, it is applicable to a battery for use in portable devices, a storage element for use in electric motorcars (at the time of constant driving), a large-scale storage element (suited for general households), etc. the chip type energy device according to the present invention is applicable: as backup electronic power supply (e.g., LSI, a clock, a digital still camera, a digital camcorder, a personal computer, a cellular phone, and a toy); as a micro energy storage element which conserves low power energy from photovoltaics, a dynamo power generation, a vibration power generation, a thermionic element, power generation, etc.; as a coupling capacitor; or as a smoothing capacitor, etc.

The energy device according to the present invention is applicable as an LED-Flash module, a communication (high power communication) module, a solar cell module, a power supply module, and backup electronic power supply (e.g. for a toy, etc.). The energy device according to the present invention is applicable: as backup electronic power supply (e.g., LSI, a clock, a digital still camera, a digital camcorder, a personal computer, a cellular phone, and a toy); as a micro energy storage element which conserves low power energy from photovoltaics, a dynamo power generation, a vibration power generation, a thermionic element, power generation, etc.; as a coupling capacitor; or as a smoothing capacitor, etc.

What is claimed is:

1. A laminated type energy device comprising:
at least two layers of layered structure in which a positive electrode and a negative electrode are alternately laminated so that positive and negative extraction electrodes are exposed, inserting a separator in which an electrolysis solution and ion pass therethrough between positive and negative active material electrodes;
a laminate sheet overlaid from a front surface and a back surface of the layered structure to compressively seal the layered structure; and
a contact hole for performing spot bonding of the laminated type energy device to a module substrate.

2. The laminated type energy device according to claim 1, wherein
the contact hole functions as a tab electrode extraction hole for extracting a tab electrode bonded to the extraction electrode.

3. The laminated type energy device according to claim 2, wherein
an electrolysis solution injection port is formed when the laminate sheet is overlaid to be compressively sealed from the front surface and the back surface of the layered structure, and
the laminated layered structure is immersed in an electrolytic bath containing an electrolysis solution, the electrolysis solution is impregnated in the layered structure from the electrolysis solution injection port, an electrolyte is impregnated between laminated active material electrodes, and electrical aging is simultaneously performed from the exposed tab electrode.

4. The laminated type energy device according to claim 3, wherein
the tab electrode which is exposed is cut to be removed after the electrical aging.

5. The laminated type energy device according to claim 4, wherein
the extraction electrode exposed from the layered structure is bonded to the tab electrode in sealant, and when the laminate sheet is overlaid to be compressively sealed from the front surface and the back surface of the layered structure, an edge part of the tab electrode which is cut is covered to be insulated with the sealant compressed simultaneously to be extended.

6. The laminated type energy device according to claim 5, wherein
a perimeter of the tab electrode extraction hole is also covered with the sealant compressed to be extended.

7. A laminated type energy device comprising:
at least two layers of layered structure in which a positive electrode and a negative electrode are alternately laminated so that positive and negative extraction electrodes are exposed, inserting a separator in which an electrolysis solution and ion pass therethrough between a positive and negative active material electrode connected in a series, and so that the separators are respectively laminated on a topmost part and a lowermost part, the separator whose area is wider than those of the active material electrodes being used so that whole of the active material electrode is covered; and
a bonded structure in which the separators with respect to one another are punched collectively in the layered structure including the active material electrodes and the separator, and fiber structures of edge faces of the separators are entangled to be bonded mutually in the edge faces of the separators.

8. The laminated type energy device according to claim 7, wherein
the separator of the extraction electrode portion is out of punching range.

9. The laminated type energy device according to claim 7, wherein
an active material electrode structure of the active material electrodes has a structure where a plurality of electrode structures is sequenced in a row with the common electrode members, and the active material electrode structure of a series of the active material electrodes is laminated alternately with the separator corresponding to the active material electrode structure.

10. The laminated type energy device according to claim 9, wherein
the laminated extraction electrodes of the positive electrodes are welded mutually and the laminated extraction electrodes of the negative electrodes are welded mutually before the punching the separators.

11. The laminated type energy device according to claim 7, wherein
a portion in which the separator is punched to be removed after punching the separator corresponds to a portion laminated from back and front surfaces with a laminate sheet, and the layered structure is laminated with the laminate sheet held in a row.

12. The laminated type energy device according to claim 11, wherein
when laminated with the laminate sheet, a portion of the laminate sheet corresponding to a lower part of each layered structure is used as an electrolysis solution injection port, without being laminated.

13. The laminated type energy device according to claim 12, wherein
a tab common electrode for use in external extraction to each extraction electrode after punching the separators, and
when injecting the electrolysis solution from the electrolysis solution injection port, the electrical aging is subjected to a plurality of the layered structure with one piece of an electrical conducting terminal from the tab common electrode.

14. The laminated type energy device according to claim 7, wherein
a series of the active material electrodes and the extraction electrodes are formed respectively of one couple of two electrode sheets, and
a portion on which an active material is coated on the respective electrode sheet is used as the active material electrodes, and a portion on which the active material is not coated is used as the extraction electrodes.

15. A chip type energy device comprising:
at least two layers of layered structure in which a positive electrode and a negative electrode are alternately laminated so that extraction electrodes portions are exposed, inserting a separator between active material electrode portions of electrodes into which positive and negative active material electrodes and positive and negative extraction electrodes are integrated;
a frame member for housing the layered structure, wherein through-holes for extracting terminal electrodes connected to the extraction electrodes to the outside thereof are formed in the frame member;
a sealing cover for sealing an upper surface of the frame member; and
a sealant for sealing a bottom surface of the frame member and the through-holes to impregnate a layered portion of the layered structure with an electrolyte.

16. The chip type energy device according to claim 15, wherein
the through-hole functions as an injected hole for injecting an electrolysis solution including the electrolyte.

17. The chip type energy device according to claim 16, wherein
a gap which is minimum required to pass the electrolysis solution is formed between the through-hole and the extracted terminal electrode passed through the through-hole.

18. The chip type energy device according to claim 15, wherein
a recessed region in which the sealing cover is concaved to inside of the frame member is formed in the sealing cover by pressing so that an upper surface of the sealing cover and a bottom surface of the sealant are sandwiched.

19. The chip type energy device according to claim 18, wherein
the layered structure in the frame members is pressed down with the sealing cover concaved in concave shape.

20. The chip type energy device according to claim 18, wherein
the sealing cover is formed of a metal plate composed of Al.

21. The chip type energy device according to claim 15, wherein
the electrode is formed by coating an active material on a part of upper surface of a metal sheet and then cutting the coated metal sheet in rectangles, and
a portion on which an active material is coated is used as the extraction electrode, and a portion on which the active material is not coated is used as the extraction electrodes, on each metal sheet which is cut.

22. The chip type energy device according to claim 21, wherein
the metal sheet is a high power aluminum electrode sheet.

23. The chip type energy device according to claim 15, wherein
the layered structure is laminated so that not the electrode but the separator is laminated on a topmost part of the layered structure.

24. The chip type energy device according to claim 15, wherein
the sealing cover is bonded with chemical-resistant ceramic adhesive agent to be mounted on an upper surface of the frame member.

25. The chip type energy device according to claim 15, wherein
the sealant seals a bottom surface of the frame member with a chemical-resistant ceramic adhesive agent.

26. The chip type energy device according to claim 15, wherein
an outer package of the chip type energy device is covered with a resin mold.

27. The chip type energy device according to claim 16, wherein
the chip type energy device is covered with a resin mold so as to form a predetermined space part between the recessed region of the sealing cover concaved to inside thereof and the resin mold.

28. A chip type energy device comprising:
at least two layers of layered structure in which a positive electrode and a negative electrode are alternately laminated so that extraction electrodes portions are exposed, inserting a separator between active material electrode portions of electrodes into which positive and negative active material electrodes and positive and negative extraction electrodes are integrated;
a base on which the layered structure is mounted, wherein through-holes are formed in the base, terminal electrodes connected to the extraction electrodes are extracted through the through-holes to outside, and the through-holes functions as an injected hole for injecting an electrolysis solution including the electrolyte;
a frame member for housing the layered structure mounted on the base; and
a sealing cover for sealing an upper surface of the frame member.

29. The chip type energy device according to claim 28, wherein
a recessed region in which the sealing cover is concaved to inside of the frame member is formed in the sealing cover by pressing so that an upper surface of the sealing cover and a bottom surface of the base are sandwiched.

30. The chip type energy device according to claim 28, wherein
an outer package of the chip type energy device is covered with a resin mold.

31. The chip type energy device according to claim 30, wherein
the chip type energy device is covered with a resin mold so as to form a predetermined space part between the recessed region of the sealing cover concaved to inside thereof and the resin mold.

32. The chip type energy device according to claim 30, wherein
the terminal electrodes are extracted to outside from the through-holes in parallel at almost same height as the structure.

33. An energy device electrode structure comprising:
a collector electrode;
an undercoat layer disposed on the collector electrode; and
an active material electrode layer disposed on the undercoat layer and including a first binder with high-temperature thermal resistance, a melting point of the first binder being higher than 200 degrees C.

34. The energy device electrode structure according to claim 33, wherein
the undercoat layer includes a second binder, and the melting point of the first binder is different from a melting point of the second binder.

35. The energy device electrode structure according to claim 33, wherein
the first binder is aramid resin.

36. The energy device electrode structure according to claim 33, wherein
the undercoat layer includes a second binder, and the melting point of the first binder is equal to a melting point of the second binder.

37. The energy device electrode structure according to claim 36, wherein
each of the first binder and the second binder is aramid resin.

38. The energy device electrode structure according to claim 35, wherein
the aramid resin is poly-meta-phenyleneisophthalamide.

39. The energy device electrode structure according to claim 34, wherein
the second binder is poly-tetrafluoroethylene (PTFE).

40. A fabrication method of an energy device electrode structure comprising:
coating a coating liquid for use in undercoat layer on a collector electrode;
drying the coating liquid for use in undercoat layer to form an undercoat layer;
coating a coating liquid for use in active material electrode layer including the first binder on the undercoat layer;
drying the coating liquid for use in active material electrode layer to form an active material electrode layer; and
subjecting a layered structure to a roll press, the layered structure being composed of the collector electrode, the undercoat layer, and the active material electrode layer.

41. The fabrication method according to claim 40, wherein
the step of drying the active material electrode layer includes vacuum drying.

42. The fabrication method according to claim 40, wherein
the step of the roll press uses in conjunction with a heating process

43. The fabrication method according to claim 40, wherein
the step of coating the coating liquid for use in undercoat layer is performed to front-back both surfaces of the collector electrode.

44. The fabrication method according to claim 43, wherein
the step of coating the coating liquid for use in active material electrode layer is performed on the undercoat layer formed on the front-back both surfaces of the collector electrode.

45. An electric double layered capacitor providing a positive and negative active material electrode structure with the energy device electrode structure according to claim 33.

46. A lithium ion capacitor providing a positive and negative active material electrode structure with the energy device electrode structure according to claim 33.

47. A Lithium ion battery providing a positive and negative active material electrode structure with the energy device electrode structure according to claim 33.

48. A laminated type energy device comprising:
a plurality of single cells having at least two layers of layered structure in which a positive electrode and a negative electrode are alternately laminated so that positive and negative extraction electrodes are exposed, inserting a separator in which an electrolysis solution and ion pass therethrough between positive and negative active material electrodes;
a dividing laminate sheet by which the single cells are overlaid with respect to one another, the dividing laminate sheet being intervened between the single cells;
an outer sealing laminate sheet which seals the whole of the single cells which are connected; and
an electrolysis solution injected between the outer sealing laminate sheet and the dividing laminate sheet, wherein
the plurality of the single cells are electrically connected via the extraction electrodes.

49. The laminated type energy device according to claim 48, wherein
the positive electrode and the negative electrode are mutually connected as for the extraction electrode of each single cell, and thereby the whole of the plurality of the single cells is connected in series.

50. The laminated type energy device according to claim 48, wherein
the positive electrode and the negative electrodes are mutually connected as for the extraction electrode of each single cell, and thereby the whole the plurality of the single cells is connected in parallel.

51. The laminated type energy device according to claim 48, wherein
the connection is achieved by welding an exposed part of the extraction electrode.

52. The laminated type energy device according to claim 49, wherein
when the two single cells are overlaid with respect to one another, the single cells are disposed so that the positive electrode of one side thereof is opposed to the negative electrode of another side thereof.

53. The laminated type energy device according to claim 49, wherein
a tab electrode is bonded to the connected extraction electrode and the extraction electrode of both terminals side.

54. The laminated type energy device according to claim 53, wherein
the number of the tab electrodes becomes the total number which added 1 to the number of the single cells connected in series.

55. The laminated type energy device according to claim 48, wherein
the dividing laminate sheet has a structure in which a metallic foil is sandwiched between two sheets of a thermoplastic resin film.

56. The laminated type energy device according to claim 48, wherein
a sealant composed of a thermoplastic resin is disposed on edge parts of the single cells side of the tab electrodes, and
a notched part in which the sealants are set therein is formed in an edge of the dividing laminate sheet.

57. The laminated type energy device according to claim 48, wherein
the notched part is sealed by melting the thermoplastic resin film, so that the metallic foil is not be exposed from the edge part.

58. The laminated type energy device according to claim 48, wherein
the number of the dividing laminate sheets becomes and the total number which subtracted 1 from the number of the connected single cells.

59. The laminated type energy device according to claim 48, wherein
the extraction electrode is bonded to the tab electrode out of the sealant, and
when the outer sealing laminate sheet is compressively sealed, an edge parts of the tab electrode is covered to be insulated with the sealant compressed simultaneously to be extended.

60. The laminated type energy device according to claim 48, wherein
the outer sealing laminate sheet has a structure in which the metallic foil is sandwiched between a thermoplastic resin film and a high melting point resin film, and covers the single cells which are connected, so that a film side of the high melting point resin is faced to the outside.

61. A fabrication method of a laminated type energy device comprising:
overlaying a plurality of single cells including at least two layers of layered structure in which a positive electrode and a negative electrode are alternately laminated so that positive and negative extraction electrodes are exposed, inserting a separator in which an electrolysis solution and ion pass therethrough between positive and negative active material electrodes;
welding the extraction electrode to be connected to the plurality of the single cells in parallel or in series;
welding a tab electrode to the connected extraction electrode and the extraction electrodes of both terminals side;
disposing a sealant composed of a thermoplastic resin on an edge part of single cells side of the tab electrode;
inserting a dividing laminate sheet in which a notched part is formed between each single cell, the sealant being set in the notched part;
covering the connected single cell with an outer sealing laminate sheet;
fusing an edge of the outer sealing laminate sheet in the condition that opening is formed in part thereof;
injecting an electrolysis solution via the opening between the outer sealing laminate sheet and the dividing laminate sheet; and
fusing the opening to be sealed.

62. The fabrication method according to claim 61, wherein
the step of fusing the opening to be sealed is performed in a vacuum.
